(19) United States
(12) Patent Application Publication
(10) Pub. No.: US 2008/0257134 A1
(43) Pub. Date: Oct. 23, 2008

(54) Method And Apparatus For Generating And Updating A Pre-Categorized Song Database From Which Consumers May Select And Then Download Desired Playlists

(75) Inventor: Harold B. Oppenheimer, Kansas City, MO (US)

Correspondence Address: PATENT ADMINISTRATOR;KATTEN MUCHIN ROSENMAN LLP, 2900 K Street NW, Suite 200, WASHINGTON, DC, 20007-5118, US

(73) Assignee: 3B Music, LLC, Lees Summit, MO (US)

(21) Appl. No.: 11/736,928

(22) Filed: Apr. 18, 2007

(51) Int. Cl. G10H 7/00

(52) U.S. Cl. 84/609

(57) ABSTRACT

Apparatus, methods, systems, and data structures for organizing music files such that consumers can download single songs or entire predetermined libraries of songs with one or two clicks on an Internet browser. For passive listeners without the time to generate their own playlists, 500 to 30,000 song libraries can be downloaded to a PC, and then side loaded to an MP3 player. This will enable users to replicate the experience of listening to a favorite broadcast radio channel having songs most likely to please the listener, with zero interruptions. The stored and downloaded songs are individually categorized by song title, artist, mood/tempo, multiple genres, era, original song release date, and audience reach (e.g., audience crossover potential). For a subscription fee, the consumer will have continued access to listen to the downloaded and side loaded songs, but without the ability to copy or transfer the song. For an additional fee (or a higher subscription fee) the consumer can take actual ownership of downloaded song libraries and/or individual songs.

### BACKGROUND OF THE INVENTION

1. Field of the Invention

The present invention relates to the loading of digital music onto personal computers (PCs) and/or portable music players from one or more song databases residing on one or more Internet (or network) servers. More particularly, the present invention relates to the generation and use of a song database(s), where each song is individually categorized based upon predetermined criteria. Consumers may then access the song database(s), and download one or more complete song libraries based upon consumer preference. Since entire song libraries may be downloaded to the PC with, for example, a one or two-click Internet interface and then loaded to the consumer's portable music player (such as an iPod™, an MP3 player, a cellular telephone, a laptop computer, a personal digital assistant (PDA), etc.), it is very quick and easy, as opposed to the current system whereby the consumer must spend hours on his/her computer selecting each song or album or playlist to be loaded onto his/her portable music player. The downloaded library or libraries allow the consumer to generate and listen to playlists, in the well known fashion on his/her PC. The consumer can then side load to his/her portable device: (i) playlists he/she generates on his/her PC, (ii) predetermined playlists recommended by the provider, or (iii) the entire song library. In a preferred embodiment, each song stored on the song database(s) is individually predetermined (pre-categorized) in accordance with five criteria (in addition to the known criteria of artist, album, and song title.)

2. Related Art

With the advent of digital music technology, and especially the MP3 files and the iPod™, consumers now enjoy access to approximately 4,000,000 song choices. On-line music download services such as Apple iTunes™ and on-line subscription-based services such as Napster, Rhapsody, and MTV/Urge provide over 2,700,000 songs that consumers can utilize to listen to, buy, or discover new music.

This tidal wave of choices has created a need for consumers to filter and select music in order to discover new music as well as organize the music they are already familiar with. One method of organizing this universe is to create playlists of songs. This allows consumers to avoid the need to individually select songs by artist, song, or album name each time they want to listen.

In order to enjoy a playlist of songs, consumers currently have two general choices. First, they can select a live radio broadcast station that is programmed for a particular style of preferred music. Today, such platforms include Internet radio, pod-casting, satellite, terrestrial and cable-based music broadcasters. Listening to live broadcast requires no expertise or time on the listeners' part to enjoy hundreds of different station playlist options. The music is selected for them by professional programmers to fit a particular “format” or theme. However, listening to playlists on these broadcast platforms has certain significant limitations. First, with a few minor exceptions, broadcast songs cannot be stored on the personal computer (PC) or portable music player because they are licensed for “listen only” consumption. This means consumers cannot fast-forward over songs they do not like (as they can with songs stored on a portable MP3 player or CD player). Instead, to listen to music they like, the consumers must station-surf, which is especially annoying while driving a car or while exercising. Second, the number of choices available from such satellite, cable, or terrestrial broadcast platforms is small and limited in depth, including the number of new artists and genres covered. Third, the number of commercial-free stations is extremely limited, with Sirius and XM offering only 69 channels each. And, these supposedly commercial-free stations are actually full of house ads promoting the broadcasters own service offerings. This too eliminates the feel of listening to one's personal library of songs without interruption. Fourth, Internet Radio is a “listen-only” format so songs cannot be legally stored on the PC or portable device.

To enjoy a desired playlist of songs, the consumers' second general option is to take the time to search for individual songs (or entire playlists) on their own, and then download them, one at a time, into their personal libraries or set of playlists. Each such do-it-yourself library can then be stored on a PC or portable MP3 player, thus allowing the consumer to skip to the next song without limitation.

Over the last several years, dozens of techniques have been developed to assist these do-it-yourself consumers in creating their own playlists from the millions of songs now available to them. These methods typically make the same two assumptions regarding music consumers: 1) The consumers want to be actively involved in choosing songs for a personalized station playlist. More specifically, it is assumed that computer-savvy music listeners with high-speed Internet access and MP3 player devices have the expertise and the time to spend many hours attempting to “discover” and download desirable music; and 2) Each consumer wants to select among a narrow range of songs and artists that they are familiar with, in order to create a profile of song traits or user preferences that can be used to sort through a 4,000,000 song universe, to recommend songs for download. The idea is to narrow the songs available to conform to past listening habits. This ignores the possible discovery of high quality new music from unfamiliar sources.

As it turns out, none of these do-it-yourself or “active” methods have appealed to a mass audience. In fact, the average owner of an iPod™ or similar MP3 player device has only two to three hundred songs stored, and purchases less than one new song per month, on average. Likewise, all eight of the music subscription services now available have collectively only obtained a total of roughly 2.0 million subscribers. None of these systems are enjoying significant growth, despite the fact that over 90 million Americans now have iPods™ or similar MP3 player devices. The reason for this is pretty simple: The vast majority of music listeners do not have the time, the expertise, or the desire to sort through the vast universe of available songs—it is simply too much work. Furthermore, the systems and methods now available to recommend songs, based on various inputs and preferences from the user, are ineffective and are also too much work. Finally, because they are based on a consumer's past, and usually highly limited, experience with the music universe, they limit the chance to discover music from unfamiliar genres, sources, artists, or time periods, and enjoy the kind of diversity now available.

These active or user-based playlist recommendation systems fall into five broad categories:
Song Matching Algorithms: The user is asked to provide favorite songs that are then analyzed in detail to find songs with similar “musical DNA” (e.g., Pandora, Yahoo-Music Match and Alcalde et. al., U.S. Pat. No. 7,081,579).
Playlist Sharing: The user shares his playlists with others to get ideas from people with similar tastes (e.g., mystrands.com, last.fm.com, MOG.com).
Artist Matching Systems: Instead of favorite songs, the user inputs favorite artists or radio stations to generate a list of recommended songs (e.g., Porteus et al., U.S. Pat. No. 6,933,433).
Identifying a “Plurality” of Preferences: The user fills out a complicated survey of “desired and undesirable seed items,” that is then used to recommend songs (e.g. Platt, U.S. Pat. No. 6,987,221).
Genre/Station Preferences: A user's radio station/genre choices form the basis for recommending songs (Doshida et al., U.S. Patent Application Publication No. 20040193649).
   Again, all of these systems assume that: 1) the listener wants his/her past choices to limit his/her future choices; and 2) the listener has the time to be actively involved in the process of generating playlists.

Meanwhile, new passive systems for retrieving and listening to playlists that are prepared by professional programmers have had fantastic success. Such “passive” systems include Internet radio broadcasters with an online listening audience of approximately 60,000,000 people, and subscription-based satellite radio services, currently with approximately 10,000,000 subscribers. Both of these types of systems are presently growing at an approximate rate of 25% annually. The present invention is intended to address this need for passive systems and methods for providing song playlists to consumers that can be legally stored on their PC or portable device thereby avoiding the limitations of live broadcast.

### SUMMARY OF THE INVENTION

The methods, systems, and data structures of the present invention are designed primarily for passive listeners without the time, experience, or desire to generate their own playlists and store them on a PC or portable device. The present invention will enable users to replicate the experience of listening to a favorite broadcast radio channel having songs most likely to please the listener, with zero interruptions. Since the downloaded songs are individually categorized, the consumer can easily “slice-and-dice” his/her downloaded song library in any number of ways to produce an almost infinite variety of playlists. For a subscription fee, the consumer will have continued access to listen to the downloaded (PC) and side loaded (MP3 player) songs, but with limited ability to copy or transfer the song. For an additional fee (or perhaps a higher subscription fee) the consumer can take actual ownership of downloaded song libraries and/or individual songs that they heard over their subscription service.

Specifically, according to a preferred embodiment of the preferred embodiment, the consumer will access an Internet-based server storing a database of roughly 30,000 songs, each of which has been categorized in accordance with five criteria (in addition to the known criteria of artist, album, and song title). After logging into the PushButtonMusic™ website, the consumer may select among nine or more song libraries ranging in size from 250 to 22,000 songs. Once the desired library is downloaded to his/her PC, the consumer can choose from a number of options to “side-load” a portable MP3 device. These include:
(i) the Full-Download Portable Service™, in which one or two clicks may be used to download a predetermined library of the highest rated songs in the song database, depending on the memory capacity of the consumer's portable music player (e.g., an entire 19,000 song database for a 80 Gigabyte MP3 player, or the 5,000 highest rated songs for a 30 Gigabyte MP3 player, etc.);
(ii) the SemiFull-Download Portable Service™, in which a few clicks may be used to eliminate from the 19,000 song Full-Download library certain categories of songs the consumer is not interested in downloading (e.g., Punk Music, Jazz, Rap, etc.).
(iii) the MyChoice Portable Service™, in which multiple clicks may be used to select the specific categories of music that the consumer is interested in downloading (e.g., Slow, Classic Jazz, and Fast, Modern, Pop);
(iv) the Advanced Portable Service™, which is akin to today's services which allow the consumer to individually choose songs, artists, albums, etc, to download, based upon criteria related to past listening choices; and
(v) the Playlist Recommender Service which allows the consumer to download entire playlists recommended by the provider based on the consumers past listening habits or stated preferences.

Another notable feature of the preferred embodiment is that a consumer's chosen library, playlist, and downloaded songs will be stored on the company's server for 12 months after the consumer discontinues the subscription for any reason. This is to address the concern by consumers that songs “rented” over a subscription service will disappear should they temporarily fail to renew for any reason.

Another notable feature of the preferred embodiment is that the consumer is encouraged to continue his/her subscription to any of the above in order to periodically download desired songs which have been recently added to the database. This presents the user with fresh music and fresh playlist possibilities.

A further notable feature according to the preferred embodiment is the 30,000 song Playlist Generator Database™ itself, which is initially installed and then continually updated using the Music Content Management System™. According to the Music Content Management System™, the universe of known digital songs (4,000,000 and growing) is filtered (preferably using five filters) to narrow that universe to 30,000 of the most popular songs which are installed into the Playlist Generator Database™. Preferably, the fourth filter (to be described in detail below) attaches to each song data indicative of five different criteria: One or more Genres; Era; Year of Original Release; Mood; and Star Rating (indicative of estimated Audience Reach or Audience Crossover potential). Each song in the database is thus pre-categorized (pre-filtered, predetermined) in accordance with the five criteria. The power of such a pre-categorized song database cannot be overemphasized. With each song in the database having five different criteria associated therewith, consumers have unparalleled ability to generate precisely those playlists in which they have the most interest. With the Playlist Generator Database™ according to the preferred embodiment, there are 1.8 billion possible different playlists that can be generated from various combinations of these criteria. The consumer can thus easily produce a portable music player having the exact kinds of songs the consumer wants to listen to, without any commercial interruptions.

In one aspect, the present invention provides a method for developing (and then updating) the Playlist Generator Database™. The method preferably comprises using five filtering steps to reduce the universe of 4,000,000 plus songs to a manageable number, perhaps 30,000, and pre-categorizing those songs so that the consumers may efficiently select the song or playlist of songs they desire. In the first filter, a plurality of predetermined expert sources are used to select a first subset of songs from the available digital song universe, wherein a number of songs included in the first subset is less than 5% of a number of songs available. In the second filtering step, a plurality of predetermined media sources are used in combination with suggestions from a network of trained remote contributors to select a second subset of songs from the first subset, wherein a number of songs included in the second subset is less than 30% of the number of songs in the first subset. In the third filtering step, each song included in the second subset is scored with information related to consumer listening and purchasing behavior obtained from a plurality of predetermined data sources. In the fourth filtering step, a plurality of raters is used to classify each song included in the scored second subset according to a predetermined set of five criteria. In the fifth filtering step, the categorized songs surviving the fourth filtering step are subject to final approval by editorial staff.

In another aspect, the invention provides a portable music player storing a plurality of song files, each song file including data corresponding to song title, artist, genre, era, year of (preferably original) release, mood or tempo, and estimated audience reach.

In yet another aspect, the invention provides a music provider server including a processor, and a memory storing a plurality of song files, each song file including data corresponding to song title, artist, genre, era, year of original release, tempo, and audience reach. An interface is provided to couple the server to a network, such as the Internet.

In still another aspect, the invention provides a method of providing a consumer with digital music files, comprising the steps of: (i) selecting a plurality of digital music files from among a predetermined group of digital music files, the selecting step including the step of categorizing each selected digital music file in accordance with music title, artist, genre, era, year of original release, tempo, and audience reach; (ii) storing the selected digital music files in a memory; (iii) receiving from the consumer a request for digital music files; and (iv) providing the consumer with the requested digital music files, wherein each digital music file includes data corresponding to music title, artist, genre, era, mood/tempo, and audience reach.

In still another aspect, the present invention provides a method of operating a subscription music service over the Internet, comprising the steps of: (i) storing on an Internet server a plurality of digital music files, each file including indicia of music title, artist, genre, and audience reach; (ii) receiving a subscription payment from a consumer; (iii) receiving from said consumer an Internet request for a digital music file; (iv) if the subscription of said consumer is current, downloading over the Internet the requested digital music file from the Internet server to said consumer, the downloaded digital music file including the indicia of music title, artist, genre, and audience reach; and (v) if the subscription of said consumer is not current, prohibiting the downloading of the requested digital music file.

In still another aspect of the present invention, a two or three-click method of Internet-downloading music files to a consumer, comprises the steps of: (i) identifying with a first click a memory capacity of a consumer's portable music player; (ii) identifying with a second click a predetermined library of music files the consumer wishes to download; and (iii) following said second click, downloading to said consumer over the Internet the requested library of music files. With a third click, the consumer can side load the downloaded songs to his/her portable music device.

### BRIEF DESCRIPTION OF THE DRAWINGS

FIG. 1 is a block diagram of the structural details by which the preferred embodiments generate and update the Playlist Generator Database™, and allow consumers to download pre-categorized song libraries

FIG. 2 is a flow chart that illustrates a preferred method for generating and updating the Playlist Generator Database™, according to a preferred embodiment of the invention.

FIG. 3 is a more detailed flow chart that illustrates the preferred method for filtering and classifying songs, according to a preferred embodiment of the invention.

FIG. 4A is a diagram that illustrates a preferred set of media sources used in the second filtering stage of FIG. 3; and FIG. 4B is a flowchart illustrating Filter #2 processing.

FIG. 5 is a diagram that illustrates a set of moods and tempos used in the stage of classifying songs in the method illustrated in FIG. 3.

FIG. 6 is a diagram that illustrates a set of genres used in the stage of classifying songs in the method illustrated in FIG. 3.

FIG. 7 is a diagram that illustrates the contents by genre and artist for a 510-song set of 5-star songs as rated in the method illustrated in FIG. 3.

FIG. 8 is a diagram that illustrates a star ratings forced curve fit for an exemplary 14,000 song playlist.

FIGS. 9A and 9B illustrate an exemplary list of channels (preselected playlist options) which the consumer may use to generate playlists from the song library or libraries resident on his/her PC and/or portable music player, while FIG. 9C is an example of a Raters Work Assignment Sheet.

FIG. 10 is an illustrative table of device size versus song libraries for various types of listeners.

FIG. 11 is a screen shot of the PushButtonMusic™ website table of contents.

FIG. 12A illustrates the first screen that the consumer will see at the PushButtonMusic™ website, and FIG. 12B illustrates the screen the consumer sees when he/she selects the first option in the FIG. 12A screen.

FIGS. 13A-13I are screenshots for the first option from FIG. 12B.

FIGS. 14A-14J are screenshots for the second screen from FIG. 12A.

FIGS. 15A-15E are screenshots for the third screen from FIG. 12A.

FIGS. 16A-16L are screenshots for the fourth screen from FIG. 12A.

FIG. 17 is a screenshot for the fifth screen from FIG. 12A.

### DETAILED DESCRIPTION OF THE PREFERRED EMBODIMENTS

### 1. Introduction

The present invention relates generally to apparatus, methods, and data structures that facilitate the generation of playlists from a database of pre-selected, pre-categorized, and rated songs. While the below description involves generating an approximately 30,000 song database housed on an Internet server, from which consumers first download selected pre-categorized song libraries to their PCs, and then side load the libraries and/or playlists their portable music players, the invention is equally applicable to: (i) direct downloading such libraries and/or playlists to music players such as iPods™, MP3 players, cellular telephones, laptops, PDAs, etc.; and (ii) housing one or more such song databases on one or more servers resident on public or private local or wide area networks. The preferred embodiments allow entire libraries (as opposed to piecemeal songs and playlists) to be pre-loaded and/or fully loaded onto PCs and portable music players.

Generally, the preferred embodiments provide methods and apparatus for consumers to easily download multi-song libraries, on-demand, from an on-line database of highly selected, pre-filtered, pre-categorized songs to their PCs, and then generate predetermined or self-determined playlists which are side loaded onto their portable music players. As described in greater detail below, this Playlist Generator™ database may be updated with current material on a daily basis. The goal of the system is to provide consumers with a digital music player (such as an MP3 player) that is fully-loaded with thousands of songs and thousands of possible playlist combinations, without spending a significant amount of time doing it themselves on a PC. In use, a service (subscription) provider like PushButtonMusic™ selects, filters, categorizes, stores, and maintains a music database of songs on one or more on-line servers. Consumers that subscribe to the service, and have music-enabled PCs, can then go to the provide's website and download specific playlists, one of nine predetermined song libraries, or the entire 30,000 song Playlist Generator™ database. While many consumers will only want a Playlist Generator™ song library that can be stored on their portable device, many will choose to download a library for their PC that is much larger than what their portable device itself can hold. This is especially true of owners of small capacity MP3-enabled mobile phones. One reason is that 30,000,000 listeners use the PC itself as their receiver/stereo. Once on his/her PC, the consumer can use a plurality of the five criteria discussed above to generate specific playlists of songs to side load to his/her portable device. Or alternatively, he/she can simply choose to go to the website and choose an entire Playlist Generator™ database and/or a number of pre-selected playlists that is “recommended” for a portable device of that size. This is a true “one key stroke” or passive download solution. In each case, the Playlist Generator™ song database will allow consumers to generate a variety of playlists to fit the criteria selected by the consumer. In this manner, even a tiny Playlist Generator™ database can generate hundreds of playlists. By loading a Playlist Generator Database™ instead of a loosely compiled group of songs and playlists, the consumer can better retrieve what they want. Imagine the Library of Congress with no uniform classification system for the books.

The present invention may also be used by MP3 manufacturers to pre-load devices in a system that is passive to the consumer. In particular, portable music player manufacturers may pre-load their products with one or more playlists downloaded from the Playlist Generator™ database, in order to offer consumers a wide variety of preloaded music players. After purchasing a pre-loaded device, subscribers would then utilize the company's website as detailed above to add music or update their library and/or playlists on a daily basis. For example, a 10 Gbyte blue-colored MP3 player may contain 2,000 Blues songs; a 30 Gbyte red-colored MP3 player may have 7,500 Rock/Pop songs, and a 5 Gbyte MP3 player with yellow crosses depicted thereon may contain 1250 Gospel songs. Thus, the present invention provides many channels through which to provide the most interesting music to the most consumers without the tedium of endless Internet hours searching for and choosing songs to download. The ability to offer a predetermined number (e.g., 115) standardized device libraries allows an entire product line of portable devices to be pre-loaded or fully loaded to address specific consumer tastes, and device capacities, from a single database.

### 2. The Structure of the Preferred Embodiments

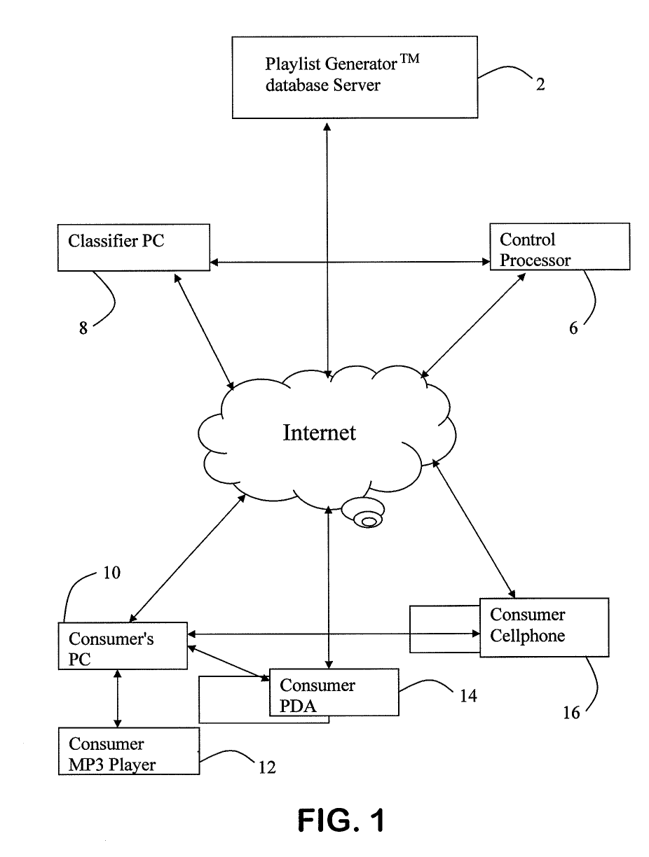

With reference to FIG. 1, the Playlist Generator Database™ resides one or more server(s) 2 that is/are preferably coupled to the Internet 4. A control processor 6 is used (in a manner to be described below) to control the upload to and download from the server 2. The control processor 6 may be a part of the server 2, or may be a separate server connected to the server 2 directly or through the Internet 4. A classifier Personal Computer (PC) 8 is used by paid raters (to be described below) to categorize songs uploaded to the server 2. The classifier PC 8 may be coupled to the server 2 and the processor 6, directly and/or through the Internet 4. The consumer typically uses a PC 10 to access the server 2 through the Internet 4, although direct connections may be offered. Song playlists downloaded to the consumer PC 10 may be side loaded to the consumer's MP3 player (or iPod™) 12. Direct download of song playlists from the Internet 4 may also be provided to the MP3 player 12, a consumer Personal Digital Assistant (PDA) 14, and/or a consumer cell phone 16. Various alternative connection schemes are possible as technology advances. All of the connections depicted in FIG. 1 and described above may be wired or wireless connections using the most current technology, such as, for example, an Ethernet connection, an RS-232 connection, 802.11 protocol, or the like.

The server 2 is preferably implemented by the use of one or more general purpose computers, such as, for example, a Sun Microsystems F15k. Each of the processor 6 and the PCs 8 and 10 are also preferably implemented by the use of one or more general purpose computers, such as, for example, a typical personal computer manufactured by Dell, Gateway, or Hewlett-Packard. Alternatively, each of the server 2, the processor 6, and the PCs 8 and 10 can be implemented with a microprocessor. Each of the server 2, the processor 6, and the PCs 8 and 10 may include any type of processor, such as, for example, any type of general purpose microprocessor or microcontroller, a digital signal processing (DSP) processor, an application-specific integrated circuit (ASIC), a programmable read-only memory (PROM), or the like. Each of the server 2, the processor 6, and the PCs 8 and 10 may use its processor to read a computer-readable medium containing software that includes instructions for carrying out one or more of the functions of the respective element, as further described below.

Each of the server 2, the processor 6, and the PCs 8 and 10 can also include computer memory, such as, for example, random-access memory (RAM). However, the computer memory can be any type of computer memory or any other type of electronic storage medium that is located either internally or externally to the respective element, such as, for example, read-only memory (ROM), compact disc read-only memory (CDROM), electro-optical memory, magneto-optical memory, an erasable programmable read-only memory (EPROM), an electrically-erasable programmable read-only memory (EEPROM), a computer-readable medium, or the like. According to exemplary embodiments, the respective RAM and/or ROM can contain, for example, the operating program for any of the server 2, the processor 6, and the PCs 8 and 10. As will be appreciated based on the following description, the RAM and/or ROM can, for example, be programmed using conventional techniques known to those having ordinary skill in the art of computer programming. The actual source code or object code for carrying out the steps of, for example, a computer program can be stored in the RAM and/or ROM. The database stored in server 2 can be any type of computer database for storing, maintaining, and allowing access to electronic information stored therein.

In the following, the generation and updating of the Playlist Generator Database™ will be described first, followed by a description of how consumers can access and download desired playlists.

### 3. Generation and Updating of the Song Database

### A. Initial Upload

The generation and updating of the Playlist Generator Database™ uses the Music Content Management System™ to be described below. Initially, the universe of 4,000,000 known songs must go through a filtering and classification process so that the Playlist Generator Database™ may be populated with a small, but manageable number of the most popular songs. Thereafter, the Playlist Generator Database™ will be updated on a periodic basis (perhaps daily, weekly, monthly, etc) to infuse the database with new and listen-worthy songs. Generally, the initial uploading process first filters out roughly 30,000 songs from the roughly 4,000,000 digital music files now available. Each song is then individually classified and rated using five additional criteria. Thus, each song in the server 2 has data appended thereto indicative of these five criteria, in addition to data designating the artist, album, and song name. Of course, more or less than 30,000 songs my be selected as the core of the song database. For present market conditions, it is believed that at least 20,000 (more preferably, 25,000, even more preferably 30,000, or 35,000, or 40,000) songs will comprise the database. Many more songs will not restrict the database to only the best songs, while many less songs will not provide enough variety for most listeners. Presently, the most preferred embodiment allows only the top 30,000 songs (based on estimated audience) reach to remain in the Playlist Generator Database™. This “forced curve” limitation will avoid allowing the database to grow and grow and become less meaningful. Older songs that are classics will always have some current audience reach/appeal. But, a lot of songs will not have enough remaining appeal to remain in the top 30,000. Each month those songs with “near zero” current audience reach will be removed from the Playlist Generator Database™ itself. While subscribers can access them on their PC, they will not appear in the most current PC or Device libraries.

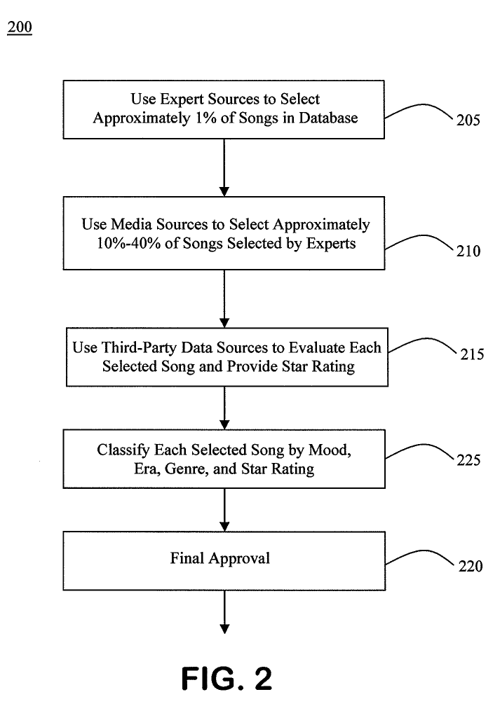

Referring to FIG. 2, the flow chart 200 illustrates a preferred method of initially uploading the 30,000 songs into the Playlist Generator Database server 2. Each step in FIG. 2 will be discussed in greater detail below. In the first step 205, Filter #1 uses expert sources (e.g., the songs broadcast by terrestrial radio disc jockeys) to select a portion of songs in the overall song universe, thus providing a first subset of approximately 4,000,000 of the most played/listened-to songs. Then, in the next step 210, media sources (e.g., the songs broadcast in Cable Music playlists) are used in Filter #2 to select approximately 10% to 80% (and more preferably, 35% to 75%) of the songs surviving Filter #1, to provide a second subset of approximately 30,000 songs. In this manner, the number of songs has been reduced in Filter #2 by a factor of approximately 99.2%-99.6%. In the third step 215, third-party data sources (e.g., CD sales) are used to score or weight, each of the remaining selected songs. This scoring assists raters to assign audience reach in Filter #4 as discussed below. For the initial song upload, it is possible to delete Filter #3 since the great majority of the previously-released 30,000 songs that survive Filter #2 will most likely satisfy the Filter #3 processing. In the fourth step 220, a staff of raters utilizing a set of carefully determined guidelines in Filter #4 rates each song with five separate criteria in addition to artist name, album, and song name. These five additional criteria preferably include five “Star” levels of Audience Reach ranking, four Mood/Tempos, six Eras, and any combination of 28 genres. Finally, at step 225, the last Filter #5 is used by the provider's senior staff to approve/disapprove the classification and ratings of all songs which are candidates that survived Filter 4 processing prior to inclusion in the Playlist Generator Database server 2.

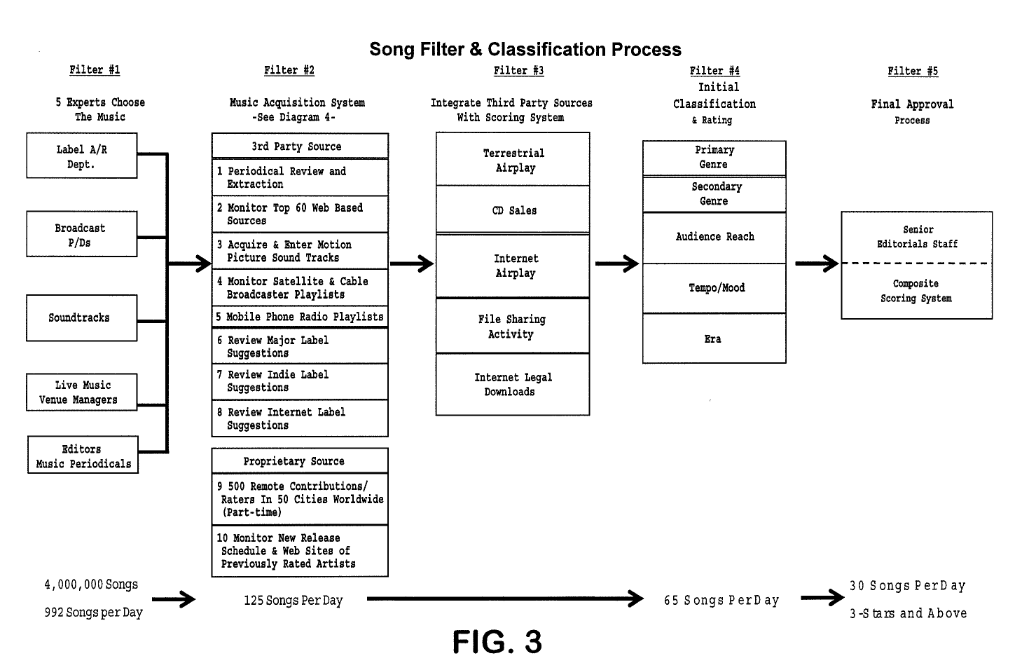

Now, in more detail, FIG. 3 presents a detailed overview of the song filter and classification process according to a preferred embodiment of the invention. Filters #1, #2, and #3 are designed to dramatically narrow the universe of songs considered as candidates for inclusion in the final database. In Filter #2, the Music Acquisition System is designed to identify the relevant songs from hundreds of Internet-based and traditional sources of music. Filter #3 then systematically integrates information regarding consumer preferences, listening and purchasing habits. As a result, there is no need to involve individual users in this process. With respect to individual tastes and preferences, these narrowing techniques are based on the invention disclosed in U.S. Pat. No. 4,843,562, in which it is found that there is a surprising consensus among individuals regarding which songs are most desirable. As it turns out, a very small subset of the 4,000,000 song universe makes up 98% of all the music listened to or purchased either over the Internet or from traditional sources.

The filtering and classification system of the present invention is designed to choose a narrow universe of approximately 30,000 songs and individually classify and rate those songs by five separate criteria. In a preferred embodiment, for an 80 Gigabyte device, 19,000 songs and 500 “channels” (predetermined playlist criteria) are downloaded, and the channels are displayed on the menu of a portable MP3 player as a convenience to consumers. Because the system allows the listener to carry the entire recommended song database on an 80-gigabyte portable MP3 player, the consumer can select any one of the channels to quickly and easily listen to a desired playlist. However, active listeners can generate up to 1.8 billion different playlists on demand from the same 30,000 song database on their PC, to determine what playlists are side loaded to their portable device.

Smaller subsets of this database are also maintained to address small capacity devices that provide, for example, only 500, 2,000, or 5,000 songs. As described above, the system also provides 500 (or up to 1,000) of the most likely song combinations or playlists in a numbered fashion similar to cable TV or satellite radio. These channels may be stored on the MP3 player as noted above, or may be used on the consumer's PC to narrow the 14,000 to 30,000 song library to a smaller size library or playlist to be side loaded to a smaller-memory portable device. This allows the consumer to choose from hundreds of playlists on-demand to be side loaded to the portable device. However, less common combinations, selected by the consumer, can also be chosen on the consumer's PC and side loaded to the portable device. While the consumer is not required to choose a single song or artist in order to enjoy the entire 30,000 song collection or the pre-programmed channels, he/she is free to do so. Moreover, the same song may appear in numerous different playlists on the same portable MP3 player. Referring to FIG. 3, the preferred embodiment provides a database of individual songs by utilizing a five stage process to select, acquire, classify, rate, and retrieve songs.

### (1) Filter #1: Five Experts Choose the Music

It is estimated that roughly 4,000,000 songs are now available via the Internet, and 2,700,000-song libraries of properly licensed music are common among major online music portals such as Apple iTunes, MTV/Urge, AOL, Music, and Rhapsody. Meanwhile, community sites such as MySpace and others now boast of hundreds of thousands of bands and songs, most of which do not appeal to a significant audience. These huge numbers are irrelevant to a passive music listener, because most of this music is simply bad and of no interest to a wide audience of passive listeners. Unfortunately, existing systems for recommending and retrieving music search 2,000,000 to 4,000,000 songs to identify potential candidates. These systems therefore include songs that were never, and will never, be considered worth listening to by a significant audience simply because their digital fingerprint or compositional elements match according to some mathematical algorithm or “similar artist”-type formula.

Fortunately, nearly all the music heard or purchased anywhere in the world has already been screened by one or more of the five expert sources noted below. Thus, PushButtonMusic™ takes advantage of this work in Filter #1 to exclude those songs not found worthy of publication by the experts. If it is not published by one of the five expert sources, PushButtonMusic™ need not consider a song further. According to the preferred embodiment, PushButtonMusic™ staff or hired contractors review the output (manually or electronically) of the below-listed expert sources to conduct further screening of songs in Filter #2:
The A/R departments of record label companies. These include four major label groups, 100 reasonably respected independent (“indie”) labels, and Internet-only labels.
The program directors of terrestrial, satellite, and Internet-radio networks, and local disc jockeys.
Soundtrack editors of movies and television programs.
Live venue owners and managers. These include major concert amphitheatres as well as respected bars and night spots in college towns.
Editorial staff members of major music industry periodicals, as well as the charts and listener activity published by those same periodicals (i.e. the Billboard charts).

The five experts described as Filter #1 all play a slightly different role in deciding what music will be made available to consumers through normal commercial channels. For example, the Artist Relations (A/R) of the four major label groups and thousands of “internet only labels” hear hundreds of artists they do not sign or promote. Most of the 135,000 artists with websites on MySpace never clear that hurdle. Broadcast programmers (P/D) must then choose a very narrow set of what the major and indie labels promote to them to play for their own targeted audiences. Editors from music magazines, such as Billboard and Rolling Stone, then chart this small universe of songs and often recommend their favorites. Most soundtrack editors pick an extremely narrow list of artists and songs to fit a particular movie and present huge “breakout” opportunities for new arties. Live music venue owner/managers give many lesser known acts a chance to show off their stuff and earn a little money. By relying upon the most respected experts, the candidate song universe is dramatically narrowed, and a consistent and high quality list of songs with no irrelevant or unfavorable songs is generated. Of course, greater or fewer than these five expert sources may be used, depending upon the number and type of songs desired in the Playlist Generator Database™.

Thus, after the Filter #1 processing (Step 205 in FIG. 2), approximately 4,000,000 of the most popular and listened-to songs published as far back as 1928 are identified for further processing.

### (2) Filter #2: Music Acquisition System

Unfortunately, even the expert sources of Filter #1 produce, promote, and even broadcast a lot of really bad music. One reason is the label's desire to sell an album containing 10 songs, when all the consumer cares about is one or two. In fact, many existing methods for retrieving music have failed to account for the fact that albums are largely dead. In the digital music age, consumers cherry-pick the singles they want. For example, music consumers now download roughly 1.5 million songs per month on illegal file sharing networks—they rarely bother with whole albums. The days of consumers buying an album costing $9.99 or $15.00 to put one or two songs in their personal library are ending much faster than industry experts anticipated only two years ago. Broadcasters, however, have adapted to these simple realities for years when addressing a passive audience. They play songs, not albums. Accordingly, the system of the present invention incorporates this reality into its own music retrieval system by further limiting the number of songs resident in the Playlist Generator Database™ server 2.

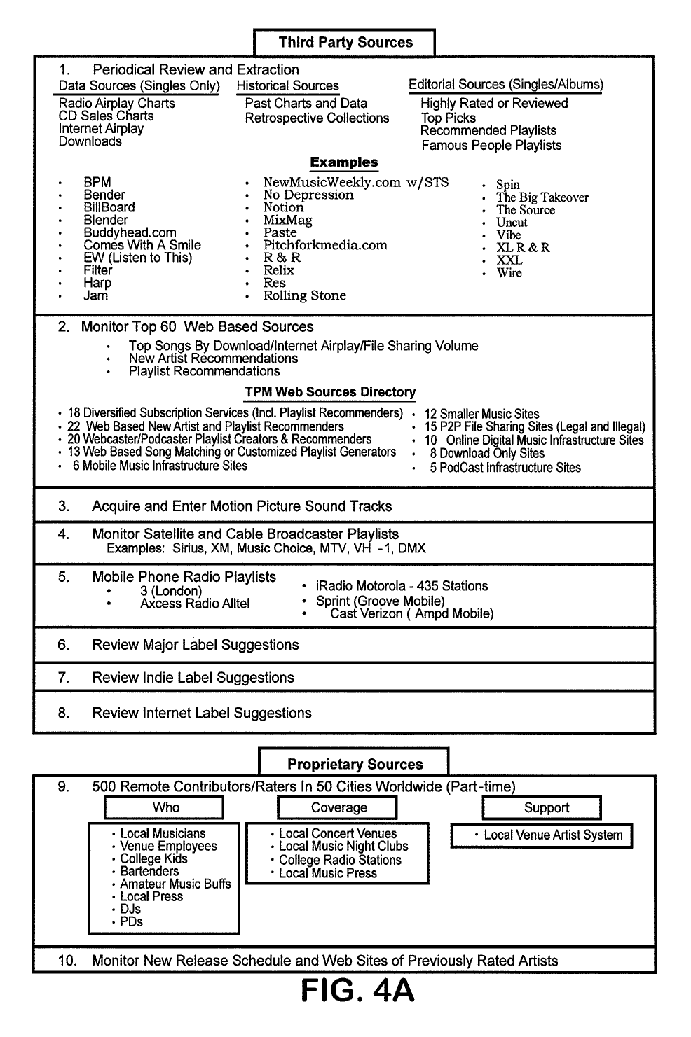

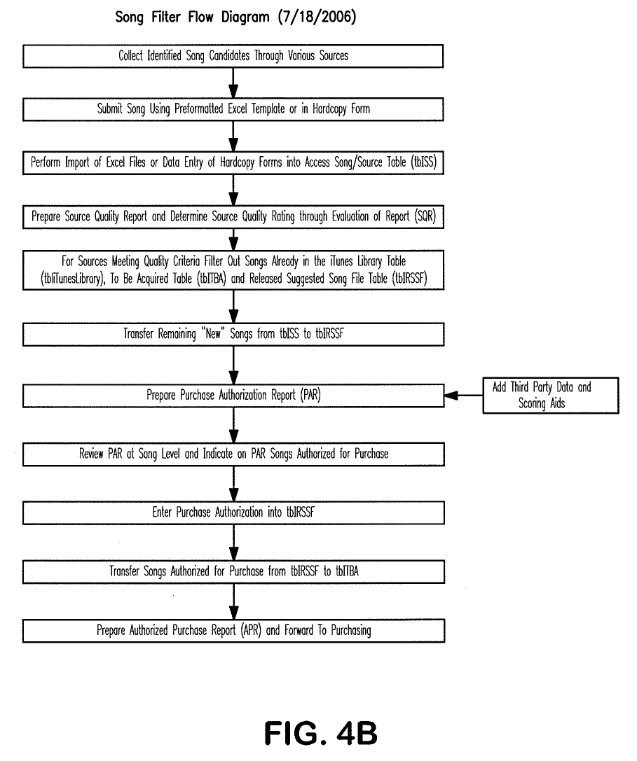

Accordingly, referring to FIGS. 3 and 4, in order to populate the Playlist Generator Database™ with only the most sought-after of the 4,000,000 songs surviving Filter #1, the preferred embodiment integrates information from selected media sources into Filter #2 (step 210 in FIG. 2). Filter #2 is preferably subdivided into two parts: Third Party Sources; and Proprietary sources. Third Party Sources preferably include eight different sources (see FIG. 4A), while the Proprietary Sources preferably include two different sources. Of course, Filter #2 may include any number of sources currently available to further limit the song database to a manageable number of perhaps 30,000 songs.

In Filter #2, PushButtonMusic™ staff or hired contractors electronically and physically research eight sources of media information that reflect the opinion of a subset of the Filter #1 experts. These are shown in FIG. 4A. “Suggested Song Files” from these media sources are then merged with “Suggested Song Files” from the remote Contributor network (to be discussed below) to create a combined list of suggested songs for further processing. A preferred Access-based computer platform that controls the entire Content Management System then automatically scans this Suggested Song List and removes about 80% of the duplications. Table 1 below depicts the steps required to process these suggested songs, prior o Filters 3, 4, and 5, as described below.

TABLE 1
Steps For Processing Suggested Song Files

| | |
|---|---|
| | 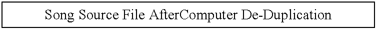 |
| CO-III-5 | Perform Manual De-Duplication |
| CO-III-6 | Load Songs to TBA File |
| | 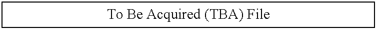 |
| CO-III-7 | Purchase Songs/Update TBA Status One Song At A Time |
| CO-III-8 | Post Purchase Clean-Up Procedure/Update Unavailable File |
| | 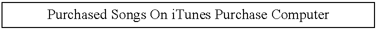 |
| CO-III-9 | Conduct Artist Assignments As Required |
| CO-III-10 | Transfer Songs to iTunes Library |
| | 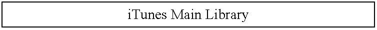 |
| CO-III-11 | Import Current iTunes Library Into Access |
| CO-III-12 | Conduct WAS and iPod Loading Procedure |
| CO-III-13 | Review Submitted Ratings For Errors |
| CO-III-14 | Enter Initial Ratings |
| CO-III-15 | Conduct WAS and iPod Loading Procedures For Senior Rater |
| CO-III-16 | Enter Senior Ratings |
| CO-III-17 | Load: Final Needs Approval iPod |
| CO-III-18 | Enter Final Approval |
| CO-III-19 | Load Full iPods |

The thus-located songs are purchased, updated, and entered into the Playlist Generator Database™ server 2 by the staff for further filtering. Alternatively, software may be written to automatically access electronic output from these sources to automate the input of songs into the server 2. The automated embodiment is preferred since, as will be described below, new songs will be filtered and added to the server 2 on a periodic basis in extremely large volumes from all the sources described in Filter 2 below.

(2a) Filter #2: Third Party Sources

Preferably, the Third Party Sources (Media Sources) of popular music used in Filter #2 include (i) Periodical Review and Extraction, (ii) Monitor Top 60 Web Based Sources, (iii) Acquire and Enter Motion Picture Sound Tracks, (iv) Monitor Satellite and Cable Broadcaster Playlists, (v) Mobile Phone Radio Playlists, (vi) Review Major Label Suggestions, (vii) Review Indie Label Suggestions, and (viii) Review Internet Label Suggestions.

(i) Periodical Review and Extraction. To filter songs in the Playlist Generator Database™, PushButtonMusic™ staff or independent contractors may physically review music industry periodicals and extract lists of the most popular songs. Many of these sources are extracted automatically in step CO-III-I as shown Table 1. For example, PushButtonMusic™ staff or independent contractors may consult such Media Sources (for Single Songs) as Radio Airplay Charts, CD Sales Charts, Internet Airplay Publications, and Internet Download Publications. PushButtonMusic™ staff may also consult Historical Media Sources such as published Past Charts and Data and Retrospective Collections. Finally, the PushButtonMusic™ staff may consult Editorial Media Sources (for Singles and/or Albums) such as Highly Rated or Reviewed Top Picks, Recommended Playlists, and/or Famous People Playlists.

Examples of Periodical Media Sources reviewed for this portion of Filter #2 are shown in FIG. 4A and include: BPM; Bender; Billboard; Blender; Buddyhead.com; Comes With A Smile; EW (Listen to This); Filter; Harp; Jam; NewMusicWeekly.com w/STS; No Depression; Notion; MixMag; Paste; Pitchforkmedia.com; R & R; Relix; Res; Rolling Stone; Spin; The Big Takeover; The Source; Uncut; Vibe; XLR & R; XXL; Wire; etc. Of course, sources may be added or deleted as they gain or lose in relevancy over time.

The review and extraction of the identities of popular songs from periodicals is preferably automated via appropriate software interfacing with electronic output from the relevant periodical sources.

(ii) Monitor Top 60 Web Based Sources. PushButtonMusic™ staff or independent contractors may also physically review the top 60 (or any convenient number) of web-based sources to identify songs that will be added to the song database. Again, such review may be automated through simple software code. Such web-based sources may include: the top songs downloaded over the Internet for a given week, month, year, or ever, etc.; new artist recommendations; and playlist recommendations, from any of the sources noted in FIG. 3.

Preferably, the 60 web-based sources are chosen from among the following, although this list will change over time:

18 Diversified Subscription Services (Incl. Playlist Recommenders)
AOL Music Now
Amazon
Cdigix
HMV
iMesh
EMusic (Dimensional Fund/Indie Focus)
iTunes—Mostly Download/Not Subscription
Napster—Roxio (Pressplay)
MSN Music (with GarageBand)
MTV
MusicNet—1999 Consortium, Infrastructure, Baker Capital
RealNetworks—Rhapsody
Target
Transworld Entertainment
Virgin
Yahoo—LAUNCHcast
Yahoo—Music Match (Auto DJ)
Yahoo! Webjay (Playlist Sharing Website)

22 Web Based New Artist and Playlist Recommenders
Acclaimedmusic.net
Allmusic.com
ArtistServer.com/Electronica
BuddyHead.com
CDBaby.com—CD Retailer
Clear Channel New Artists
Fresh Tracks
GarageBand/MSN
MP3Unsigned.com
Magnatune.com
Metacritic.com
Music.MySpace.com
MusicStrands
MyMixedTapes.com
Muze.com
PitchforkMedia.com
Planet of Sound
Players Music IP
PureVolume.com
RedButton.com
Sire Systems
Sugaroo.com

20 Webcaster/Podcaster Playlist Creators & Recommenders
AOL Radio Network (Free and Paid)
Backbeat Podcast Network—Commercial
Clear Channel Radio Web Sites
Clear Channel—Premier Radio
E-Music Radio
Live365.com—5,000 hosted Podcasts (Free and Paid)
Mecora.com IM Radio—Allows Downloads
MSN Radio Plus (Free and Paid)
Napster/XML—Radio (PressPlay)
Pandora Radio—Create Your Own Streaming Radio Station
Radio 365 Web Cast—Auto Request System
Radio@Netscape Plus: (Spinner.com)—150 Stations
iRadio/Motorola—400 Stations
Rhapsody Radio—100 Stations Subscription/25 Free/Provider to Comcast, Sprint)
Rule Radio.com
Shoutcast.com—Free, Will Play Through iTunes
VH1.com Radio—Has Themes—Moods
Yahoo! LAUNCHcast Radio Service (also Music Match) (Free and Paid)
Yahoo! Radio Network (2.6 million listeners)
Yahoo! Webjay (Playlist Sharing Website)

15 Web Based Song Matching or Customized Playlist Generators
Amazon.com
Grace Note
Last FM—People with similar playlists
MOG.com—Social network recommending songs
Music Genome—Song Matching Software
Music IP
MusicStrands
MyStrands.com—tracks songs you play
Pandora—Algorithm
Rhapsody—Playlists Based on Favorite Artist
Rhapsody—Playlist Central Sharing Lists
Siren Systems
Yahoo—LAUNCHcast—Construct Your Own Playlist
Yahoo—Music Match—People With Similar Tastes Like This (Juke Box 10)
Yahoo—Webjay (Playlist Sharing Website)

9 Mobile Music Infrastructure Sites
36U Upload (acq. Mophone)—Mobile Entertainment Portal—4,000,000 users
Amp'd Mobile
Groove (Sprint)
Hands-On-Mobile (was MForma)
Helio—MUNO (For “Hero” and “Kickflip” devices
InfoSpace
Music Waver Mobile Music Download Services
Verizon V-Cast
Virgin Mobile USA

12 Smaller Music Sites
About Music
AudioLunchBox.com
Drowned in Sound (Foreign Acts)
Live Music Archive (archive.org/audio/ETREE.PHP)
Mix and Bun
MuchMusic.com
Passalong.com
People Sound/Vitaminic Music Network
Secondhandsongs.com
SongConnect/Sony
Soundtrack.net/trailers
Whatsthatcalled.com

15 P2P File Sharing Sites
ArtistServer.com
BitTorrent
eDonkey
FastTrack
FreeNet
Gnutella
Grokster
Kazaa
Limewire
MashBoxx
Mecora
Morphers (Steamcost)
Qtrax (ad supported)
SoulSeek
WinMX

11 Online Digital Music Infrastructure Sites
CDBaby.com—CD Productions for Indies
Entrig—Protect, Monetise, Publish
IODA (iodalliance.com)—Aggregator Indie Music
Loudeye.com—Digital Music Services
Musicane—Content Payment Processing
MusicGenome—Song Matching Software
MusicGiants.com—Super Quality Audio Downloads
Music IP—Song Matching Software—Acoustic Discovery
MusicNet
Passalong Networks P2P Revolution Platform
PumpAudio—Licensor of Digital Music to Show Television Producers

7 Download Only Sites
BuyMusic
Buy Music
Download Punk
Music Now
OnDemandDistribution (OD2, Europe)
SonyConnect
Wal-Mart

5 PodCast Infrastructure Sites
Audible—Spoken Content for iPods
iPreppress—books for Podcasts
Odeo
PodCastReady
Yahoo! Webjay (Playlist Sharing Website)

(iii) Acquire and Enter Motion Picture Sound Tracks. PushButtonMusic™ staff or independent contractors may also physically review all released Motion Picture Sound tracks for songs to be added to the song database. Again, this process may be automated with appropriate software.

(iv) Monitor Satellite and Cable Broadcaster Playlists. Again, PushButtonMusic™ staff or independent contractors may review selected satellite and cable music broadcasters to identify those songs that are to remain in the song database. Sources such as Sirius, XM, Music Choice, MTV, VH-1, DMX, etc., may be monitored physically or automated on a periodic or continual basis.

(v) Mobile Phone Radio Playlists. The PushButtonMusic™ staff or independent contractors may also review selected mobile phone playlists to locate songs to add to the song database. For example, the carrier 3 London; Axcess Radio Alltel; iRadio Motorola—435 Stations; Sprint (Groove Mobile); and V-cast Verizon (Amp'd/Mobile) may be physically monitored or monitored electronically with appropriate software code to add to the songs which will added to the song database at the end of Filter #2.

(vi) Review Major Label Suggestions. The PushButtonMusic™ staff or independent contractors may see song releases of the major music label companies by watching the release schedules on their websites. Popular songs are easily obtained this way. This process may be automated.

(vii) Review Indie Label Suggestions. Similarly, the websites of the independent labels may be reviewed by the PushButtonMusic™ staff or independent contractors for suitable songs to be added to the song database. Again, this process may be automated.

(viii) Review Internet Label Suggestions. The PushButtonMusic™ staff or independent contractors may likewise monitor or review the websites of the companies which release songs through the Internet. Since the songs themselves can easily be obtained through the Internet, this process can also be automated.

### (2b) Filter #2: Proprietary Sources

Also included in Filter #2 are two proprietary sources, as shown in FIGS. 3 and 4. The first proprietary source preferably includes a network of hundreds of (preferably 500) trained part-time Remote Contributors. These contributors preferably undergo rigorous training and online examinations concerning all aspects of the Rated and Classification Guidelines in order to be admitted to, and then remain, a Remote Contributor. Preferably, such contributors are music-savvy such as local and/or professional musicians, local music venue employees, college kids, bartenders, amateur music buffs, local music press reporters, DJs, radio station program directors, etc. This network of Contributors covers local music venues, local music night clubs, college radio stations, and the local music press (and their websites). Contributors are used to find out what the Venue Managers and other “experts” are playing in their local clubs, etc. This provides an early detection system for artists that have not yet received a record contract and are therefore unlikely to show up in the third party sources discussed above. In practice, these Contributors forward to the PushButtonMusic™ staff lists of songs which are deemed worthy of inclusion in the song database. Since these locally-discovered songs are not likely to be derived from the Media Sources shown in FIG. 4A, they will be added to the existing song database by PushButtonMusic™ staff.

Preferably, the trained Contributors work on a part-time basis via the Internet. As stated above, these Contributors cover sources not well represented in the eight Media Sources described above. In addition, they are constantly blogging and surfing the net for song suggestions that the preferably automated web search system described above may miss. These include certain locations within major music portals and community websites such as MySpace. These Contributors preferably will be required to pass a number of online examinations and training exercises to be qualified as a PushButtonMusic™ Contributor. As a result of this training, the Remote Contributor Network produces a large volume of highly desirable song suggestions, many of which are still unknown to the experts and media sources described earlier. Preferably, these Contributors are paid only for songs the song database does not already have, for example, on a per-star basis (to be described below). For example, simply suggesting a song not already on the song database that achieves a 5-Star audience reach (in Filter #4 to be described below) pays $10.00 to the Contributor. If the song is from an artist that is new to the system, it could pay, for example, $35.00.

The second proprietary source in Filter #2 is PushButtonMusic™ staff or independent contractors who monitor the websites, tour schedules, and release schedules of artists that have already been detected and have songs already in the song database that are rated highly. This includes many younger artists without major label contracts. This second source informs the Contributor Network of the first proprietary source of activity regarding the rated artists assigned to them. This unique source provides valuable information to assist the remote Contributors discover new artists and songs.

The next step in Filter #2, is a preferably automated method for determining whether or not a suggested song is already in the database, as shown in Table 1. Given that hundreds of songs enter the system daily from the wide variety of sources described above, this automated de-duplication system is helpful. The system then generates a Source Quality Report™ (SQR) that shows what rating was assigned to the duplicated songs already in the system. This tends to suggest what rating level can be expected from a particular source. Later, the staff reviews the classification and rating achieved by the new suggested songs from a particular source to further determine if the source is delivering the quality and type of music needed in the song database.

In greater detail, since Filter #2 generates song suggestions acquired from both non-proprietary and proprietary sources, this means that hundreds of playlists, charts, and lists of favorites from the Contributors will be coming in every day. Sorting through thousands of songs per day is very difficult. To alleviate this problem, the preferred Duplication and Source Quality Control System™ has been adopted. This system provides the SQR™ briefly discussed above. This system is preferably automated and includes a number of steps. In Step #1, an internal Source Editor software module identifies a particular song source from one of the five experts discussed above with respect to Filter #1. This could be a music website, a community networking site, or a hard-copy periodical available online. A number of different automated methods may be adopted to obtain the music, depending on the communication protocol required. The identified songs are then put in a Suggest Song File™ (SSF™). Alternatively, the network of remote Contributors may directly submit Suggest Song Files over the Internet using, for example, an EXCEL© File format.

In Step #2, within seconds, another software module determines which songs the system is already aware of. Preferably, this will identify songs and artists even when the spelling and title format are slightly different. Another software module then gives the Source Editor (or Remote Contributors) four pieces of information:
A. The number of duplications submitted and the “duplication ratio” of songs submitted by that source.
B. What genres the duplicated songs fell into.
C. The audience reach/popularity ranking (star level) of the duplicated songs.
D. A composite SQR™ score based on the current ratings of the duplicated songs
   A source with a high duplication ratio, SQR above 2.5 stars means that the source is providing a good number of songs with an estimated audience reach above the weighted average in the Playlist Generator Database.

Step #3 of the SQR system begins after the new songs have been classified, rated, and approved in Filters 4 and 5 described below. Theses results are then added to the original duplicate songs and a new cumulative SQR™ is run. A new source or Remote Contributor that does not maintain a cumulative SQR™ above 2.5 will eventually be dropped. This quality control system has three major benefits: 1) It insures that the Rater team, in the second part of Filter #2, does not get overwhelmed with poorly suggested songs. 2) It gives the Source Editor feedback on new sources, within minutes. 3) Hundreds of sources with thousands of song suggestions can be processed in a fully automated fashion.

As shown in Table 1, the Filter #2 process preferably uses an Access-based computer system (see FIG. 4B) for sorting through many thousands of song suggestions per day (during daily updating, to be described below) to eliminate duplication from all eight Media Sources as well as song suggestions submitted by remote Contributors over the Internet. This is done by first creating a Suggested Song File in a standardized format from each source. In some cases, these Suggested Song Files are created by extracting song lists from the source in an automated fashion. In other cases, the Suggested Song File is hand-created by the PushButtonMusic™ staff. This system also carefully tracks the source and time of every song suggestion file received by the system, as shown in Table 1, and accepts them on a “first-in” basis. This automation is preferred in the design of Filter #2.

The above-described preferred embodiment of Filter #2 produces numerous advantages in creating a Playlist Generator Database and playlist generation system. 1) This filter eliminates a significant amount of overhead required by traditional music programmers to recommend songs and prepare playlists for broadcast. 2) Aggregating song recommendations from qualified Third Party sources and Contributors eliminates the need to involve consumers or programming staff in the music selection process. 3) Currently, no other music programming system includes a full review of so many Third Party and Contributor sources on a periodic (daily) basis, including a wide array of Internet sources. Even the most active music listeners, including professional programmers, cannot accomplish this on their own. Note that the preferred embodiment does not rely upon the unstructured random opinions of individuals on social networking or community web sites such as MySpace or Mog.com. That is the approach of many of the “song recommender” systems described above in the Background. Rather, the preferred embodiments according to the present invention provide a disciplined, wide-ranging approach which monitors hard data such as actual sales, actual broadcasts, and listening habits.

### (3) Filter #3: Integrate Third Party Data Sources

In Filter #3, songs that survive Filter #2 are then provided with information available from third party data sources. Specifically, data is acquired from third party providers to assist the Raters in Filter #4 (to be described below). Such data includes information regarding terrestrial airplay, internet airplay, file sharing activity, traditional retail sales, and download activity over sites such as Apple iTunes™. This information is inserted onto a Work Assignment Sheet (WAS) that will be sent to the Raters in Filter #4. This gives the rater a number of quantitative estimates of a selected song's Audience Reach and sales activity. The primary objective of Filter #3 is to provide helpful information to the raters in Filter #4, described below, as opposed to reducing the number of songs.

The song database created by this 5-stage filtering system is large enough to include all the highly rated music found on a set of principal sources, which includes the following:
The most discussed songs/bands on MySpace and other music oriented community sites.
The top choices from 60 music websites, including iTunes and E-Music;
Almost every song on every playlist recommended by all eight music subscription portals (e.g. MTV/Urge, Yahoo, AOL, Napster, and Rhapsody);
All songs from Billboard Top 100 Lists for the last 40 years; and
Nearly all of the songs played by R&R “Reporting Stations” over the last 10 years.

In Filter #3, PushButtonMusic™ staff or independent contractors review the information available on a particular song from at least the following five sources to help the Raters in Filter 4 (described below) assign an estimated audience reach to the songs already stored in the song database based on: (i) Terrestrial Airplay Activity, (ii) CD Sales, (iii) Internet Airplay Activity, (iv) File Sharing Activity, and (v) Internet Downloads.

### (4) Filter #4: Initial Classification and Rating System

In general, Filter #4 implements the Music Classification & Rating System™ (part of the Music Content Management System™) to categorize the songs in the Playlist Generator Database™ according to five criteria in addition to artist, album, and song. Judging the so called “quality” of a given song candidate is not the purpose of the Music Classification & Rating System™. Filters #1 and #2 have already identified the top 1% of the 4,000,000 song libraries now available. Rather, in Filter #4 a group of highly-qualified and trained Raters reviews each song in the database and assigns to each song data indicative of (i) that song's “Star” level (estimated Audience Reach), (ii) one of four Mood/Tempos for that song, (iii) one of six Eras for that song, (iv) any combination of 28 genres for that song, and (v) the raters break apart song compilations such as “Best of Bill Withers” or “Rock of 80's” and then look up and assign each individual song with its correct initial release date. Compilations make up roughly 40% of all albums sold both in physical and digital form. However, other services show only the release date of the compilation, not that of the songs themselves. These original release dates in turn allow the end-user to select an entire playlist of songs across 20,000 artists and all 28 genres for a particular year of group of years. These pre-categorized songs, then, become the basis upon which consumers have unparalleled flexibility in generating and downloading any of 1.8 billion possible combinations of playlists.

This system preferably utilizes a group of part-time private contractors willing to make from $10 to $20 per hour listening to and rating music on their PC, working at home over the internet. Most are professional musicians looking for day jobs or former radio station programmers. To make the process more efficient and to improve consistency, a particular artist will normally be assigned to one Rater who is particularly experienced with a particular genre. Artist familiarity cuts the time required to rate and classify music by almost ⅔. Many of the Raters also belong to the network of Filter #2 Contributors, which further insures quality and speed.

Preferably, the Raters are trained to ensure uniform categorization of the database songs. To become a Rater, an individual must first pass an examination, and then be subject to constant training and quality review. A Rater candidate first submits his/her own top 100 songs for review by the PushButtonMusic™ staff. If a high portion of these top 100 songs are resident in the song database, the Rater candidate will then receive the most recent Rater/Contributor Guidelines and an MP3 player with samples of songs already in the database. The candidate will then categorize these sample songs and return their work to the PushButtonMusic™ staff. The Rater candidates are then evaluated to see how closely their categorization of the sample songs matches the existing categorization data already in the database. The Rater candidates whose categorizations most closely match those of the database are selected as Raters. Raters receive on-going training to ensure high quality, uniform application of standards across the entire database. Periodic (perhaps weekly) conference calls and online seminars may be used for training purposes.

Filter #4 thus preferably applies five distinct criteria to each song in the database: (i) that song's “Star” level (estimated Audience Reach), (ii) one of four Mood/Tempos for that song, (iii) one of six Eras for that song, (iv) the song's Original Release Date, and (v) any combination of 28 genres for that song. The criteria and the methods of applying them will be described in more detail below.

(i) “Star” level (estimated Audience Reach). In the absence of a consistent and uniform method to evaluate a subjective criteria such as “quality,” the system uses popularity, which is referred to herein to as audience reach. This allows the purely quantitative information assigned in Filter 3 to help determine a song's current or potential audience reach. This method is consistent with how many consumers think about popular music. Specifically, songs that make the top 40 or the Billboard Top 100 got there from airplay and sales both physical and digital. The first challenge in developing a uniform classification system across many genres is what to do about the “small audience” genres. For example, a very popular jazz song is still unlikely to make the Billboard 100 because its audience reach is too small. Table 2 below shows the audience share by format (or genre) for terrestrial radio in late 2005. This table shows just how different the audience share is among major formats (genres) and tiny formats. Most of the preferred 28 genres fit into these music formats, but many do not. As a result, terrestrial radio cannot offer the diversity available from internet radio platforms such as PushButtonMusic™. PushButtonMusic™ creates libraries of a fixed size that in some cases, represent the best picks across the entire music universe. In this library, a top Jazz song may still receive only a 2-star audience reach despite being recognized by Jazz aficionados as very high “quality.” That is because its overall popularity with other music audiences is still very small. Thus, the preferred embodiments provide a uniform rating system for both small audience and large audience music contained in that library.

A principal goal of the PushButtonMusic™ star rating system is to allow a mass audience of listeners to sample music across many different genres and time periods using a single database or library of songs. This allows subscribers to discover great music from genres, time periods, and artists they are not very familiar with. This type of cross-over programming is not available on either satellite or terrestrial radio which, for the most part, follow traditional radio “format” guidelines. This requires consumers to channel surf in order to find cross-genre music and most of the time, music from small audience genres is just not available.

The problem with a uniform system is that it will include music from both large and small audience genres. While Jazz, for example, has less than a 3% share, it represents a huge repertoire of songs covering many decades. Since the preferred embodiment will deliver a 14,000 or 30,000 song library, only a select group of those small-audience songs, which actually have an audience reach estimate or “cross-over” potential above 2-stars as described below, will be included in the song database. The preferred embodiment provides two solutions to this problem. First, lovers of a particular small genre, such as Jazz, World, Reggae, Bluegrass, Folk, etc. can select a library with a song count heavily weighted to these genres. To that end, the best song list available in those genres from the 4,000,000 songs available have been chosen for inclusion into the song database. Therefore, it is really not necessary for this small audience of listeners to rely upon the star system to find great music in these categories. They simply select “1 star and above” and get everything in that genre. Secondly, for a mass audience with little exposure to small audience genres, they can still rely upon a ranking system based on estimated audience reach. While aficionados can choose jazz music with one or two stars, or by a favorite artist or era, the mass audience will likely select only songs rated 3-Stars or above.

Another problem with existing systems based on individual consumer “quality” scores is that they usually create over 500,000 5-Star songs, making them useless as a search tool. In the present invention, on the other hand, songs that can or do appeal to a larger audience receive a higher star rating than songs that do not. This means, by definition, that very few of the carefully selected Jazz or Bluegrass songs in the preferred embodiment will actually receive an Audience Reach rating higher than 2 stars. As shown on Table 3 below, a 3 star song, should reflect a medium size audience appeal and a “50% Crossover Potential”. That means that one can expect that 50% of the users with this song in their chosen library, will not skip it when it comes on. The result is that users can choose a 3, 4, or 5 star list and hear a few songs from small audience share genres. That is what one would expect from genres commanding less than a 5% audience share. At the same time, small genre lovers can simply click on 1 star and above and hear a much deeper list of songs. The same is true for a particular artist. If the user wants a deep list of songs including those with relatively small mass audience appeal, he/she merely includes 1 star songs in the list. This arrangement thus has nothing to do with quality per se, but creating a single library of songs to cover all genres. Fortunately, this creates a star rating system that still makes sense to a mass audience.

TABLE 3

| | | Share of | Culumative “and |
|---|---|---|---|
| | Crossover/Skip Potential | Rated Songs | Above” Share |
| 0-Star: | Processed But Omitted Songs | | |
| 1-Star: | Deep Playlist Songs | Bottom 20% | 100% |
| 2-Star: | Favorite Songs By That Artist | Next 25% | 80% |
| | Favorite Songs In That Genre | | |
| 3-Star: | 50% Crossover Potential | Next 35% | 55% |
| | Medium Audience | | |
| 4-Star: | 75% Crossover Potential | Next 15% | 20% |
| | Large Audience | | |
| 5-Star: | 95% Crossover Potential | Top 5% | 5% |
| | Mass Audience | | |

Choosing a given star rating means all songs at that rating or higher.
Super songs in a small audience genre may receive only 2 or 3-Star due to limited Audience Reach.
For the best songs in a small audience genre, pick 2-Star and above.

Consumers that choose to do so can download the entire 30,000 Playlist Generator Database to their PC and then select from 115 Device Libraries, ranging from 250 to 25,000 songs to side load to their portable device. In creating a practical embodiment, it must be recognized that a 80 GB MP3 player will only hold 19,000 songs, and many subscribers will request Device Libraries that are far smaller. Therefore, to create these libraries, a narrow universe of music should be selected with the broadest appeal possible to roughly 90 million owners of MP3 players. As a result, the initial 30,000 song Recommended Song File will preferably represent less than 1% of the song universe now available. On an on-going basis only about 13% or 125 songs of the roughly 982 released daily will even be submitted for rater review. Theoretically, all of the songs that are submitted for classification and rating are, by definition, the most appealing from an audience reach standpoint from any artist and any genre. Within this narrow universe any attempt to establish “quality” ratings per se would be almost entirely subjective. Instead, stars are assigned based on estimated Audience Reach or “Cross-Over Potential.” In this regard, a song's star rating should generally reflect the current or potential audience for that song. Fortunately, there is already a broad consensus among the listening public about what constitutes the best music to listen to in every genre. In most cases, these songs will already have demonstrated airplay and sales on the internet or via traditional channels. To assist the Raters, the most current information available from Internet, satellite, and terrestrial airplay, will appear on the Raters Work Assignment Sheet (WAS). This information is a good proxy for both quality and audience size.

Obviously, one could fill an entire 19,000 song Device Library with only the most popular songs from one or two mass audience genres. (That is, in fact, what most radio broadcast networks do.) However, even the most passive listener in the digital music age has come to expect far more diversity and a higher “discovery ratio” than they can find on the narrow playlists of terrestrial and satellite radio programming. Therefore, the 19,000 Recommended Song Device Library according to the present embodiment will include what is currently believed to be the most popular music from 28 different genres. To accomplish that, a strict forced curve is applied to the entire database, based on the size of the audience that would enjoy at least some exposure to the song, even for listeners unfamiliar with the genre. This creates some challenges:
Subscribers interested only in small audience genres such as Children, Christmas, Jazz, Gospel, Rap, Dance, World, and Latin can still select that specific genre to listen to. A “1 or 2-Star” rating will give them what is currently considered the best music in that specific genre. A “1 or 2-Star” rating or above therefore includes the Raters' top picks among the thousands and thousands of songs available in that genre. Therefore, the best 15 songs by a jazz genius such as Billie Holiday or Miles Davis will generally receive a 1 or 2-Star rating, not a 5-Star. This is a mechanical not an editorial issue. Do not think quality, think “Audience Reach” and “Cross-Over Potential.”
3-Star, 4-Star, and 5-Star ratings are based on the “cross-over potential” or the size of the audience that will be attracted to a song. Songs in very popular genres such as Country, Rock, Pop, or R&B will therefore make up the vast majority of the songs 3-Stars or above. For example, this system allows subscribers to pick “all 3-Star and above” and hear a huge universe of songs across all genres. However, this will include only the songs from small genres that have at least some large audience appeal. Table 3 above presents the general guidelines that are applied. These guidelines may be based on specific quantitative assumptions based on third party listening, sales, and download data.

A 0-Star rating simply means that the Rater listened to the song and does not believe it qualifies for further consideration. Any song with 1 or 2 stars or above is considered to be part of the “rated” music database and included in the 30,000 song Playlist Generator Database. So, as will be discussed in more detail below with respect to Table 3, on a cumulative basis, “1-Stars and above” includes 100% of the rated music for that artist, genre, or playlist combination. “3-Stars and above” includes 55% of all the rated songs; “4-Stars and above” includes the top 20%, and “5-Stars and above” includes the top 5%.

A 1 or 2-Star song can be found by selecting a genre-specific or artist-specific playlist, or by selecting the song itself. To conserve space, very few 2-Star genre playlists will appear among the set of pre-selected playlists (to be discussed below). However, when portable MP3 capacity exceeds 60 gigabytes, “2-Stars and above” playlists may become more common. Because well-known artists will often have lots of music at the 3-Star, 4-Star, or 5-Star levels, the 2-Star rating is used sparingly for these artists. Nevertheless, the preferred embodiment is the only song retrieval system in the world that hand selects the best songs by a particular artist. If a subscriber chooses Bob Dylan, he/she will see 109 songs from 13 different albums, not a listing of 31 albums and re-issues with hundreds and hundreds of irrelevant choices. This is a big convenience for consumers. The same applies to genres. In this regard, the subscribers expect playlists from PushButtonMusic to contain only highly recommended songs, and even a 1-Star song is considered to be among the top approximately 0.0048% of all the music available.

Preferably, 3-Star songs have a 50% chance of not getting skipped by a large audience. When a consumer selects 3-Star music of a particular mood/tempo, the consumer typically wants a lot of diversity (not just the hits) across all genres. However, that does not mean that the consumer wants to hear obscure small-genre music catering only to a very unique niche of listeners. 3-Star music must have popular appeal with significant crossover potential. This means that a 3-Star Jazz, Folk, Bluegrass, etc., song would therefore represent the highest rated music in that genre from a popular audience standpoint. A 4-Star or 5-Star Jazz song is therefore extremely rare.

The 4-Star and above rating represents the top 20% of the carefully selected list of 30,000 songs in the database, based on estimated audience reach. These songs should have a 75% chance of not being skipped by a large audience. Preferably, a rater guideline for the 4-Star rating is this: If the Raters want to fast forward before he/she hears the whole song, it is not 4-Stars.

A 5-Star rating is the top 5%. The rater guidance for this rating is this: To be 5-Star, the Rater will want to listen to the entire song twice in a row. The fact that multiple trained Raters normally agree on a song's assigned ratings is evidence these guidelines can be applied uniformly. This uniformity is important in creating the Playlist Generator database and song retrieval system.

Refinements to the Audience Reach embodiment described above may include listing a maximum Star rating for each of the 28 genres and/or micro ratings (e.g. 2.1, 2.2, and 2.3) for small audience material such as Jazz, with little or no crossover potential.

To help consumers better understand a Star Rating System based on Audience Reach instead of subjective quality evaluation, the preferred embodiments will use the following star description, which may change over time:
5-Stars: Solid Hits
4-Stars: Mass Audience Appeal
3-Stars: Discovery/Diversity
2-Stars: Artist Favorites
1-Star: Deep Playlist

As well as biasing the Star-assigning process for the different genres as discussed above, the Star rating system should be normalized so that, for example, 95% of the songs are not assigned a 5-Star rating. Many music websites now feature long lists of the “Highest Rated Music”, such that there are very few lower-rated songs. Such criteria are meaningless as a method to retrieve music. To ensure that the Playlist Generator Database™ will include what is believed to be the most popular music from 28 different genres, a strict forced curve is applied to the entire database based on the size of the audience it is believed would enjoy at least some exposure to the song. As a rule of thumb, a 3-Star song should appeal to 50% of all MP3 player owners; a 4-Star song should appeal to 75% of all MP3 player owners; and a 5-Star song should appeal to 95% of all MP3 player owners. To implement this rule, a strict forced curve is applied, as illustrated in FIG. 8. By using a forced Gaussian “Bell” curve, only the top 5% of the narrow universe of selected songs is allowed a 5-Star rating for audience reach (4-Star ratings add another 15%). This disciplined approach gives customers a highly effective way to separate the very best music based on its Internet and terrestrial airplay, download, file-sharing, and sales data. This is implemented by applying the curve to the songs already stored in the database with their “initial” star ratings from the Raters' inputs. Alternatively, the curve can be applied by each Rater to their own songs before their inputs are provided to the song database.

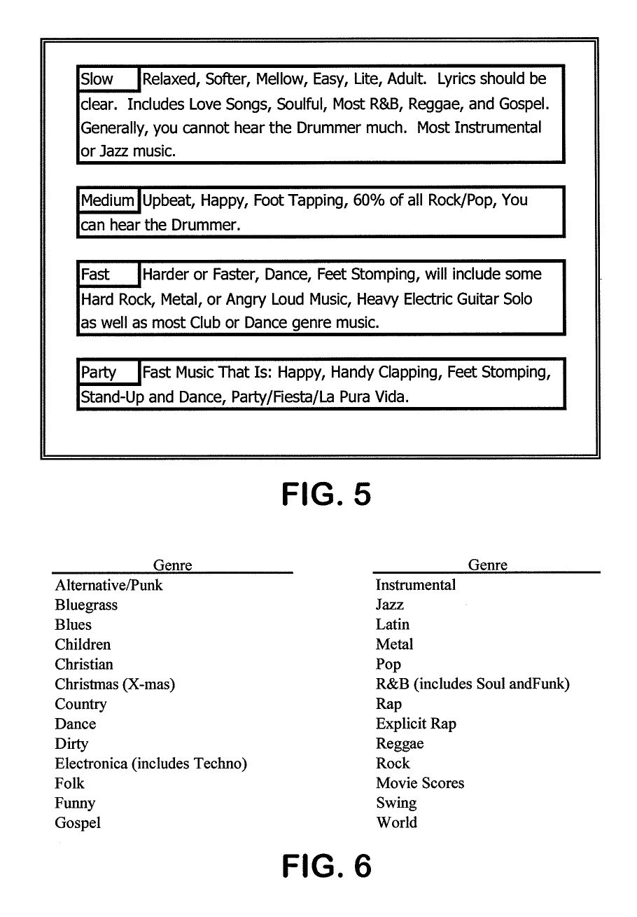

(ii) Mood/Tempos Referring to FIG. 5, the entire rated song database has also been categorized into four Mood Groups. The consumer can then select a playlist solely based on Mood Group, or choose one that combines a certain Mood Group with a star level as described above (i.e. “Medium-4 star”). As shown in FIG. 5, each of the four Mood Groups can be characterized by key words that help to determine what Mood Group is assigned to a song. In general, it is expected that approximately 30% of the songs are assigned to the “Slow (or Soft)” group, which will normally include slower tempo, relaxed, mellow, easy, lite, adult songs. Typically, the lyrics will be clear and drums will not be heard much. Songs in this mood will include love songs, soulful songs, most Rhythm & Blues songs, most instrumentals, and easy Jazz. Songs should be categorized in only one mood group (Slow, Medium, Fast (or “Hard”) with a portion allowed to have the “Party” assignment as well. By requiring songs to be preferably classified in only one of four simple mood groups, this distinction is highly effective as a retrieval mechanism. Systems that allow dozens or even hundreds of moods or themes as a basis for retrieving songs are confusing and ineffective by comparison. Optionally, songs may be categorized in a second or even third tempo/mood.

Approximately 60% of the songs are assigned to the “Medium” group, which includes upbeat, happy, foot-tapping songs where the drummer is distinctly heard. Such songs include approximately 60% of all Pop and Rock songs. About 10% of the songs are assigned to the “Fast (or Hard)” group, which includes harder, foot-stomping dance music, such as Rock, Metal, Angry Loud Music, and Heavy Electric including Guitar solos. In most cases, if the Rater can hear the drummer or if the song has solo electric guitar riffs, it will be assigned to either the medium group or the fast group. About 30% of the songs are assigned to the slow (or soft) group.

Some of the songs will also be assigned to the “Party” group. This includes soft, medium, and hard songs that make people want to dance, get happy, and/or celebrate. This includes fast music that is Happy, Hand-Clapping, Foot-Stomping, Stand-up-and-dance music.

(iii) The Era classifications shown below are used to further define the music to be retrieved from the 28 genres (to be discussed below) such as Pop, Rock, or Country. For example, “Recent” Country and “Classic” Rock are two era classifications within large genres. The six eras preferably used for classification according to the preferred embodiments include the following:
Newly Released in the current calendar year (e.g., 2007);
Recent: Released or discovered in the previous three calendar years (e.g. 2004, 2005, 2006);
Modern: Released after 1983 (previous twenty years);
Classic: Released prior to 1983;
Oldies: Released prior to 1965; and
Archive: Released prior to 1950.
   Exceptions to these guidelines may include newly discovered or pre-label artists that may be classified as “Recent” even though the material was actually first published a while ago. In these cases, “Recent” actually means “largely unknown.” Many “recent” artists may have been touring and releasing demo-like albums long before they get a major label contract or are noticed by one of the Third Party data sources discussed above. In these cases “recent” means “newly recognized”. Finally, in some cases, “Recent” will include bands enjoying new attention by a large audience. Consumer's willing to utilize the “active user” portion of the website can also choose a single year or make up their own collection of years (e.g. 1968 through 1972 only).

Re-Rating Recent Music. In the case of “Recent” or “New Released” material from new bands submitted by remote Contributors, the star rating may require some degree of guesswork. That is because they are too new to have reliable third party data (Filter #3) as described above. In other cases, a super pop hit may decline in audience reach very quickly from its release date. To address these problems, “Recent” songs are preferably re-rated once they have been in the system for three calendar years. Typically, a song with a recent star rating of 4-Stars or 5-Stars will then face much tougher competition in the “Modern” era. In addition, there will be significantly more factual data available for objectively determining the Audience Reach by that time.

The fifth Era “New Releases” preferably includes only songs released in the current calendar year. However, if Recent is selected, the New Release songs should automatically be included. Future embodiments may also include a Just Added classification so the subscriber can go straight to new releases in the last 30 days only. The Just Added list may also include older material that has just been added to the library.

(iv) Genre. Referring to FIG. 6, the classification system of Filter #4 provides a condensed list of 28 primary genres, which preferably include: Alternative/Punk; Bluegrass; Blues; Children; Christian; Christmas; Country; Dance; Electronica (includes Techno); Folk; Funny; Gospel; Instrumental; Jazz; Latin; Metal; Pop; R&B (includes Soul and Funk); Rap; Rap (Explicit); Reggae; Rock; Movie Scores; Swing; World. While FIG. 6 shows only 26 genres, other genres such as Party, Dirty, Rave (and others) may also be added periodically. Thus, genres may be added or subtracted as music tastes change. However, genres preferably will not include odd titles or micro-fads that most consumers care nothing about, or cannot understand instantly, such as “post-punk Screamo,” “patio,” “alternative,” “latte,” “love of the ages,” “dance hall reggae,” “indie,” or “garage.” For other examples, the LIVE365.com Internet radio site offers 285 “genres”. However, it is presently believed that very small sub-genres are unnecessary, too limiting, and generally confusing to a passive listening audience.

Most music services today, such as Apple iTunes™ apply only what they (or the label) perceive to be the primary genre for a song or artist. In the preferred embodiments, on the other hand, individual songs are placed into as many genres as they apply. This insures that a top song will appear on several genre-specific lists as well as on the “all 4-Star songs” or “all fast songs” lists.

To classify a song in multiple genres, the Rater simply uses a slash in the genre field. For example: Latin/World/Dance/Pop. One important question to be answered by the Rater is: “Is it Rock or Pop?: Generally, songs should not be categorized as both Rock and Pop. This distinction is one of the toughest, and typically can be solved by asking whether or not the song is “hard enough” to be a rock song. Pop is a genre that covers a broad spectrum of music. Some songs from smaller Genres such as R&B, Blues, Bluegrass, World, or Rap have a high potential for popular appeal as well. These songs are therefore included in the Pop Genre playlist in addition to their “primary” Genre. For example, Nora Jones is usually Recent Jazz/Pop. This adds diversity to the most listened to Pop playlists that is not available from other broadcast sources. In some cases playlists are offered that combine similar types of genres. These include:
Pop/Rock
Country/Bluegrass/Folk
World/Reggae/Latin
R&B/Rap.

### (5) Filter #5: Final Approval Process

The Final Approval Process of Filter #5 is intended to be a simple verification process performed by PushButton Music™ senior editorial staff. The purpose of this filter is largely to ensure that songs were uniformly classified when entered so that they are played on the correct lists. This final approval process has two steps. First, both the songs and predetermined playlists (to be discussed below) will eventually be evaluated by consumers on an ongoing focus group basis using Internet-based and other market research firms. This function is similar to the quantitative research now performed by traditional programmers. Songs that may be “burned out” or demonstrate low appeal will then be re-rated appropriately by the Senior rater staff. Secondly, a small staff of senior editors reviews the final changes and discusses possible exceptions. These individuals may add/delete songs, change stars, change genres, etc. This step may also include a Composite Scoring System identical to or similar to that described above. At the end of this filtering process, the song library contains a plurality of song files, one for each song. Each stored song file comprises data corresponding to the song, the artist, the album, the mood/tempo, the era, the genre (or genres), estimated audience reach, and the year of original release.

### B. Updating the Database

After the Playlist Generator Database™ has been initially uploaded using the methods and apparatus described above, the song database will be periodically updated (daily, bi-weekly, weekly, bimonthly, or monthly) to keep the database fresh and provide consumers with new song choices. This updating process uses the Music Content Management System™ filters described above. According to the Recording Industry Association of America (RIAA), 60,331 albums were released in 2005, of which 16,580 were in digital form only. When re-issues are removed, that comes to roughly 992 songs per day from the Filter #1 sources. By comparison, MySpace now hosts websites on 135,000 artists, and MusicNet lists 110,000. Therefore, the actual total number of songs created on a daily basis is much larger than 992 songs per day. Thus, an objective of the system of the present invention is to scout all of the song sources available for music that subscribers are likely to care about. In order to meet this objective, several hundred broadcasters and web-based music sources are preferably tracked on a daily basis.

As shown in FIG. 3, the updating process works exactly the same as the initial upload, only the song volumes will be smaller on a daily basis. That is, approximately 992 songs per day may be expected to emerge from Filter #1, while 125 songs per day may be expected to emerge from Filter #2. Filter #3 does not really reduce the database in a significant way for periodic updates. The updating process will likely produce approximately 65 songs per day from Filter #4. Filter #5 will likely not reduce the database in a significant way, leaving perhaps 65 songs per day added to the database. With the proposed star rating system, this translates into approximately thirty 3-Star and above songs being added to the database every day. Consumers will thus have the best of the new songs to download and enjoy on a daily basis.

### 4. Preselected Playlists

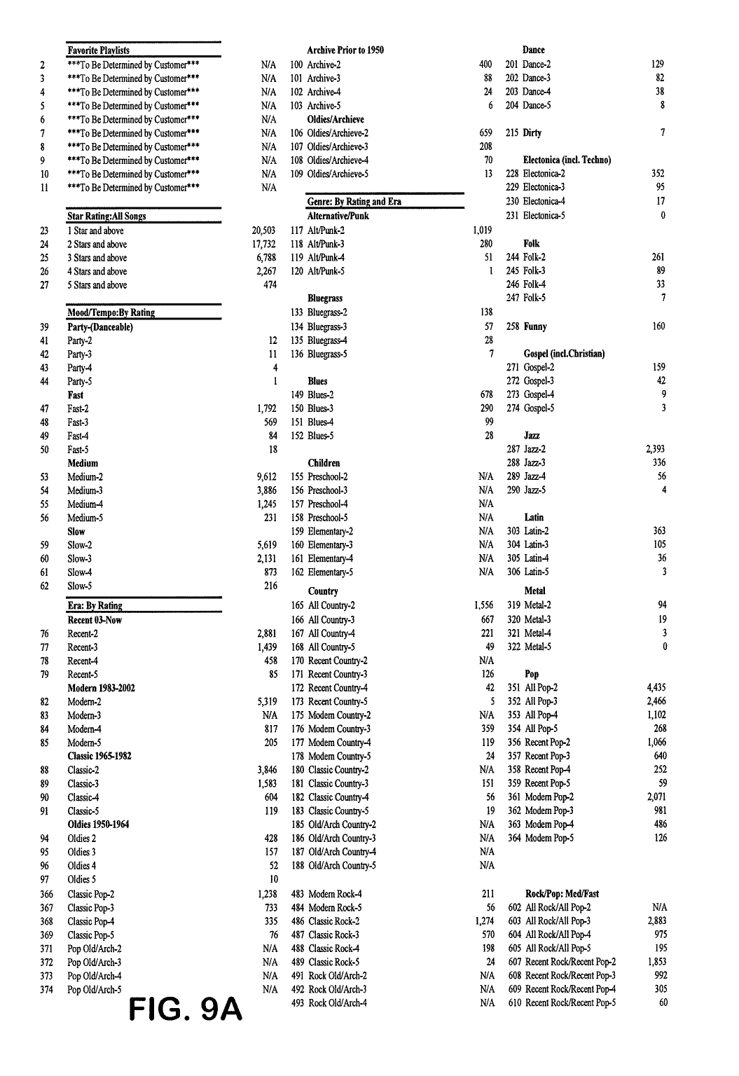

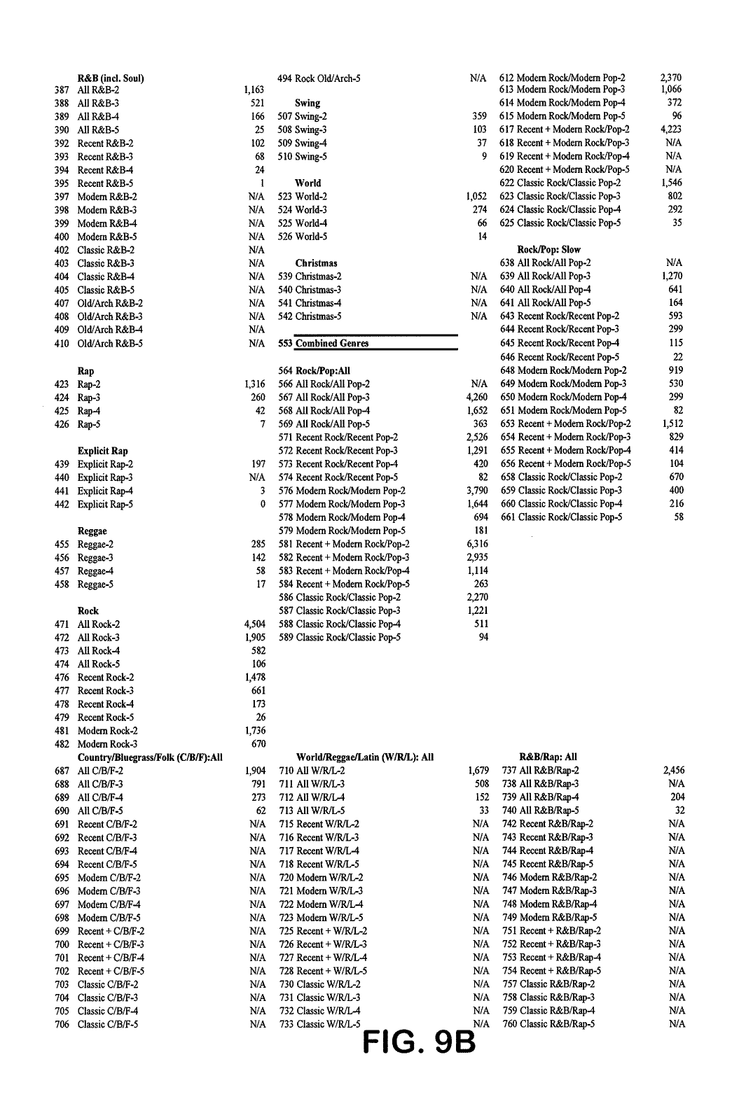

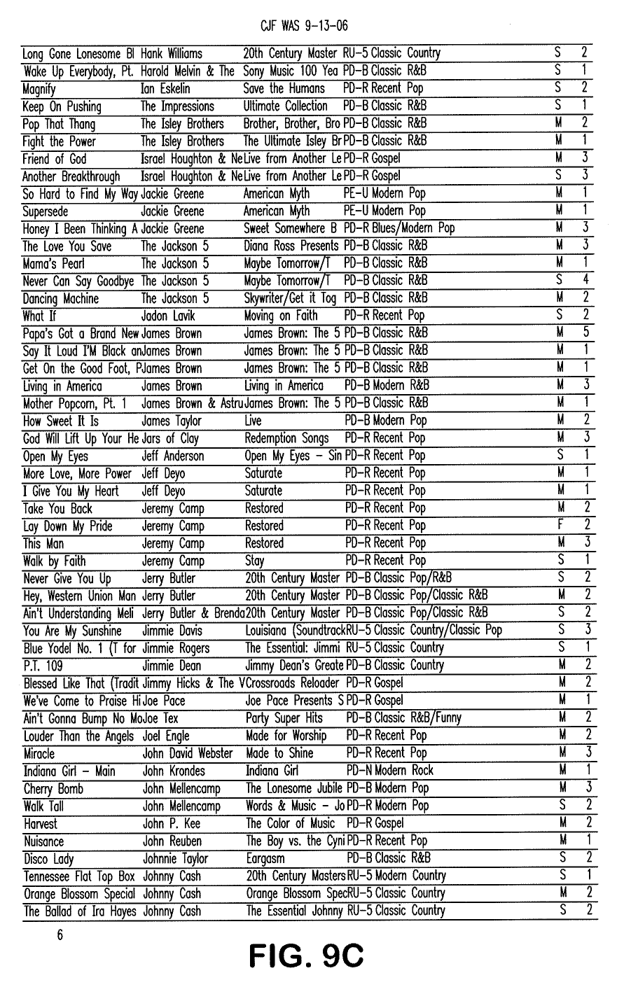

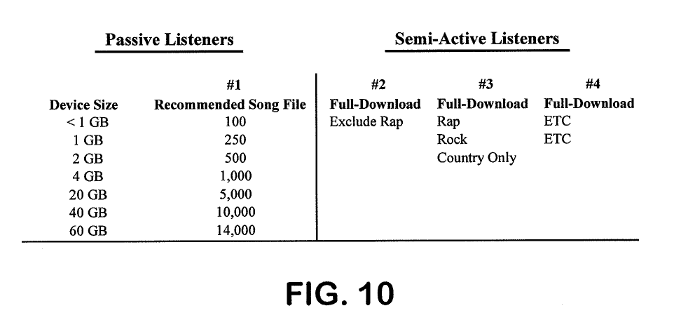

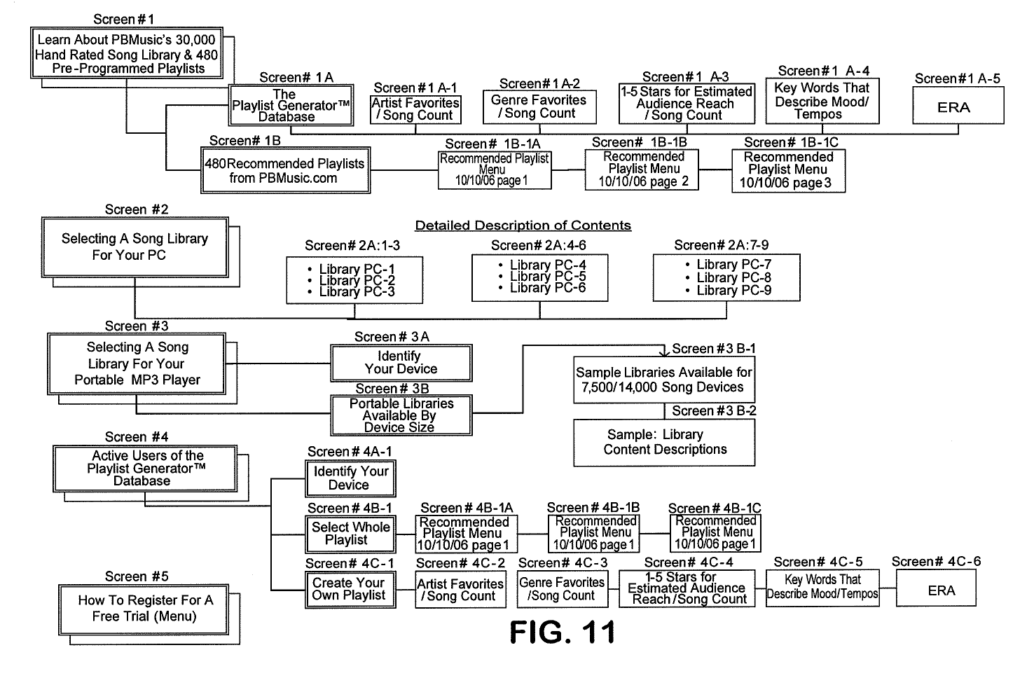

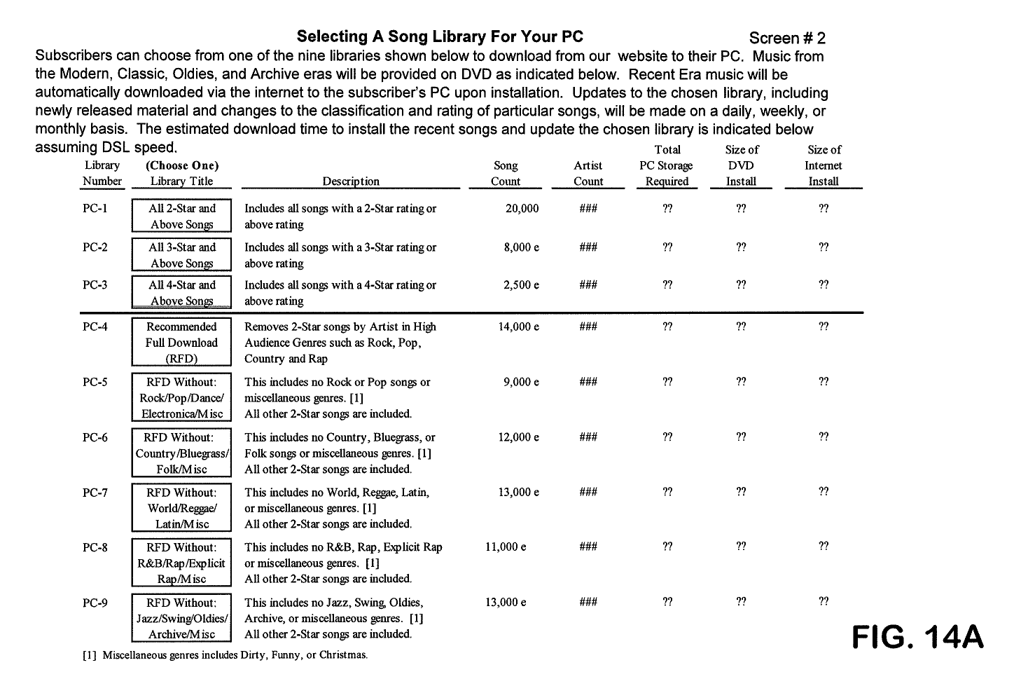

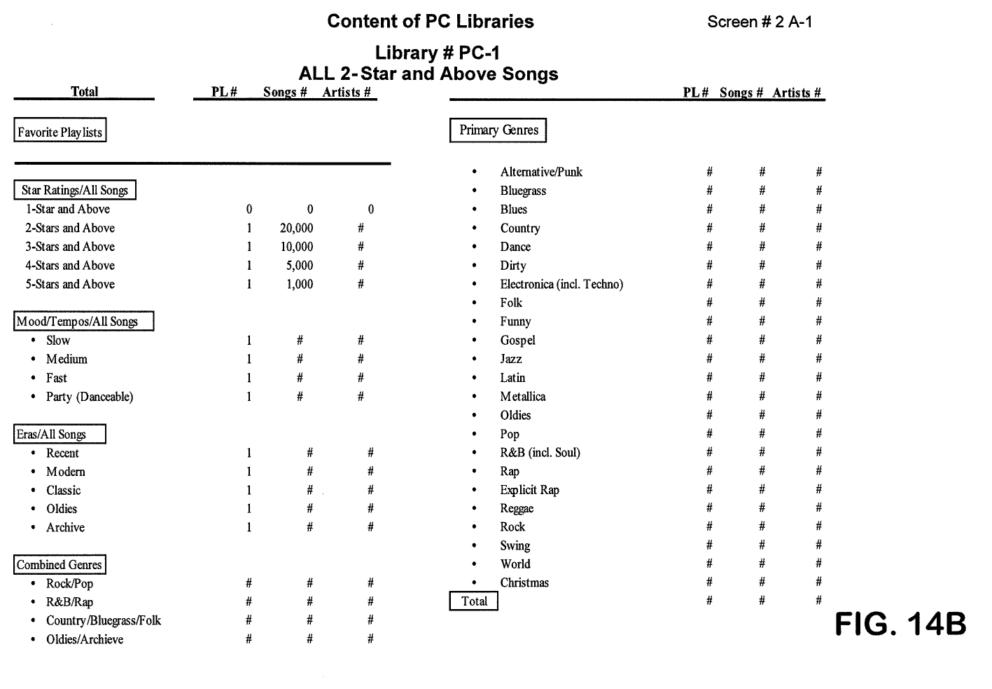

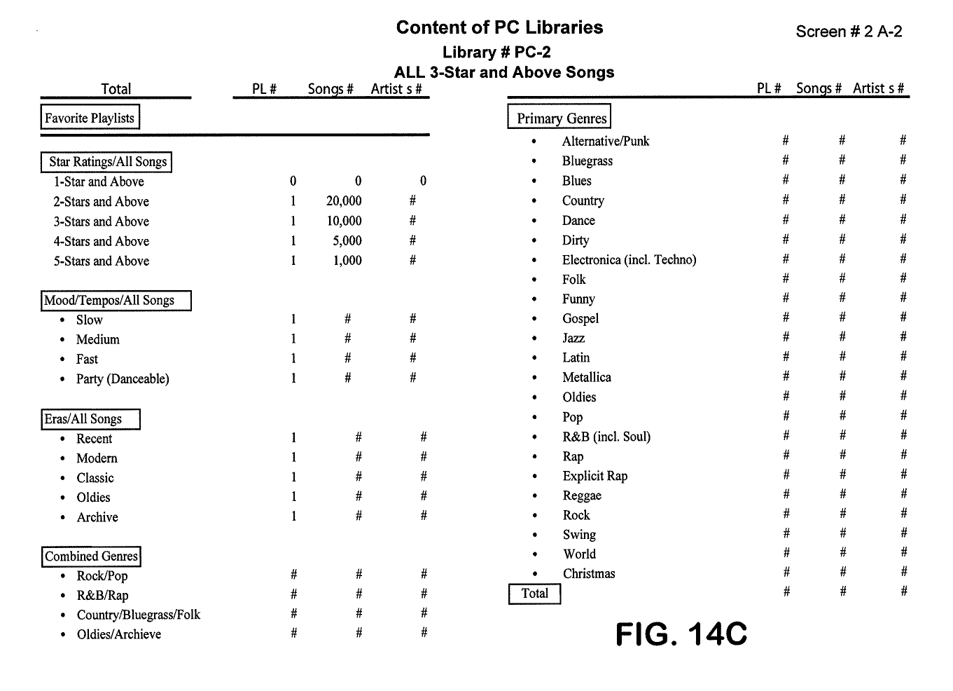

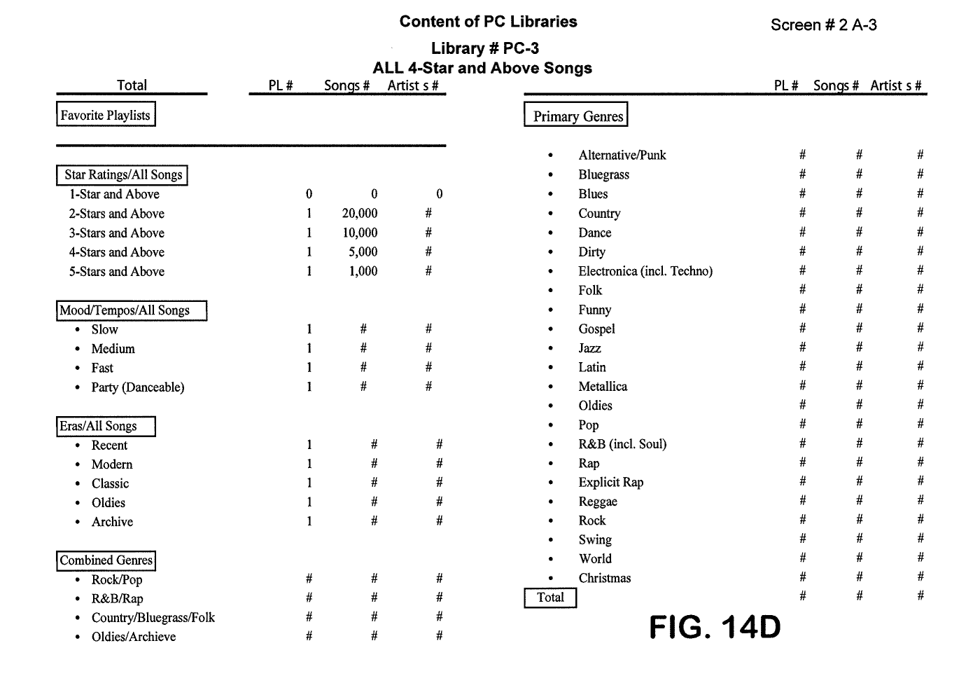

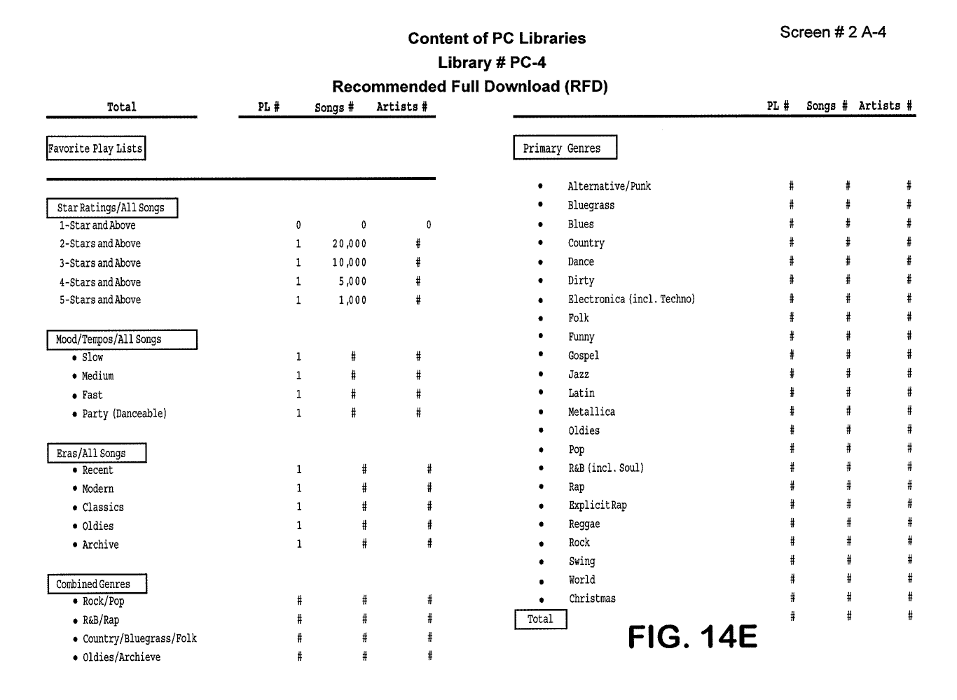

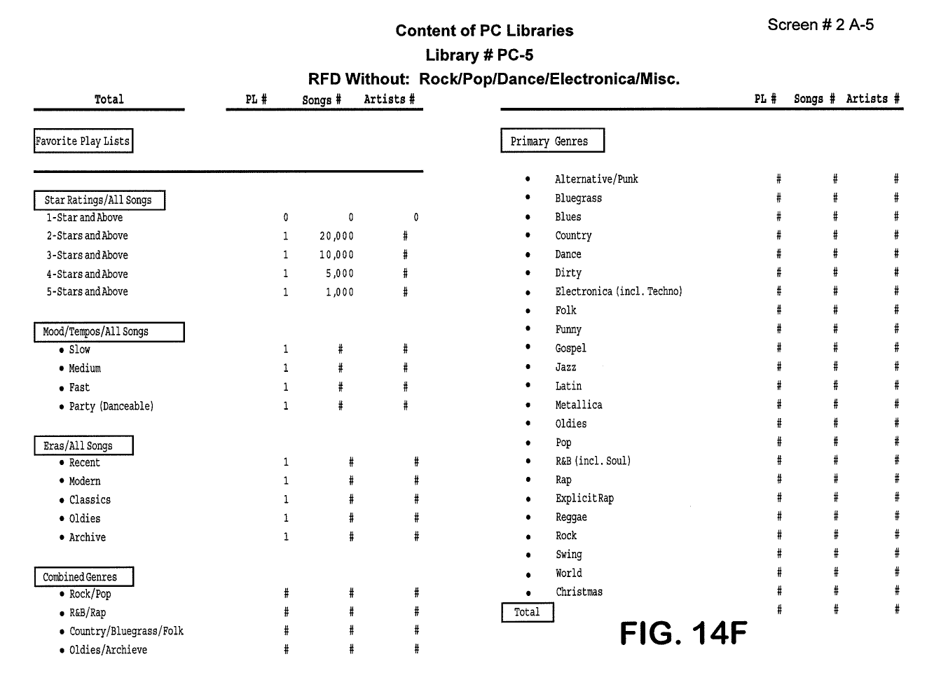

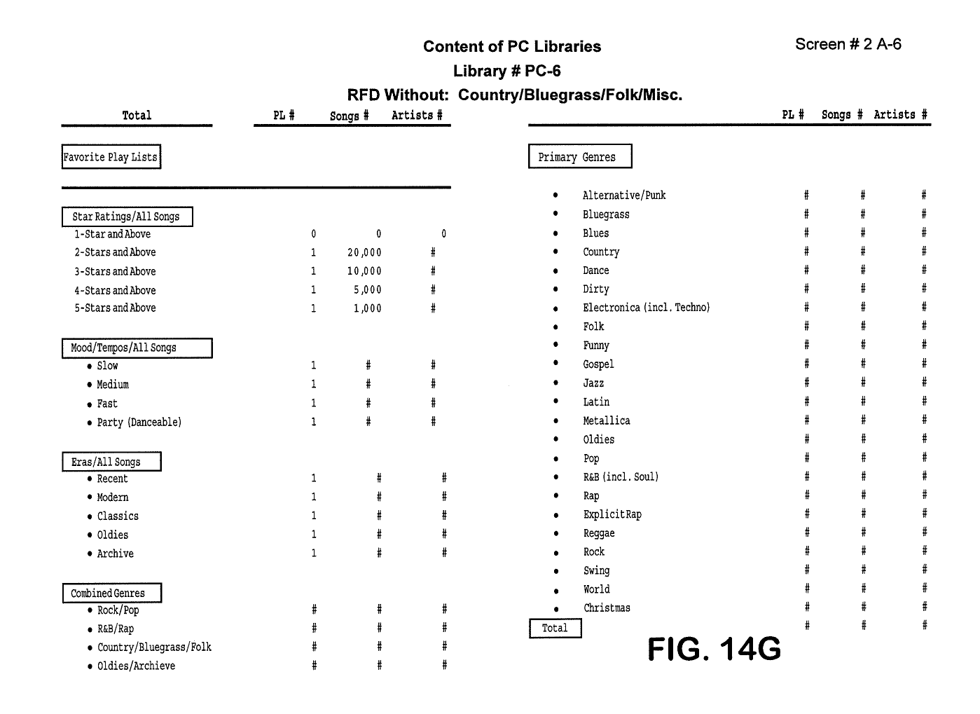

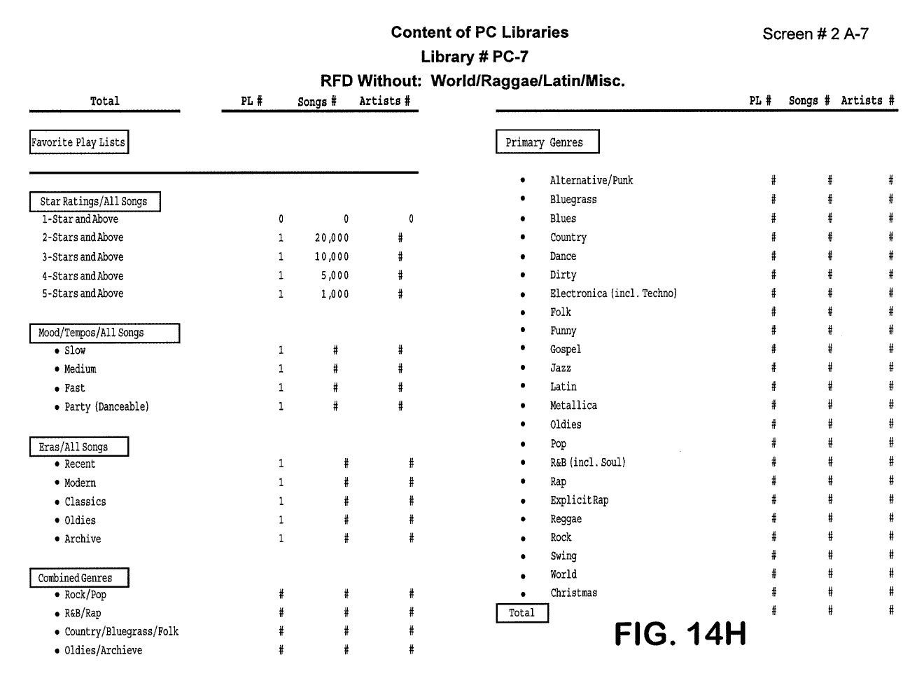

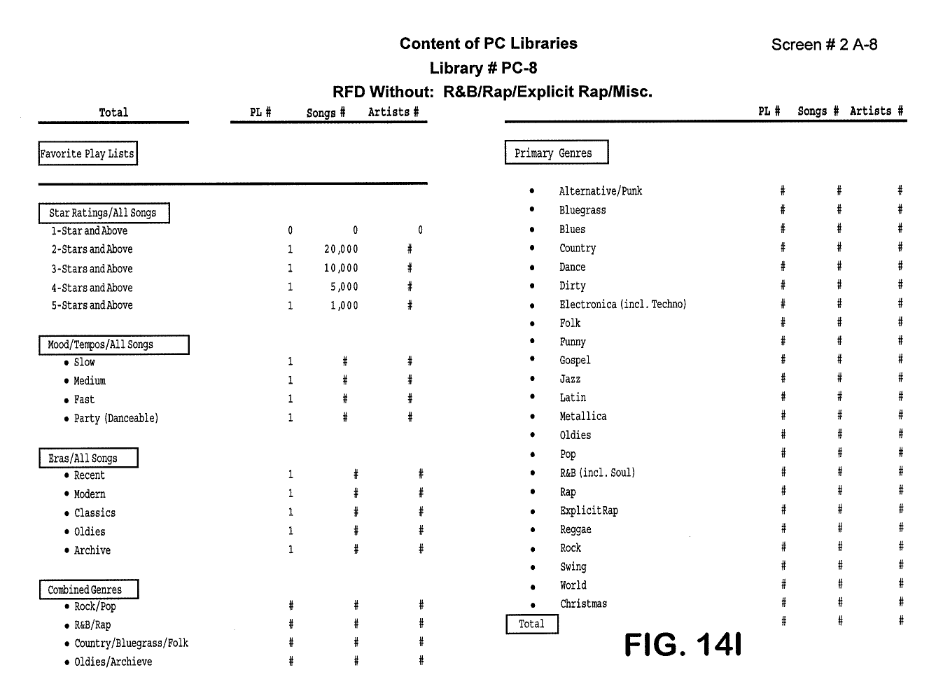

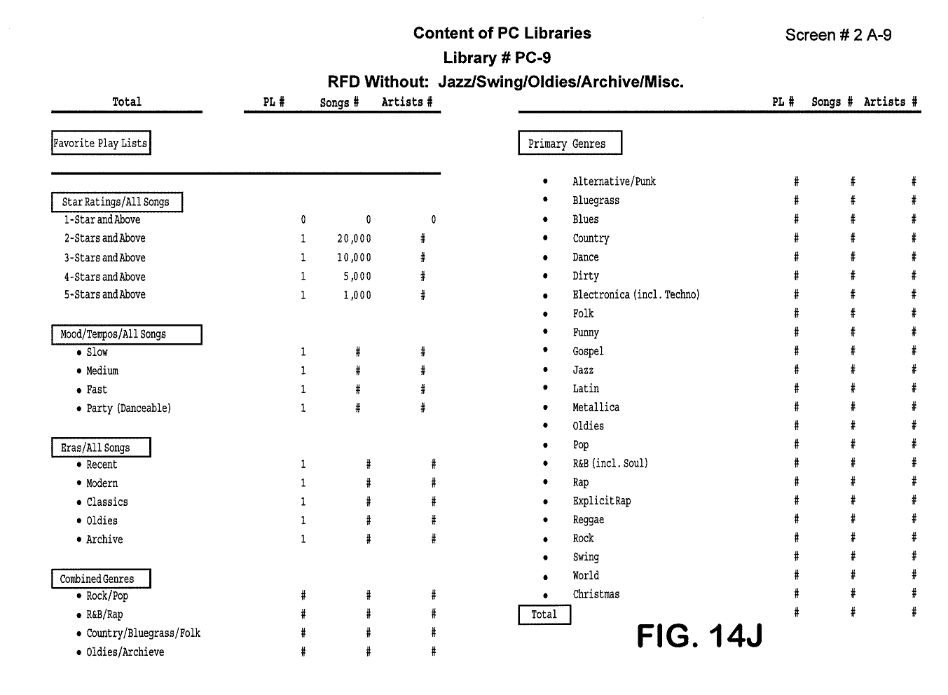

As will be described in more detail in Section 5 below, a notable feature according to the preferred embodiments is that consumers will preferably be offered a variety of predetermined “full-download” libraries from the Playlist Generator Database™ website, together with 600 or more predetermined playlists organized in accordance with various combinations of the selection criteria discussed above. As shown FIG. 14A, nine libraries will be offered for download to the consumer's PC. The consumer first selects an entire library to be downloaded to their PC and then selects a Device Library to be side loaded to the portable device. The songs in these libraries then populate the pre-determined playlists shown on the PC and portable device menu. The number of songs in each predetermined playlist or library will vary. The playlist menu is preferably standardized. In most cases, the nine libraries available to download to the consumer's PC will be much larger than the Device Library or libraries they chose to side load to their device. Each of the sided loaded device libraries will be configured with a predetermined number of songs based on portable device size, as depicted in FIG. 10. From these PC and Device Libraries, approximately 600 pre-programmed and recommended playlists are generated and offered, as shown, for example, in FIGS. 9A and 9B. As a result, a wide selection of playlists will be available from a portable device with limited storage capacity. Alternatively, the consumer is allowed to pick only certain playlists shown on the PC (instead of entire libraries) for side loading to the device. For example, a consumer with a 1 GB portable music player and desiring to side load a Jazz song library will select “channel” 230 for side load to his/her portable player. This gives the consumer 121 pre-programmed Jazz songs to listen to from the portable device depending on the size and type of library chosen. By revisiting the website, the consumer can change the PC Library they downloaded originally or change which playlists or artists to side load to their portable device. For listeners, this creates a live broadcast-like listening experience from a huge personal collection of songs stored on a portable device, and those songs can be easily changed. And, due to the “fully-interactive” license with content owners, consumers have the ability to skip songs as they do when listening to their personal CD or MP3 file collection. This song-skipping capability in turn allows the consumer to avoid searching for music by changing stations to find a different song. In addition, in the further embodiment, consumers may be able to download and purchase songs they like, on demand, and have them stored on a personal music player.

Much like what cable TV providers did to television, the Satellite content aggregators (i.e. XM/Sirius) have already introduced the concept of numbered channels or stations to the public. Consumers remember channel numbers better than they do the confusing and vague titles used by XM/Sirius. For that reason, the menu of numbered playlists according to the preferred embodiment is designed to find exactly what the consumer chooses by Audience Reach, Mood/Tempo, Era, and Genre. Vague stylistic titles for playlists such as “Latte,” Adult Patio Party,” are not used. Luckily almost all recent MP3 players, including the iPod™, allow the listener to scroll through a numbered playlist menu quite easily.

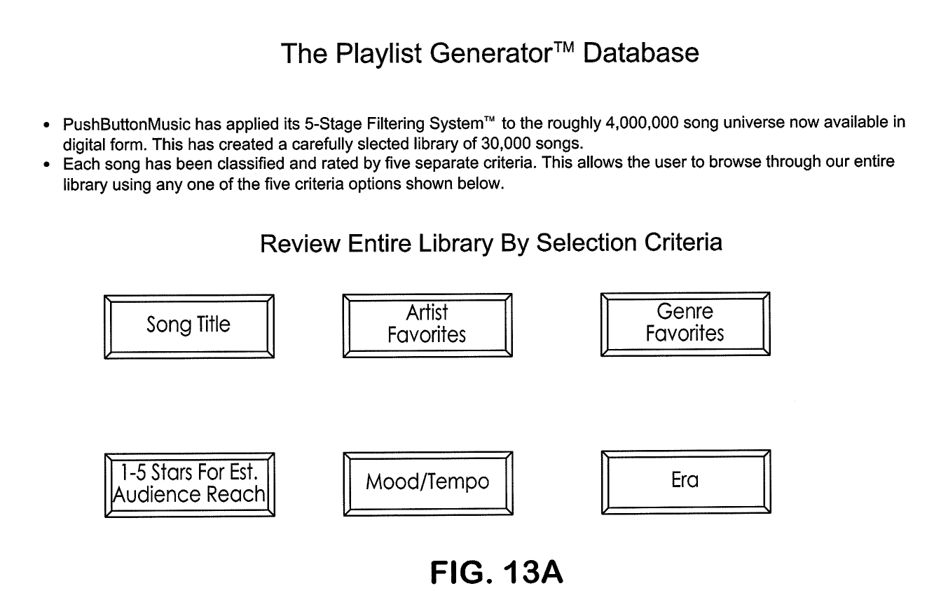

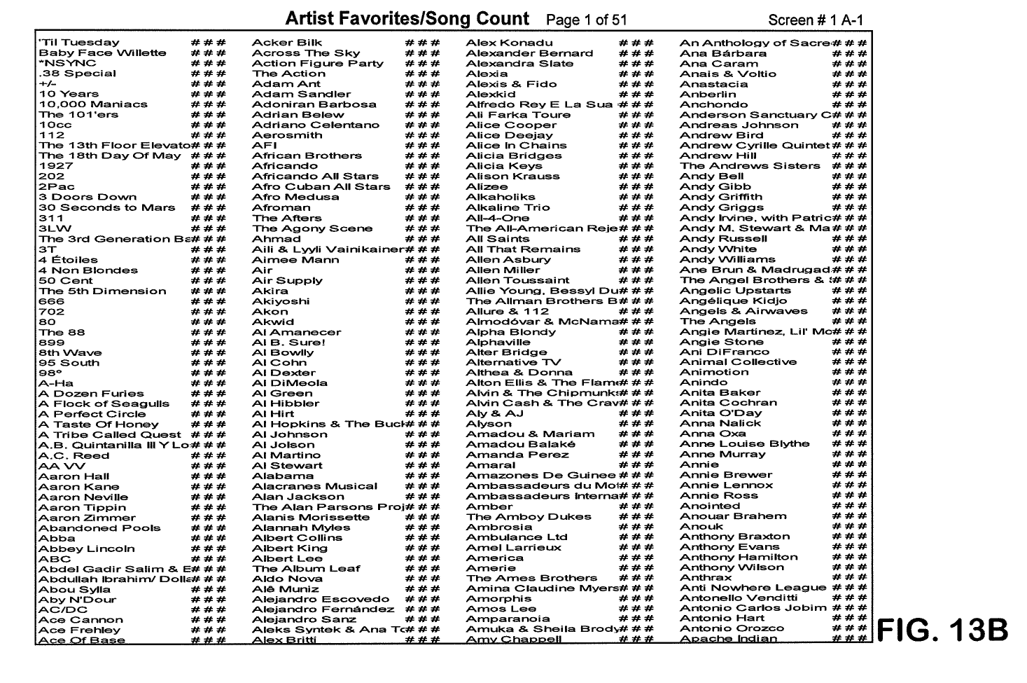

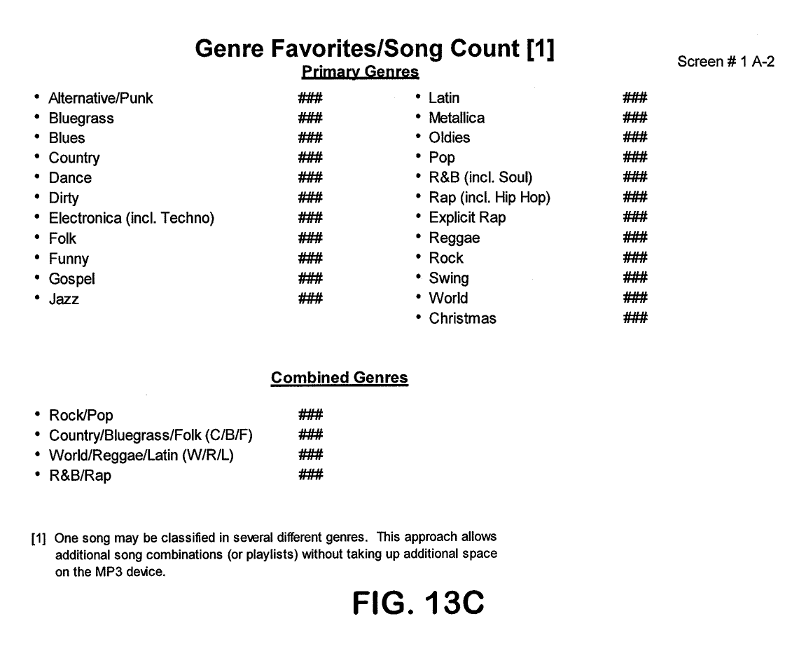

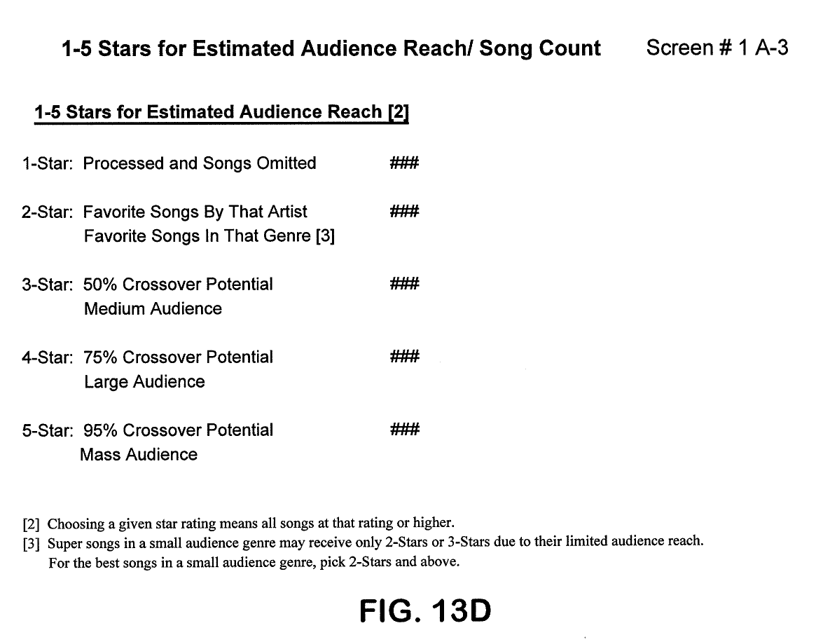

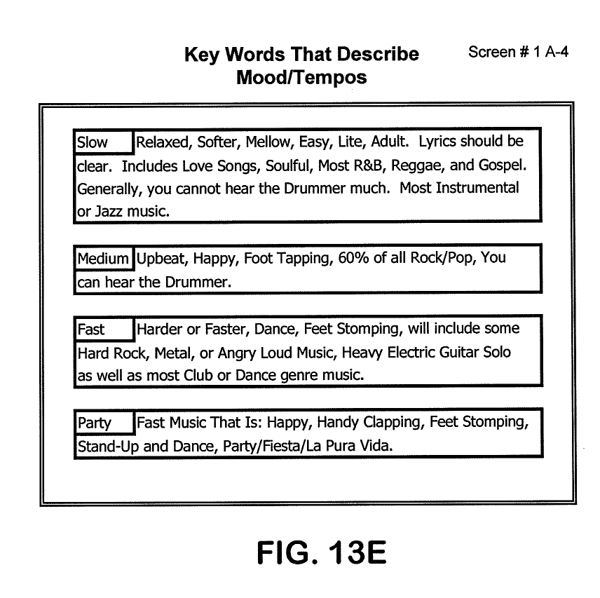

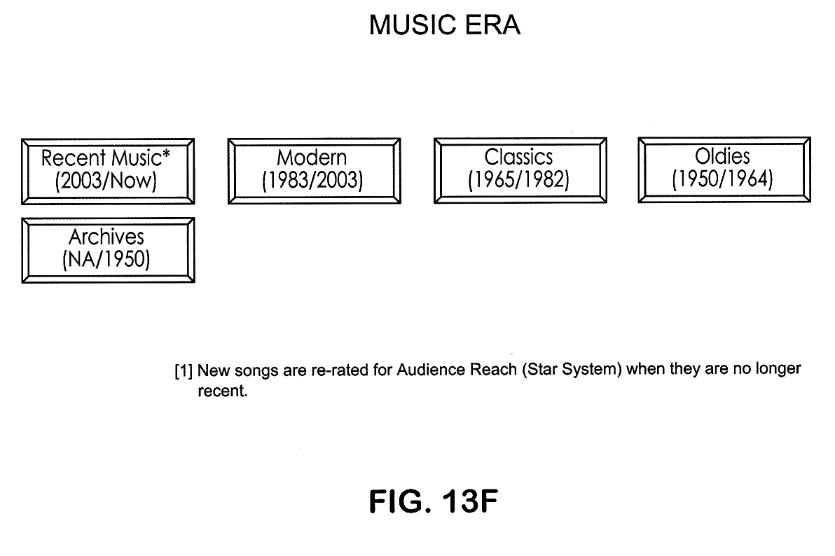

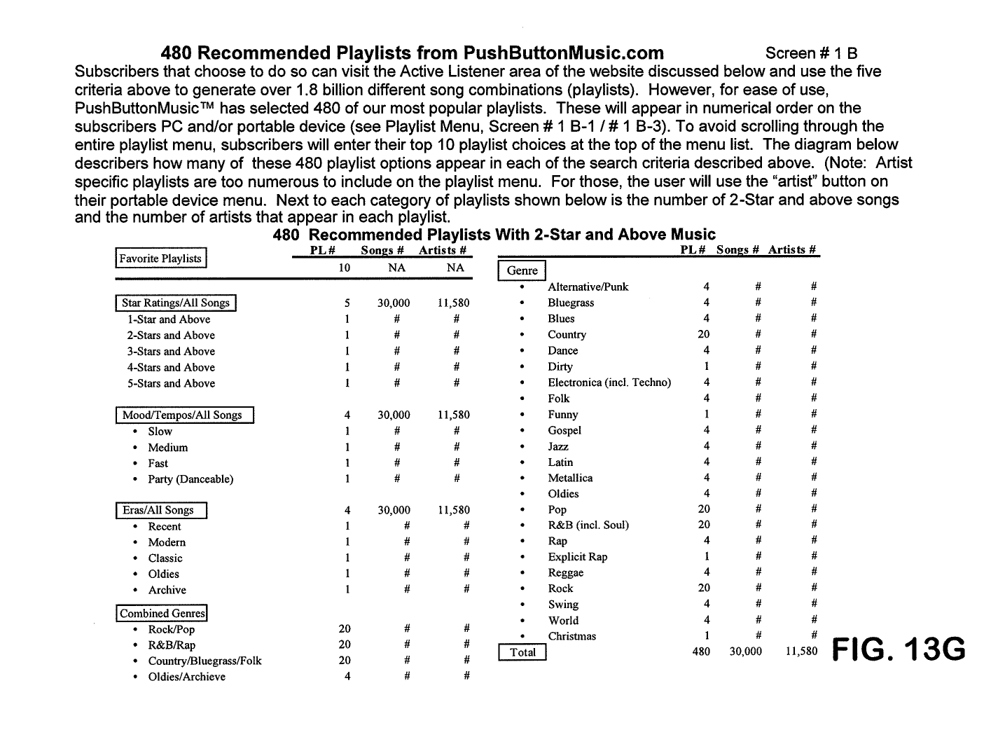

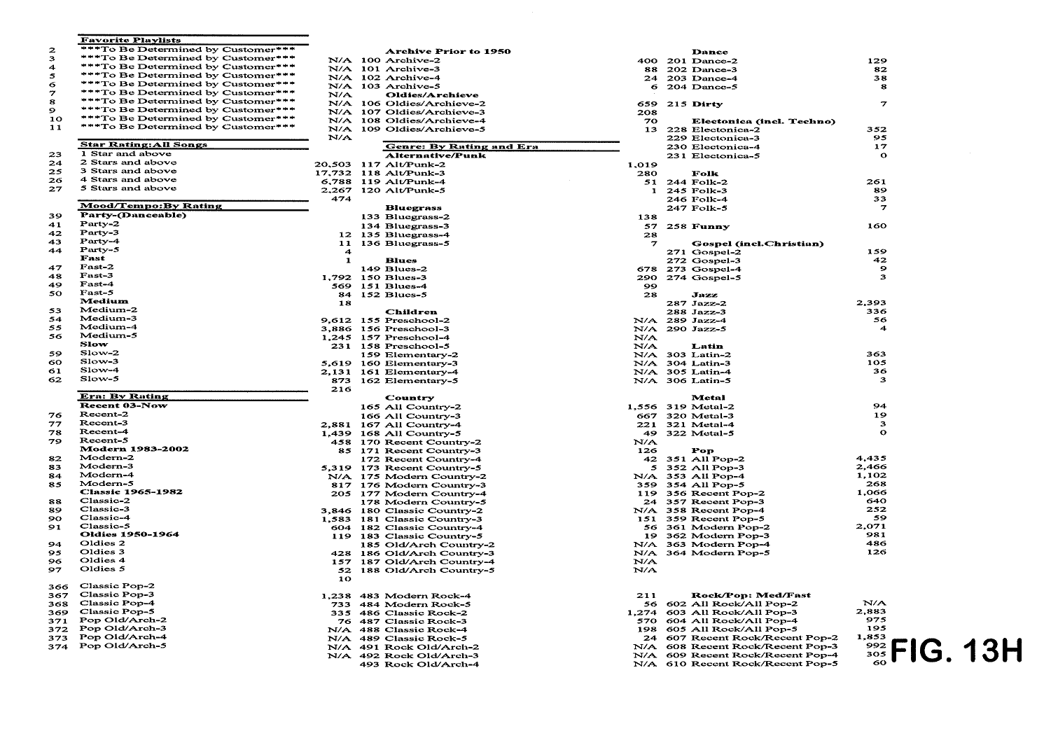

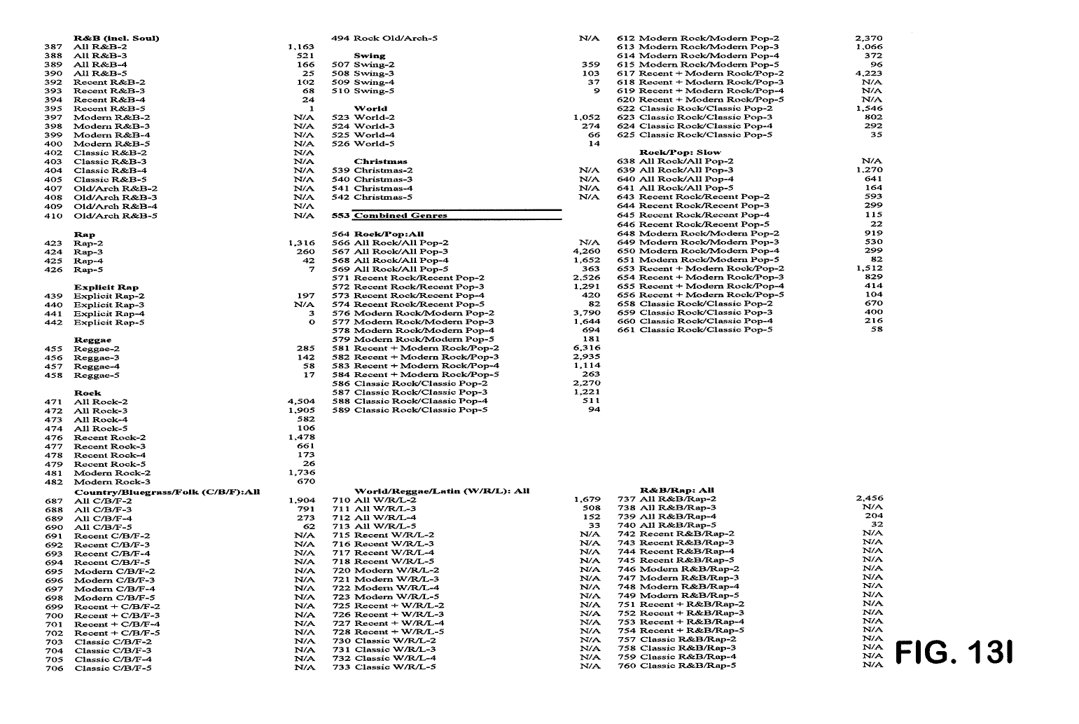

FIGS. 13H-I show 480 pre-selected station playlist selections which may be on the PushButtonMusic PC and portable device menu. Note that the song counts shown will increase as the categorization process proceeds. While 480 predetermined playlists are presently preferred, any convenient number may be adopted. For present market conditions, it is believed that at least 100 (more preferably, 150, even more preferably 200, even more preferably, 250, even more preferably 300, even more preferably, 350, even more preferably 400, even more preferably, 450) predetermined playlists will be adopted. Of course, the number of predetermined playlists, in the future, may grow above 480.

Combined Genres: A few pre-selected station playlists are also available which combine one or more of the primary Genres described above. For example, a customer who just wants the most Recent Rock and Recent Pop music of 4-Star quality would choose Station 0417 “R-Pop/R-Rock-4,” which stands for “Recent Rock” and “Recent Pop” at 4-Star or above. To help consumers better understand these station titles, subscribers may receive a hard-copy menu as well.

The Master Artist List (MAL): The MAL is a file maintained by PushButtonMusic staff to insure that every artist is assigned to a particular Rater. Normally, those assignments are made based on genre expertise. This is because the rating of songs goes much faster (and with less errors) for artist and genres the Rater is familiar with.

The Work Assignment Sheet (WAS): Every few weeks the Rater receives a list of unrated songs on a Work Assignment Sheet as shown in FIG. 9C. This list will be identical to the playlist found on the MP3 player that accompanies it. All five criteria are reviewed and entered onto the WAS, as shown. Note that the genre shown on the WAS is what the record label companies and service providers such as iTunes™ or MusicNet™ use. PushButton Music genres will be chosen from the list in FIG. 6.

Playlist Rotation for Small Capacity Devices. Most consumers will enjoy a library on their PC that is much larger than their portable phone or MP3 player allows. In addition, consumers with large capacity devices such as 60 GB or 80 GB MP3 players can load very large libraries of songs (i.e. 14,000, 20,000) all at once. This means that nearly all of the 480 pre-selected playlists according to the preferred embodiments will have lots of songs to choose from. More importantly, the preferred embodiments can offer an extensive Artist Favorites list on the roughly 20,000 artists in the song database. The preferred Playlist Rotation system delivers a similar listening experience on a much smaller portable device. Fortunately, there is only so much music a person can listen to in a day. With that in mind, according to this alternative, all 480 pre-selected playlists are broken into small subsets of songs that change on a daily basis. For example, the “3-Star and above” Class Rock playlist that appears on the “Day 1” Library subset may have only 20 (or any number such as 40, 60, 80, or 100) songs versus the 528 songs available on the 19,000 song library. However, the “Day 2” list has 20 different songs. The size of the daily subset for a particular playlist is determined by which library option was chosen for the portable device (see the below description). In this manner, the consumer is exposed to the entire 528 song collection over time. Frankly, it's just as if a listener was “shuffling” through the entire collection all at once. But, in reality they are only pulling from the subset of 20 songs available on any given day. To implement Playlist Rotation™ system, the entire library chosen for the smaller devices is entirely changed every night. Fortunately, the “sync” functions of many media players allow this. And, a small library does not take long to replace either on the PC or the device. The different songs are selected by PushButtonMusic staff or automatically by computer. The selection may be random, semi-random, or organized by any of the selection criteria discussed above.

Consumers May Customize the PushButtonMusic Playlists To Their Own Taste: The newest generation of media player/device systems can track when a listener skips a song or even wants it omitted from their PC or portable device library altogether. These media player/device systems also allow a listener to flag a song to be included in their own favorites list. This “on-the-go” editing function allows each PushButtonMusic subscriber to customize any one of a number of the standardized libraries or pre-selected playlists. For example, when the user skips over (or deletes) a song on his/her portable music player, the next time the player is coupled to the PC, the PushButtonMusic player will detect the skipped (or deleted) song(s), and permanently delete that song from the playlist resident on the PC. Of course, the user may be given a software prompt to confirm/deny the deletion(s). In a sense, PushButtonMusic is providing consumers with 480 pre-selected playlists of recommended songs for them to use to develop their own playlists. In operation, consumers will heavily edit at least their top 10 favorite lists. The result is that these subscribers will be very unlikely to change services.

The preferred menu of predetermined (and numbered) playlists depicted in FIGS. 9A and 9B is designed to find exactly what the consumer wants, based on a combination of estimated Audience Reach, Mood/Tempos, Era, and Genre. This eliminates the confusion and mystery regarding what a playlist contains that is created by current theme titles such as, for example, “Latte Music,” or “Love Songs of the 80's,” or “Best of the 90's,” etc. The system allows the consumer to enjoy unprecedented diversity and discovery. For example, a consumer could select “all 3-Star and above” songs and hear a huge universe of songs across all Genres, Eras, and artists in a single playlist of, in this example, 5,209 songs. Thus, the consumer can download the maximum number of songs for their individual device, and then select certain “slices” of those stored songs, based on predetermined playlists. This allows the consumer to generate a practically limitless number of playlists from the songs resident on his/her PC and/or portable music player.

A few pre-selected playlists are also available which combine one or more of the era and primary genres described above. For example, a consumer who just wants the most Recent Rock and Recent Pop music of 4-star quality could choose Channel 0417 “R-Pop/R-Rock-4” (See FIG. 9B), which stands for “Recent Rock” and “Recent Pop” at 4 stars or above.

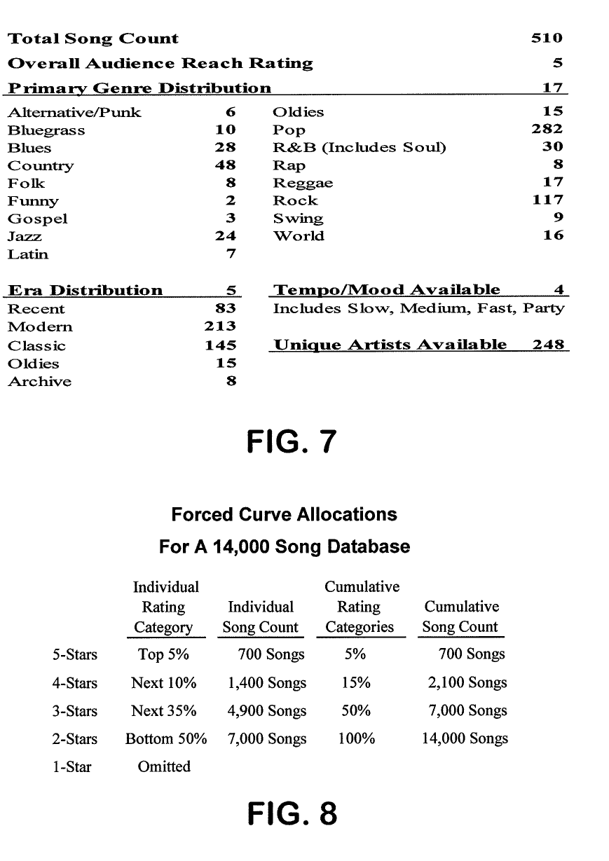

As one example, of the Device Libraries discussed earlier, referring to FIG. 7, all 510 songs in the predetermined Device Library for a 2 GB device for a passive listener (see FIG. 10) are rated 5 stars. This represents the top 5% of the top 0.048% (19,000/4,000,000) of the universe available. Even with this tiny library, 18 of 28 genres are represented, and the diversification with respect to era and mood/tempo is quite wide. Furthermore, without using artist name or Audience Reach rating, this 510 song database still theoretically allows 58.9 million playlist combinations. By allowing only one primary genre to be used for each list, 4,590 playlist combinations are possible.

Referring again to FIGS. 9A and 9B, to further illustrate the diversity and convenience of the predetermined playlists, a menu of the 480 most popular playlists that would automatically appear on the consumer's PC and/or portable MP3 player along with song count for each playlist. The ability to display this many playlist choices in a coherent fashion from the menu of the portable device is a notable benefit of the method of the preferred embodiment.

The preferred embodiments may be modified to also recommend individual songs or entire playlists that will “match” the users indicated song preferences or listening habits. One existing method, for example, is to share playlist information with a “friend” or published source that has stated at least a few shared preferences in their own playlists or song libraries. Other methods are related to the “Music Genome Project” whereby songs are carefully dissected for their composition traits as a basis of finding similar songs. These “preference matching” schemes suffer from many problems. First, is the fact that they attempt to filter and select song candidates from a song universe with millions of potential candidates. The result is that lots of irrelevant or just plain bad music is “discovered.” Second, they rely upon the consumers past music collections that typically represent an extremely narrow sub-section of the variety now available. And, third, the recommended songs are not individually classified in a uniform manner greatly reducing the playlist options available to retrieve the songs. The Playlist Recommender System™ (according to a modification of the preferred embodiments described below) presents an entirely new approach to recommending entire playlists that addresses these problems, and may utilize the above-described known methods in combination with the embodiments according to the present invention described herein.

The Playlist Generator™ database described above “recommends” entire libraries of rigorously filtered and rated songs that collectively represent less than 0.075% (30,000/4,000,000) of the available song universe. From this database, passive users may simply select a pre-programmed playlist and active users can make-up their own. For passive listeners, this still requires a fair amount of trial and error with the currently preferred 480 playlist menu (which may eventually reach 1,000 predetermined playlists). To assist this process, the subscribers may benefit from the Playlist Recommender System™.

This Playlist Recommender System™ relies upon the highly selected Playlist Generator™ Database and generally works as follows: The songs played by the subscriber either on his/her PC or portable device are already tracked by the music licensing platform (e.g., MusicNet) in order to properly compensate the right content owners. In one embodiment, the subscriber can ask the system (via the music provider server website/media player) to identify which of the preferred libraries and specific playlists most corresponds to his/her recent choices. Multiple playlists are then displayed and ranked for match. Skipped songs will not be included in the users “target sample.” The user can also decide how many days back they want to include in this “target sample.” Such a system can even identify what level of audience reach or popularity (star system) the consumer prefers within a highly specific set of songs. For example, 2-Star/Classic Country/Slow versus 3-Star/All Country/Medium.

In another embodiment, the user scrolls through the entire database which has been downloaded to his/her PC and indicates what songs he/she wants in the target sample. Songs can also be added to this target sample or “favorites” playlist at any time by simply indicating that the song is to be saved from the portable device (iTunes/iPod already has this feature).

In yet another embodiment, the user can create the target sample by simply downloading his/her existing song library, in its entirety, into the PushButtonMusic media player on their PC. (By automatically merging their current library they can also enjoy both the PushButtonMusic service and their current library on the same media player.) This will allow the Playlist Recommender System™ to rank the PushButtonMusic playlists by their match to the person's pre-existing library. Because that user's library will contain unknown or unrated songs not in the PushButtonMusic database, they will not be merged into the Playlist Generator™ database itself. Rather, they will be kept separately on the media player. This system, in all three embodiments described above, allows users to receive specific playlist recommendations based on past preferences or recent listening habits, when they choose to do so.

Subscribers can customize their PushButtonMusic playlists in a number of ways. For example, the subscriber can hit the skip button twice in a row to delete a song from one of the pre-programmed playlists. Over time, their favorite playlists will become more and more customized. They can also create their own favorites list on-the-go, as described above.

Currently, digital music service (e.g. iTunes™) do not include the original release date of the songs included in a compilation, only the album compilation of release. As a result, the metadata displayed on portable music players rarely includes any information regarding date of release. Only song title, album, and artist name are displayed. The PushButtonMusic database, on the other hand, preferably includes the original release of every song, even if it is part of a compilation (about 40% of songs) on the portable device. To display it on the portable device of a PushButtonMusic subscriber, the downloaded digital song files will include original song release date data. This will cause the portable device of a PushButtonMusic subscriber to display the song's release year, preferably in front of the abbreviated album name.

While the album name may be displayed in an abbreviated way on the subscribers device, preferably it will appear in full on the artist look-up section of the device menu and on the subscriber's PC. And, in most cases even an abbreviated title is plenty to identify the album. However, subscribers who do not like this feature can remove it.

The preferred embodiments offer an easy and attractive method for displaying the contents of a particular library or playlist on the PushButtonMusic website/media player. To accomplish that, the PushButtonMusic website/media player preferably will display tiny album covers for all the album/artists included in a library or playlist.

### 5. Consumer Access to the Playlist Generator Database™

The below is a detailed description of how the consumer accesses the Playlist Generator Database™ through their PC (or portable music player) according to the preferred embodiments. This is the process by which the consumer selects, downloads, and side loads song libraries and predetermined playlists to their PCs and portable music players

For ease of use, PushButtonMusic has developed nine pre-programmed song libraries for loading to the subscriber's PC. These range in size from 30,000 songs to 12,000. Smaller libraries for the PC may be added. Fortunately, since a subscription model is used, the user avoids purchasing the songs individually. And, should a subscription temporarily lapse, PushButtonMusic maintains the user's file on their server 2 for 12 months. This is to address concerns that music the consumer does not actually own will suddenly disappear if the consumer misses a subscription payment or changes devices, etc. For an additional fee, the consumer may purchase the song(s) outright, and the purchased song files may be exported to a number of other platforms.

Each of these nine PC-libraries comes with 480 (or more preferably, 600) of the most popular playlist choices installed on a numbered menu similar to cable TV channels. Meanwhile, the subscriber's “Favorite” playlists appear at the top of the menu, and additional playlists can be added at any time. This entire collection of pre-programmed playlists is updated on a daily basis.

To initially install the chosen PC-library, the subscriber will have a number of options. First, they may receive one or more DVDs including music released from 1925 to 2003. These DVDs of the libraries may be packaged and sold at stores or other convenient outlets. More recent material as well as daily updates of the entire library are then preferably downloaded over the Internet. Secondly, these libraries may be pre-loaded onto the device by the device manufacturer or the retail location from which the device was purchased. Thirdly, for consumers with faster Internet portals, the initial song libraries may be downloaded in their entirety. For Internet download (which may take many hours for the entire 30,000 song database), the user may schedule the download in plural sections at regularly scheduled times, such as every night between 1 and 3 AM, or every Saturday night from 2-6 AM, etc. After the download of their chosen PC Library, for a fixed price per month, subscribers can: 1) listen to any of the 480 (or more preferably, 600) recommended playlists from their PC or home stereo, 2) customize these playlist to their own liking as they listen to them, 3) download rented songs to a favorite's playlist as they hear them, and 4) add their own playlists constructed on the PushButtonMusic Playlist Generator™ using the criteria described above.

Once the PC-library is installed, the subscriber will be asked to identify his/her portable MP3 player. Under most current licenses, three different devices can be loaded for the same subscriber (e.g. phone, PDA, MP3 player). It is estimated that roughly 60 such devices are now compatible with Microsoft's Plays-For-Sure DRM system. This allows subscription music to be side loaded to a portable device. These devices can be anything from a mobile phone with a 200 song capacity to an 100 gigabyte portable hard-drive allowing for 22,000 songs. The user will then be asked what size of library they wish to side load, leaving plenty of room for their other media files. The subscriber can then choose from dozens of libraries designed for their size of device and side-load them with the click of a single button. Each library will contain up to 480 (or more preferably, 600) recommended playlists which are numbered and will appear under the playlist menu on their portable MP3 device. For a fixed fee per month, the device will be updated on a daily basis by simply hooking the device to the PC to charge. This will allow them to enjoy PushButtonMusic playlists and songs from the car, the gym, or anywhere.

Downloading a very large song library (e.g. 80 gigabytes) to a subscriber's PC can take several days, even at DSL speed. As compressions and bandwidth utilization schemes (e.g. Bit Torrent) continue to improve, this will be less and less of a problem. In the meantime, subscribers will be offered a variety of options to install their chosen PC library over the Internet. For example, in all cases, the subscriber may be able to receive the highest rated 500 songs immediately so they can begin enjoying the playlists immediately.
i. As stated above, they can purchase an MP3 player that has been pre-loaded by the manufacturer with everything but the most recent material, and upload it to their PC. Similarly, they can buy an empty device and have the retailer load it for them at the store. Or, they can order the device online loaded to their specifications and have it shipped to them.
ii. They can use a package of one or more DVDs (sold at the store or mailed separately) containing their chosen PC library and install it themselves. With any of these options, more recent material and daily database updates will be sent over the internet.
iii. Once the subscriber has chosen what library they wish to download on the website/media player and their internet access speed or method, they will be given an estimate of the download time available. They will then be given a number of choices in terms of when the downloading will occur. For example:
My PC is available from 1:00 A.M. to 5:00 A.M. only.
My PC is available from 8:00 P.M. to 8:00 A.M.
Anytime I am not using it.
Continuous download, starting now.

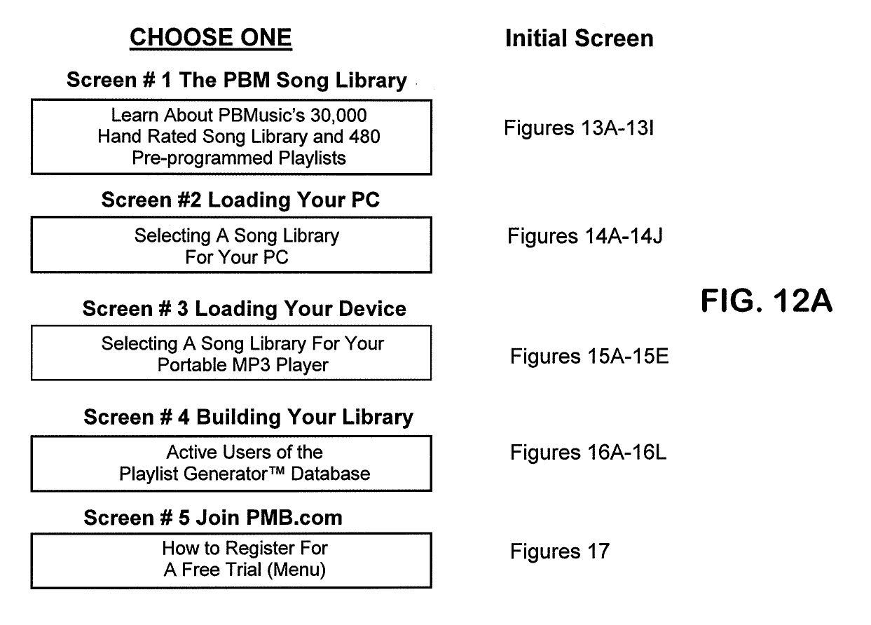

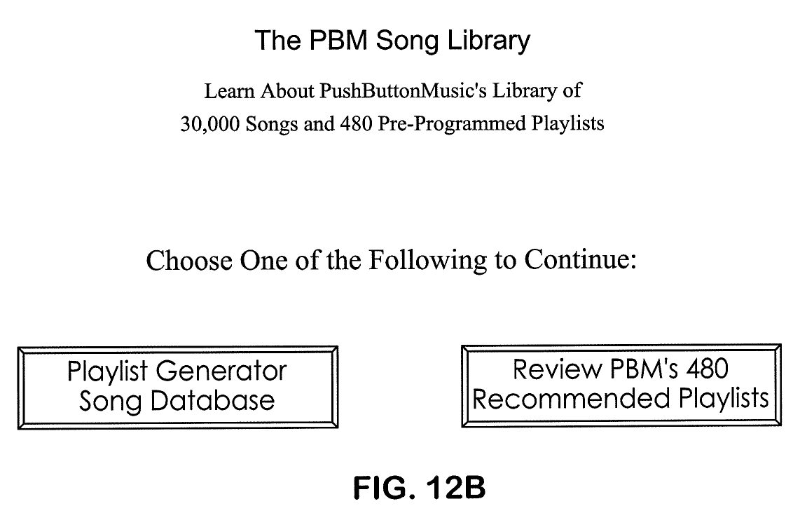

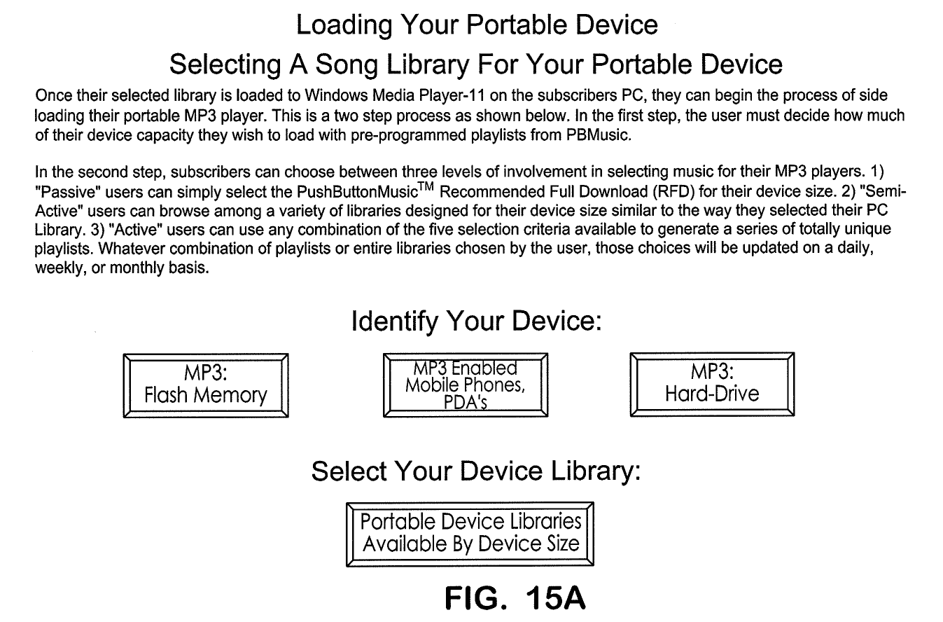

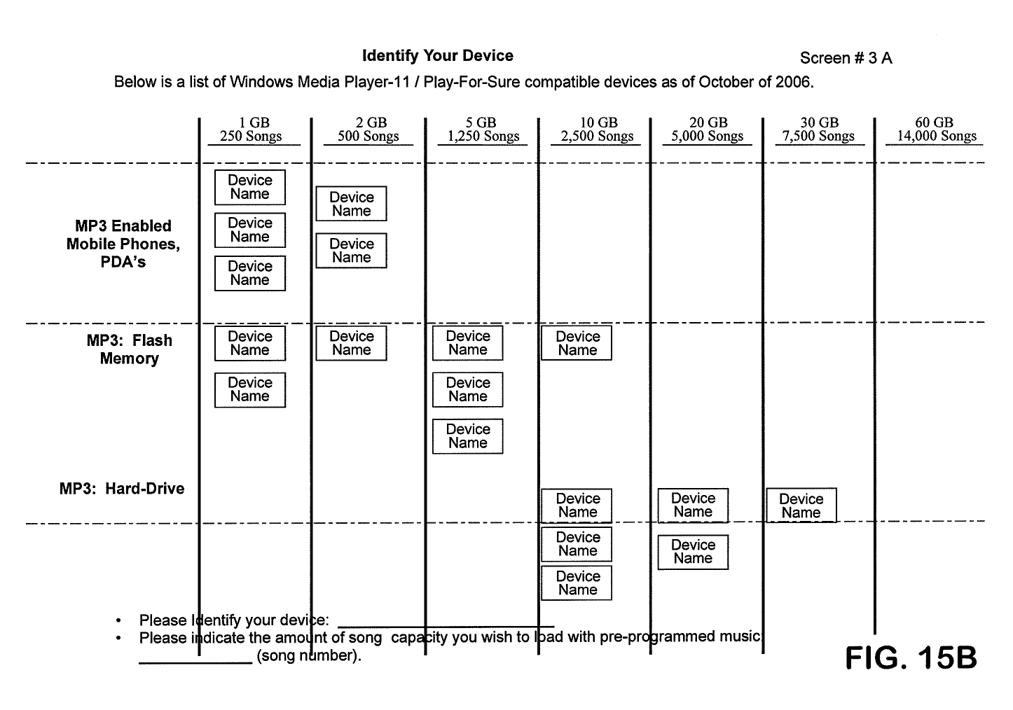

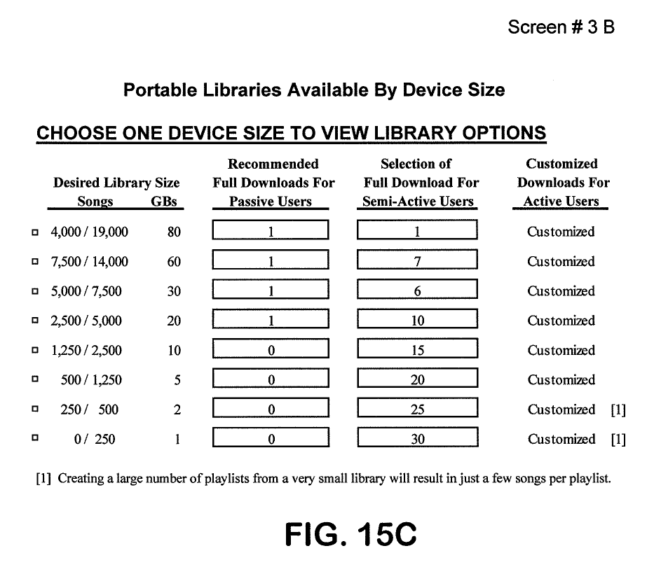

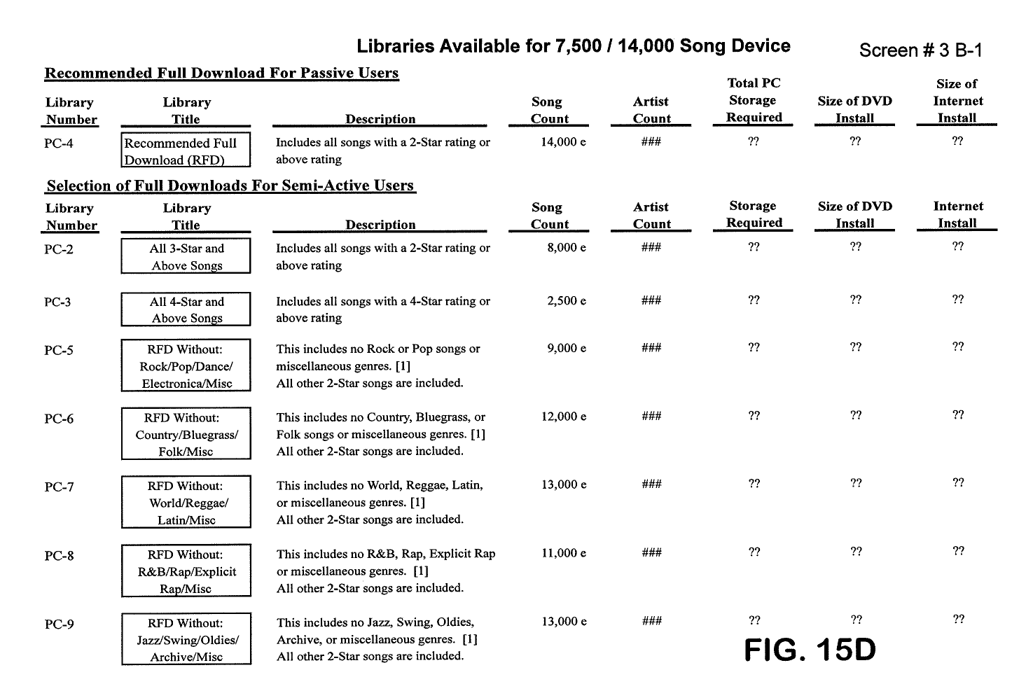

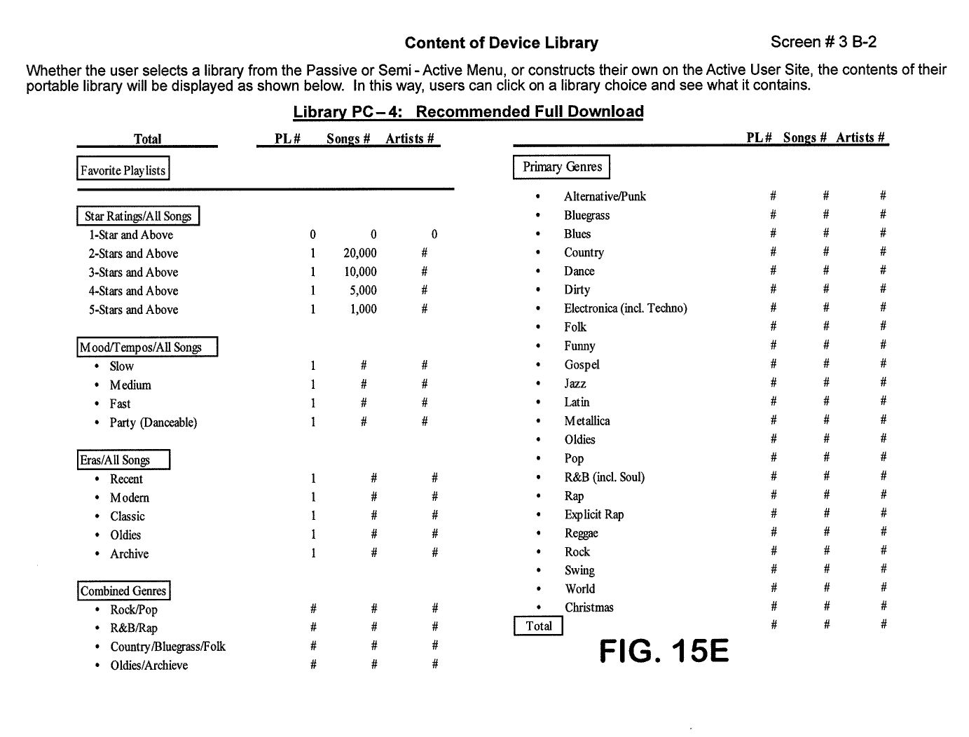

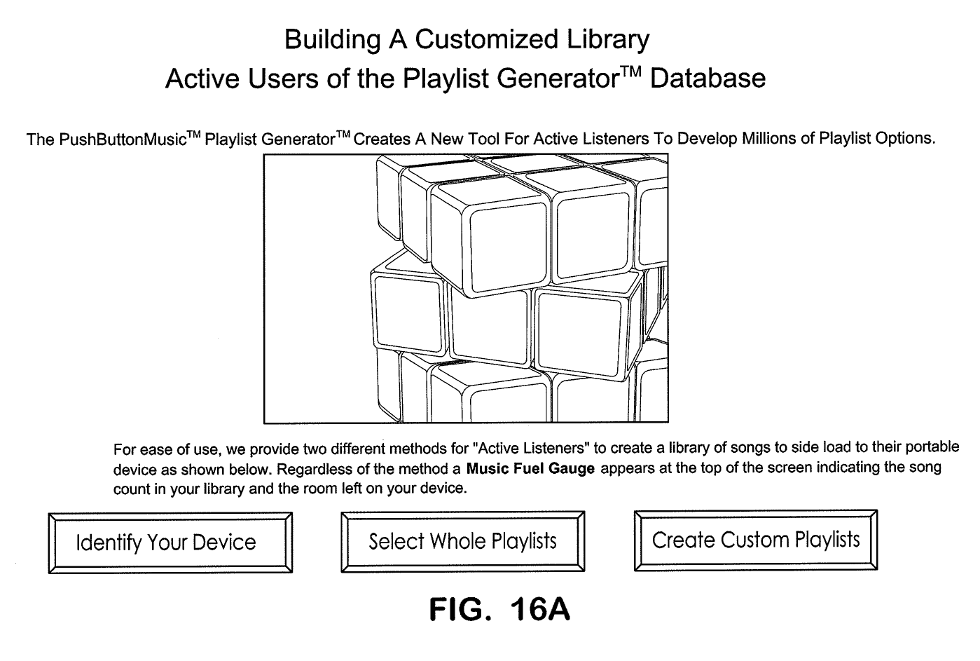

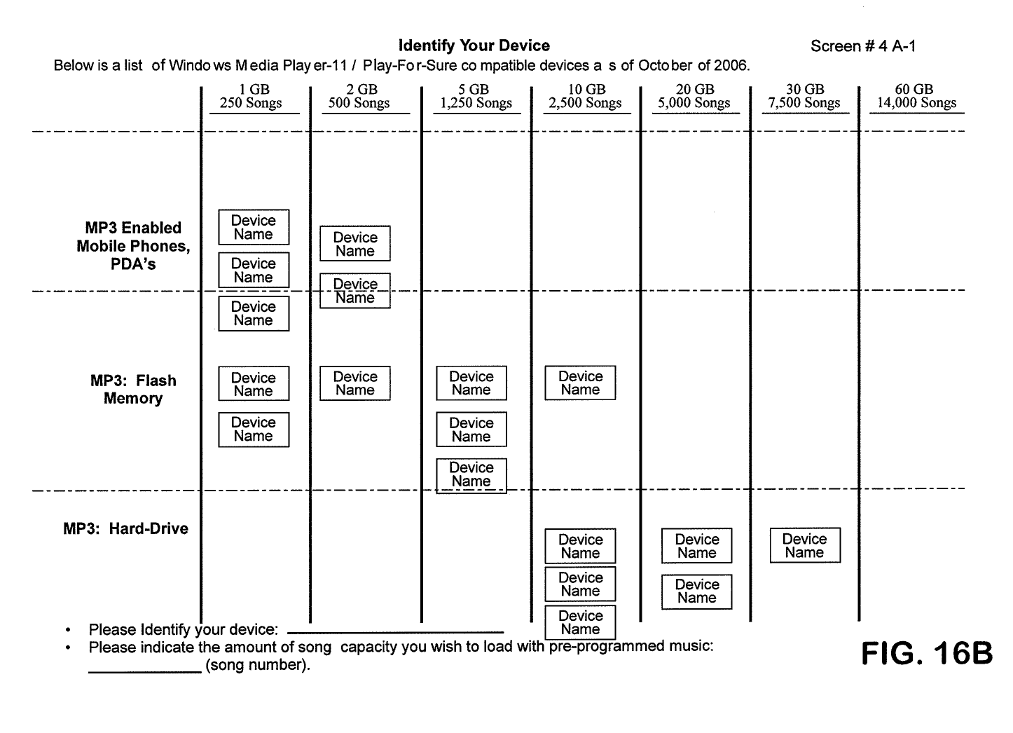

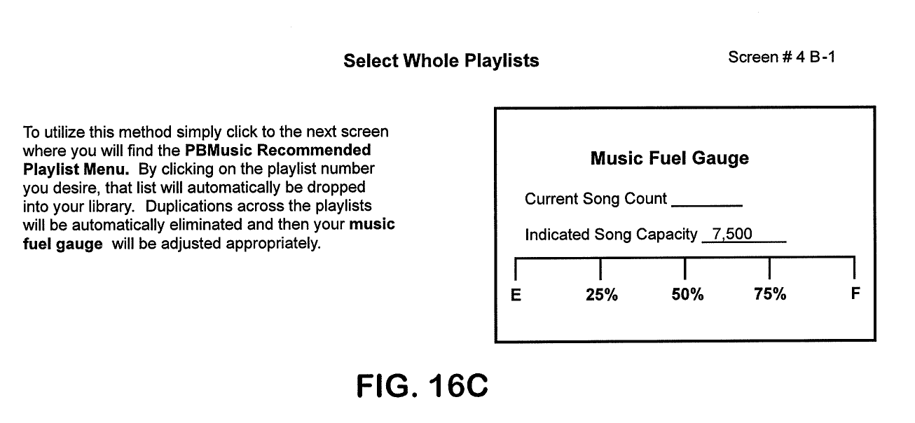

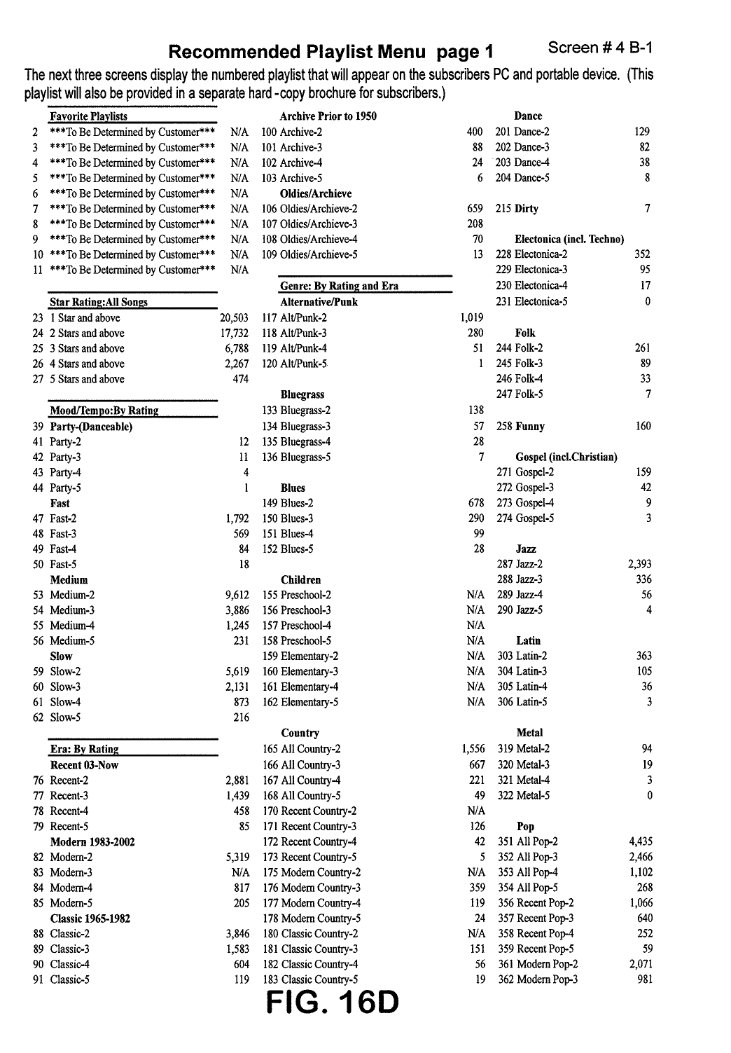

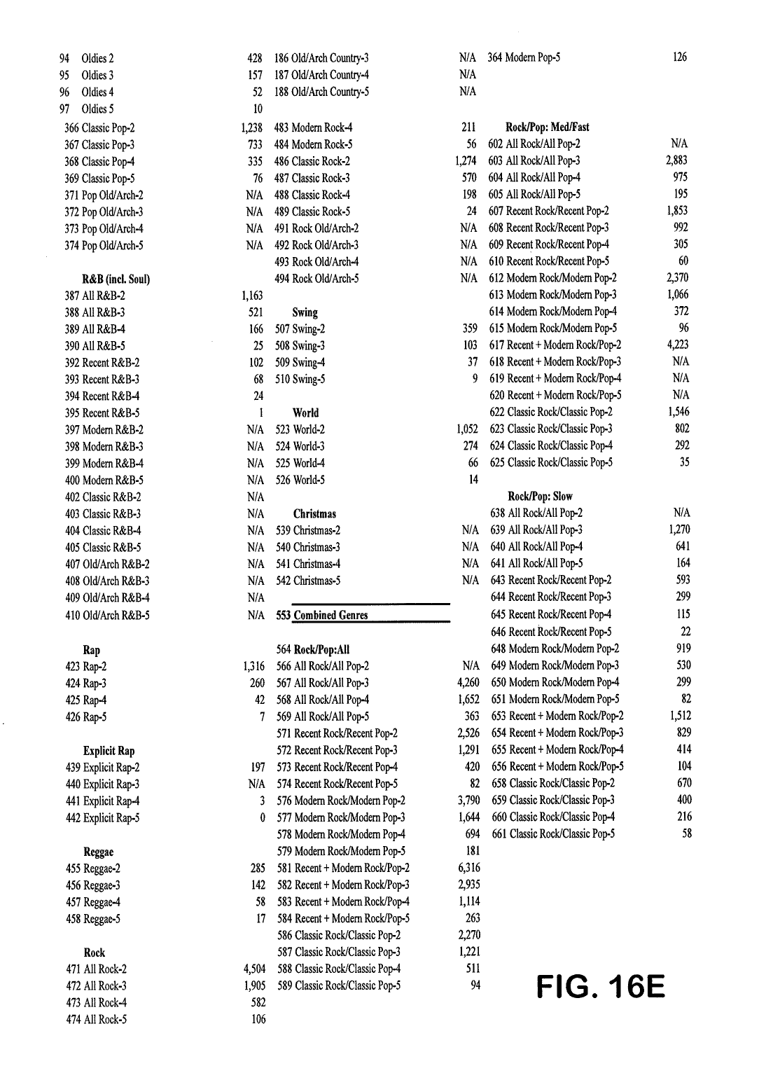

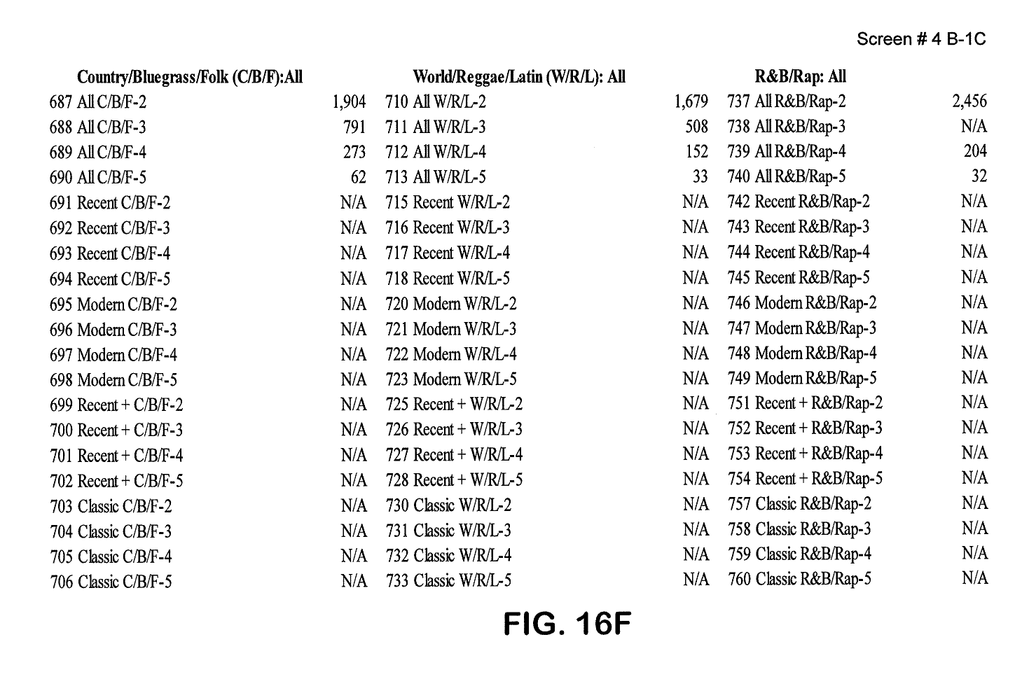

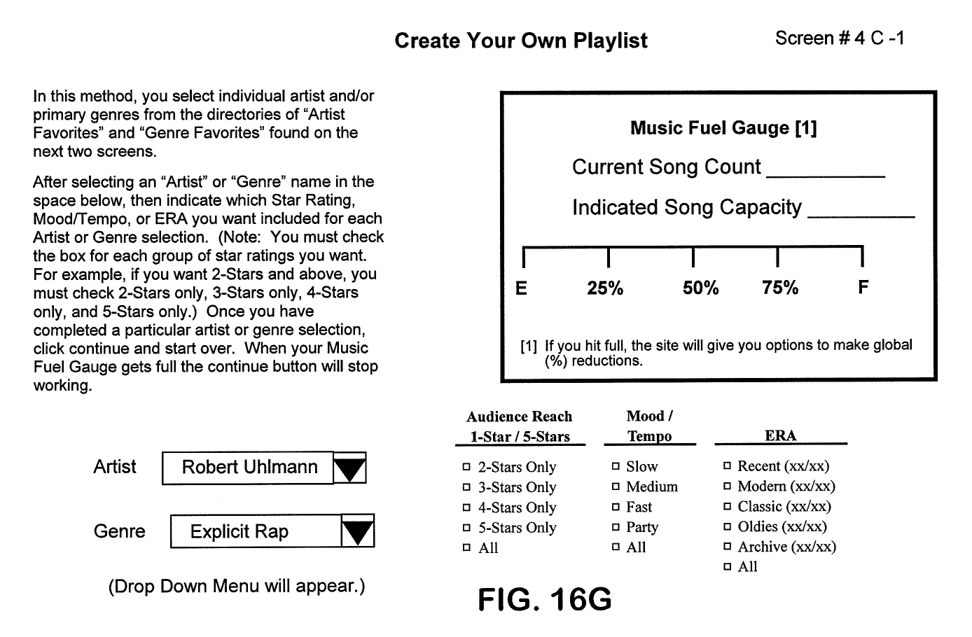

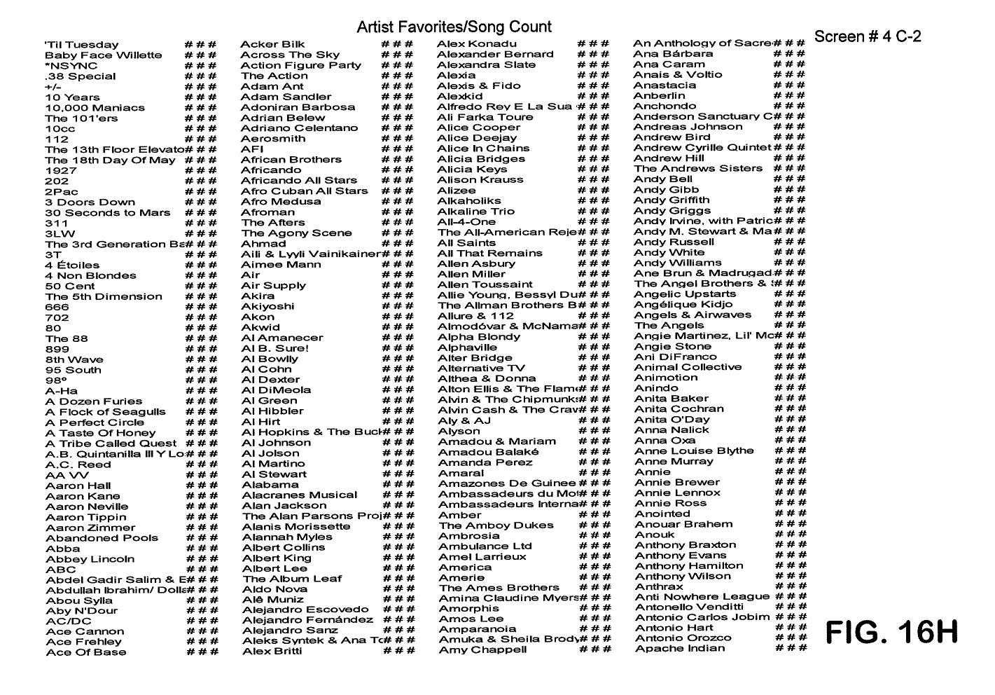

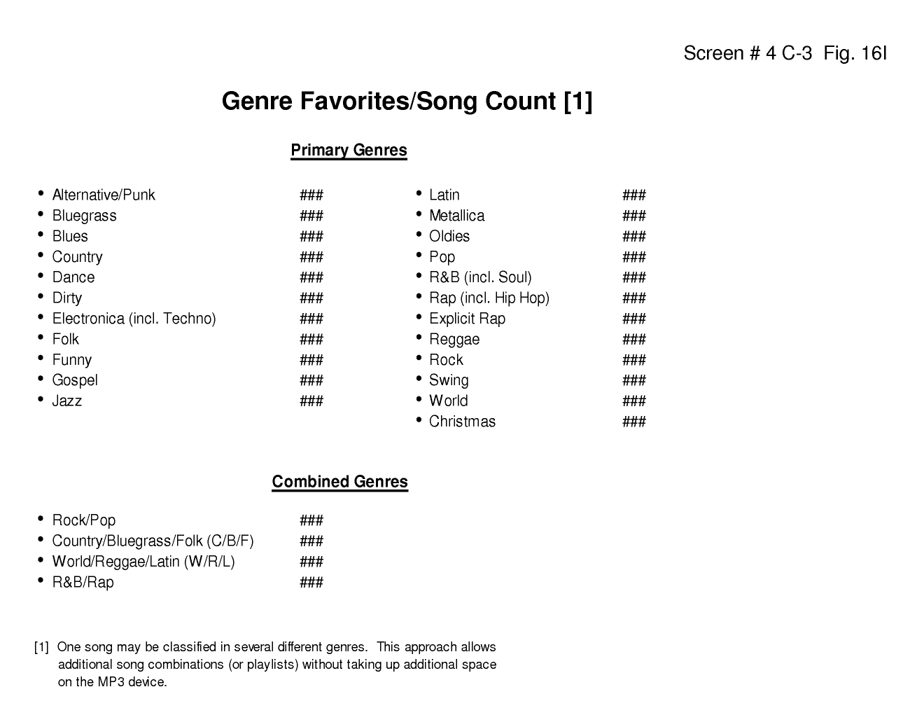

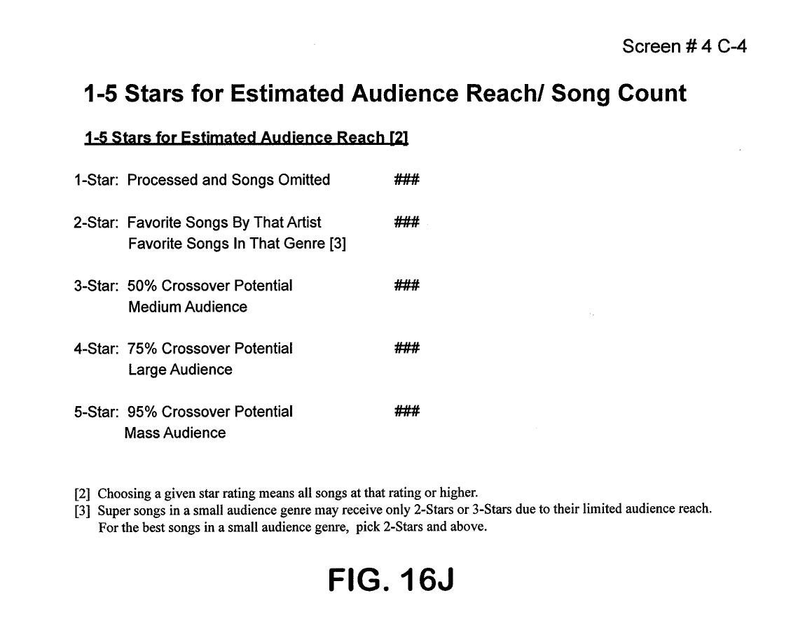

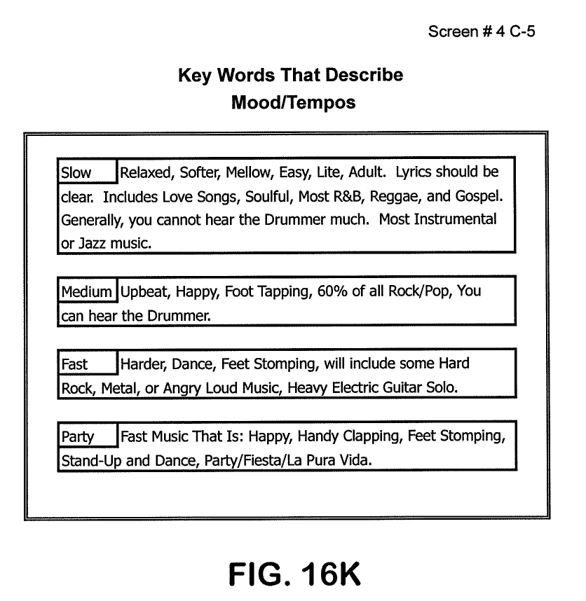

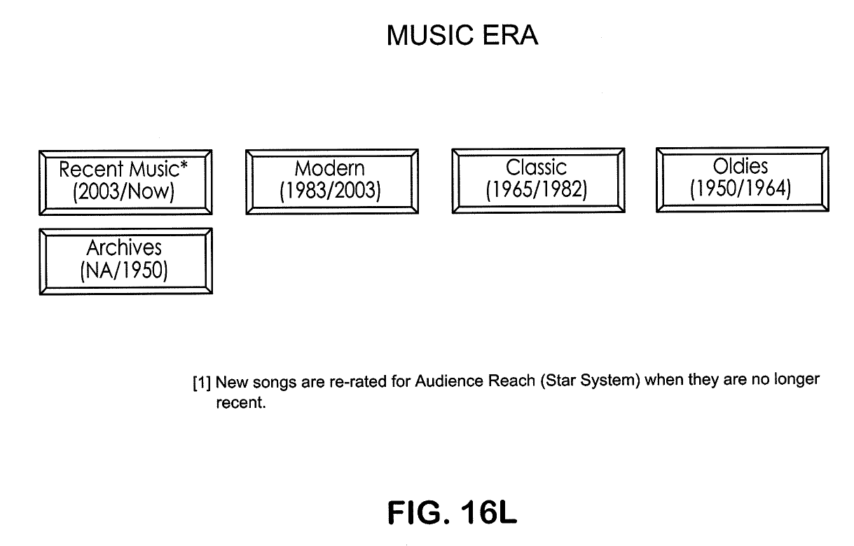

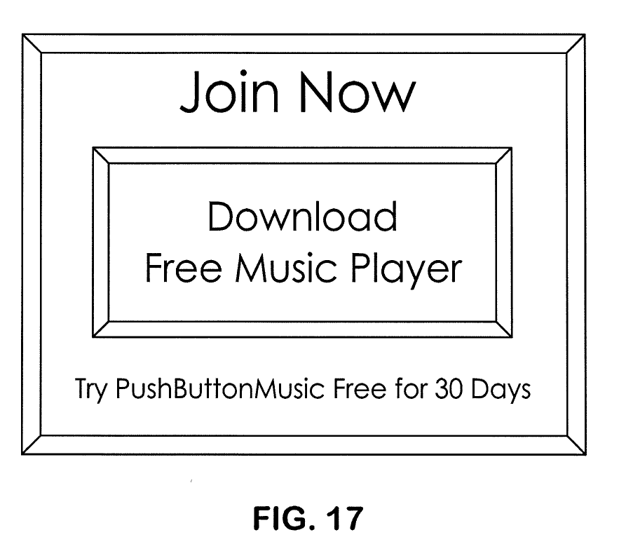

FIG. 11 shows the organization of website screen shots according to the preferred embodiments, while FIG. 12A depicts the preferred opening screen. The consumer begins by accessing the Playlist Generator Database™ website through their PC or portable music player (e.g., music-enabled cell phone, etc.). In FIG. 12A, the user can choose any one of Screens #1-5: Screen #1—Learn About PushButtonMusic's 30,000 Hand Rated Song Library & 480 Pre-Programmed Playlists (see FIGS. 12B and 13A-13I); Screen #2—Selecting A Song Library For Your PC (see FIGS. 14A-14J); Screen #3—Selecting A Song Library For Your Portable MP3 Player (see FIGS. 15A-15E); Screen #4—Active Users of the Playlist Generator™ Database (see FIGS. 16A-16L); or Screen #5—How to Register For A Free Trial (Menu) (see FIG. 17).

In FIG. 13A, Screen #1A, the user can choose one playlist selection criteria: Song Title; Artist Favorites; Genre Favorites; 1-5 Stars for Estimated Audience Reach; Mood/Tempo; and ERA (and/or original release date). For example, in FIG. 13B, Screen #1A-1, the user may choose Artist Favorites. Note that, for exemplary purposes only, FIG. 13B depicts only one of fifty-one pages of artists. The number of songs for each Artist will be depicted where the ### symbol is in all of the Figures.

In FIG. 13C, Screen #1A-2, the user may choose Genre Favorites, such as the Primary Genres: Alternative/Punk, Bluegrass, Blues, Country, Dance, Dirty, Electronica (inc. Techno), Folk, Funny, Gospel, Jazz, Latin, Metallica, Oldies, Pop, R&B (inc. Soul), Rap (inc. Hip Hop), Explicit Rap, Reggae, Rock, Swing, World, Christmas; or the Combined Genres: Rock/Pop, Country/Bluegrass/Folk (C/B/F), World/Reggae/Latin (W/R/L), R&B/Rap. One song may be classified in several different genres. This approach allows additional song combinations (or playlists) without taking up additional space on the MP3 device.

In FIG. 13D, Screen #1A-3, the user may choose 1-5 Stars for the desired Estimated Audience Reach, as described in greater detail above. Briefly:
5-Stars: Solid Hits
4-Stars: Mass Audience Appeal
3-Stars: Discovery/Diversity
2-Stars: Artist Favorites
1-Star: Deep Playlist
   Choosing a given star rating preferably means all songs at the rating or higher. Super songs in a small audience genre may receive only 2-Stars or 3-Stars due to their limited audience reach. For the best songs in a small audience genre, the consumer will pick 1-Star and above.

In FIG. 13E, Screen #1A-4, the user may choose one or more Mood/Tempos, as described in greater detail above. Briefly,
Soft: Slower Tempo, Relaxed, Softer, Mellow, Easy, Lite, Adult. Lyrics should be clear. Includes Love Songs, Soulful, Most R&B, Reggae, and Gospel. Generally, you cannot hear the Drummer much. Most Instrumental or Jazz music.
Medium: Upbeat, Happy, Foot Tapping, 60% of all Rock/Pop, You can hear the Drummer.
Hard: Fast Tempo, Harder, Dance Feet Stomping, will include some Hard Rock, Metal or Angry Loud Music, Heavy Electric Guitar Solo.
Party: This includes: soft, medium, and hard songs that make people want to dance, get happy, and/or celebrate. This includes fast tempo music that is Happy, Hand-Clapping, Foot-Stomping, Stand-up-and-dance music.

In FIG. 13F, Screen #1A-5, the user may choose the Era or the original release date itself, as described in greater detail above. Briefly:
Newly Released (in the current calendar year [e.g. 2007]);
Recent: Released or discovered in the previous three calendar years (e.g. 2004, 2005, 2006);
Modern: Released after 1983 (previous twenty years);
Classic: Released prior to 1983;
Oldies: Released prior to 1965; and
Archive: Released prior to 1950.
   Or they can choose a precise year and hear music released only in that year or combination of years across all 28 genres and approximately 20,000 artists.

As noted earlier, the consumer is offered a Full-Download Portable Service™, in which two or three clicks may be used to download and/or side load a predetermined library of the highest rated songs in the song database, depending on the memory capacity of the consumer's portable music player. In FIG. 13G, Screen #1B, the user may observe the 480 predetermined and recommended “full download” playlists from PushButtonMusic.com, as was described in greater detail above. Subscribers that choose to do so can visit the Active Listener area of the website discussed below and use the five criteria above to generate over 1.8 billion different song combinations (playlists). However, for ease of use, PushButtonMusic has pre-selected 480 of the most popular playlists. These will appear in numerical order on the subscribers PC and/or portable device (see Playlist Menu, Screen #1B-1 and #1B-2, FIGS. 13H-I). To avoid scrolling through the entire playlist menu, subscribers may enter their top 10 playlist choices at the top of the menu list, as shown in FIG. 13H. This may also include playlists recommended by the Playlist Recommender system described above. FIG. 13G depicts how many of these 480 playlist options appear in each of the search criteria described above. Note that Artist-specific playlists may be too numerous to include on the playlist menu. For those, the user may use the “artist” button on their portable device menu. Next to each category of playlists shown is the number of 1-Star and above songs and the number of artists that appear in each playlist.

In FIGS. 13H, Screen #1B-1A, the user may choose from among the currently most-preferred Recommended Playlist Menu shown. The “channel” numbers, the predetermined playlist descriptions, and the song counts are preferably shown to the consumer. These playlists choices will appear on the subscribers PC and/or portable device. These predetermined playlists may also be provided in a separate hard-copy brochure for subscribers.

In FIG. 14A, Screen #2, the user may choose Selecting A Song Library For Your PC. Subscribers can choose from one of the nine libraries shown to download from the website to their PC and/or to their portable device. The consumer is also offered the SemiFull-Download Portable Service™, in which multiple clicks may be used to eliminate from the 14,000 to 30,000 song Full-Download library certain categories of songs the consumer is not interested in downloading. As discussed above, music from the Modern, Classic, Oldies, and Archive eras may also be provided to the subscriber on a preloaded device, a DVD, or any other convenient medium. Preferably, this will mean that only the Recent Era music will be automatically downloaded via the internet to the subscriber's PC upon connection. Updates to the chosen library, including newly released material and changes to the classification and rating of particular songs, will be made on a daily, weekly, or monthly basis. The estimated download time to install the recent songs and update the chosen library is indicated, assuming DSL speed. The lists includes Library Number (PC-1 through PC-9), Library Title, Description, Song Count, Artist Count, Total PC Storage Required, Size of DVD Install, Size (e.g., speed) of Internet Install. The number and types of libraries will evolve over time. Preferably, the consumer can choose from among:
Library #PC-1: All 2-Star and Above Songs, which include all songs with a 2-Star rating or above rating.
Library #PC-2: All 3-Star and Above Songs, which include all songs with a 3-Star rating or above rating.
Library #PC-3: All 4-Star and Above Songs, which include all songs with a 4-Star rating or above rating.
Library #PC-4: Recommended Full Download (RFD), removes 2-Star songs by Artist in High Audience Genres such as Rock, Pop, Country, and Rap.
Library #PC-5: RFD Without: Rock/Pop/Dance/Electronica/Misc, this includes no Rock or Pop songs or miscellaneous genres. All other 2-Star songs are included.
Library #PC-6: RFD Without: Country/Bluegrass/Folk/Misc, this includes no Country, Bluegrass, or Folk songs or miscellaneous genres. All other 2-Star songs are included.
Library #PC-7: RFD Without: World/Reggae/Latin/Misc, this includes no World, Reggae, Latin, or miscellaneous genres. All other 2-Star songs are included.
Library #PC-8: RFD Without: R&B/Rap/Explicit Rap/Misc, this includes no R&B, Rap, Explicit Rap, or miscellaneous genres. All other 2-Star songs are included.
Library #PC-9: RFD Without: Jazz/Swing/Oldies/Archive/Misc, this includes no Jazz, Swing, Oldies, Archive, or miscellaneous genres. All other 2-Star songs are included. Miscellaneous genres include Dirty, Funny, or Christmas.

FIG. 14B, Screen #2A-1, depicts the contents of Library #PC-1, ALL 2-Star and Above Songs. FIG. 14C, Screen #2A-2, depicts the contents of Library #PC-2, ALL 3-Star and Above Songs. FIG. 14D, Screen #2A-3, depicts the contents of Library #PC-3, ALL 4-Star and Above Songs. FIG. 14E, Screen #2A-4, depicts the contents of Library #PC-4, Recommended Full Download (RFD). FIG. 14F, Screen #2A-5, depicts the contents of Library #PC-5, RFD Without: Rock/Pop/Dance/Electronica/Misc. FIG. 14G, Screen #2A-6, depicts the contents of Library #PC-6, RFD Without: Country/Bluegrass/Folk/Misc. FIG. 14H, Screen #2A-7, depicts the contents of Library #PC-7, RFD Without: World/Reggae/Latin/Misc. FIG. 14I, Screen #2A-8, depicts the contents of Library #PC-8, RFD Without: R&B/Rap/Explicit Rap/Misc. And FIG. 14J, Screen #2A-9, depicts the contents of Library #PC-9, RFD Without: Jazz/Swing/Oldies/Archive/Misc.

In FIG. 15A, Screen #3, the user may choose to side load (or download directly from the website) the selected songs/libraries/playlists to the portable music player in Selecting A Song Library For Your Portable MP3 Player. In more detail, once the selected library is loaded to (preferably) the PushButton Music Media Player on the subscribers PC, they can begin the process of side loading their portable MP3 player. This is a two step process. In the first step, the user must decide how much of their device capacity they wish to load with pre-programmed music from PushButtonMusic™. In the second step, subscribers can choose between three levels of involvement in selecting music for their MP3 players. 1) “Passive” users can simply select the Recommended Full-Download for their device size. 2) “Semi-Active” users can use the SemiFull-Download Portable Service™ to browse among a variety of libraries designed for their device size similar to the way they selected their PC Library. 3) “Active” users can use the MyChoice Portable Service™ to select songs/playlists using any combination of the five selection criteria discussed above to generate a series of totally unique playlists. Whatever combination of playlists or entire libraries chosen by the user, those choices may be updated on a daily, weekly, or monthly basis. In Screen #3A, the user selects Identify Your Device; and in Screen #3B, the user can select Portable Device Libraries Available By Device Size.

In FIG. 15B, Screen #3A, the user may Identify Your Device from a list of Windows Plays-For-Sure compatible devices. Devices utilizing other subscription based services and software such as Napster-To-Go, RealNetworks, and the new Zune Music Marketplace Service from Microsoft may be available options as well. The user may select MP3 Enabled Mobile Phones, PDA's, and then choose among: 1 GB, 250 Songs, 2 GB, 500 Songs, identifying the particular device by name. The user may also select MP3: Flash Memory, and then choose among: 1 GB, 250 Songs, 2 GB, 500 Songs, 5 GB, 1,250 Songs, 10 GB 2,500 Songs. Finally, the user may select MP3: Hard-Drive, and then choose among 10 GB 2,500 Songs, 20 GB, 5,000 Songs, 30 GB, 7,500 Songs, 60 GB, 14,000 Songs, 80 GB, 19,000 Songs, and 100 GB 25,000 Songs. The user is asked to identify his/her device and indicate the amount of song capacity they wish to load with pre-programmed music (song number).

In FIG. 15C, Screen #3B, the user may choose Portable Libraries Available By Device Size. The user chooses one device size to view library options, as shown. Creating a large number of playlists from a very small library will result in just a few songs per playlist.

In FIG. 15D, Screen #3B-1, a sample of a recommended Full Download Library Available for 7,500/14,000 Song Device is shown. The lists include Library Number, Library Title, Description, Song Count, Artist Count, Total PC Storage Required, Size of DVD Install, Size of Internet Install. Recommended Full Download For Passive Users: Library #PC-4: Recommended Full Download (RFD), includes all songs with a 2-Star rating or above rating. Selection of Full Downloads for Semi-Active Users: Library #PC-2: All 3-Star and Above Songs, which include all songs with a 3-Star rating or above rating. Library #PC-3: All 4-Star and Above Songs, which include all songs with a 4-Star rating or above rating. Library #PC-5: RFD Without: Rock/Pop/Dance/Electronica/Misc, this includes no Rock or Pop songs or miscellaneous genres. All other 2-Star songs are included. Library #PC-6: RFD Without: Country/Bluegrass/Folk/Misc, this includes no Country, Bluegrass, or Folk songs or miscellaneous genres. All other 2-Star songs are included. Library #PC-7: RFD Without: World/Reggae/Latin/Misc, this includes no World, Reggae, Latin, or miscellaneous genres. All other 2-Star songs are included. Library #PC-8: RFD Without: R&B/Rap/Explicit Rap/Misc, this includes no R&B, Rap, Explicit Rap or miscellaneous genres. All other 2-Star songs are included. Library #PC-9: RFD Without: Jazz/Swing/Oldies/Archive/Misc, this includes no Jazz, Swing, Oldies, Archive, or miscellaneous genres. All other 2-Star songs are included.

In FIG. 15E, Screen #3B-2, whether the user selects a library from the Full-Download Portable Service™ or the SemiFull-Download Portable Service™, or constructs their own on the MyChoice Portable Service™, the contents of their portable library will be displayed. In this way, users can click on a library choice and see what it contains. For example, this Figure shows the metrics for Library PC-4: 14,000 Songs.

FIG. 16A, Screen #4, shows the opening screen for the Active Users using the MyChoice Portable Service™ of the Playlist Generator™ Database. The screen shot shows that the PushButtonMusic™ Playlist Generator™ Creates a New Tool For Active Listeners To Develop Millions of Playlists Options. For ease of use, several different methods are provided for “Active Listeners” to create a library of songs to side load to their portable device. Regardless of the method a Music Fuel Gauge preferably appears at the top of the screen indicating the song count in the chosen library and the room left on the device. In Screen 4A-1, the user is asked to Identify Your Device; in Screen 4A-2, the user is asked to Select Whole Playlists; and in Screen 4A-3, the user is given the option to Create Your Own Playlists.

In FIG. 16B, Screen #4A-1, the user is asked to Identify Your Device from a list of Windows Media Player/Plays-For-Sure compatible devices, as described above in connection with FIG. 15B.

In FIG. 16C, Screen #4B-1, the user may choose Select Whole Playlists. The Music Fuel Gauge will give the user the Current Song Count and Indicated Song Capacity. The gauge will show: E, 25%, 50%, 75% and F. To utilize this method, the user simply clicks to the next screen to find the Recommended Playlist Menu. By clicking on the playlist number desired, that list will automatically be dropped into the library. Duplications across the playlists will be automatically eliminated and then the music fuel gauge will be adjusted appropriately.

In FIGS. 16D-F, Screen #4B-1A, the user may choose the Recommended Playlist Menu, as detailed above with respect to FIGS. 13H-J. These screens display the numbered playlists that will appear on the subscribers PC and/or portable device.

In FIG. 16G, Screen #4C-1, the user may choose Create Your Own Playlist. The Music Fuel Gauge will give the user the Current Song Count and Indicated Song Capacity. The gauge will show: E, 25%, 50%, 75% and F. If the user hits full, the site will give the user the option to make global reductions. For example, to construct or reduce their customized library, the user may select individual artist and/or primary genres from the directories found on the next two screens. After selecting an “Artist” or “Genre” name in the indicated space, the user indicates which Star Rating, Mood/Tempo, or ERA to be included for each Artist or Genre selection. (Note: The user should check the box for each group of star ratings desired. For example, if the user wants 2-Star songs and above, he/she must check 2-Stars only, 3-Stars only, 4-Stars only, and 5-Stars only.) Once the user has completed a particular artist or genre selection, he/she clicks continue and starts over. When the Music Fuel Gauge gets full the continue button will stop working.

In FIG. 16H, Screen #4C-2, the user may choose Artist Favorites, as described above with reference to FIG. 13B.

In FIG. 16I, Screen #1C-3, the user may choose Genre Favorites, as described above with reference to FIG. 13C.

In FIG. 16J, Screen #4C-4, the user may choose among the 1-5 Star Rating for Estimated Audience Reach, as described above with reference to FIG. 13D.

In FIG. 16K, Screen #4C-5, the user may choose key words that describe Mood/Tempos, as described above with reference to FIG. 13E.

In FIG. 16L, Screen #4C-6, the user may choose the ERA, as described above with reference to FIG. 13F. In the preferred embodiment, the user may also choose a particular year or group of years and include songs originally released in that year across all 28 genres.

In FIG. 17, Screen #5, the user may choose How To Register For A Free Trial (Menu).

The present embodiments, while currently envisaged for use with a dedicated Push Button Media Player, may be adapted for use in the Apple iPod™ and iTunes™ systems. Like all media players, iTunes™ keeps track of the: song name, album, artist, release date, a personal star rating, the genre (as assumed by iTunes™), and lots of smaller facts such as bit rate and file size. The present embodiments may use some of the fields available on the iTunes™ screen. Specifically: 1) the “Comment” field may be used to store a song's Mood/Tempo (e.g. fast, slow); 2) the “Grouping” field may be used to store the source of the song (e.g. BB=Billboard); and 3) the “Composer” field may be used to store the initials of the person assigned to classify and rate the song initially. None of these inputs require any significant changes in the iTunes™ media player itself. As long as there are several fields available that can be used as smart-list criteria, their titles are irrelevant.

Regardless of the music player and it's music service, the preferred embodiments will likely transfer the following data elements to the music service server and the media player used by subscribers.
1. Song Name
2. Artist Name
3. Album Name
4. The Assigned Genres
5. The Assigned Audience Reach (Stars)
6. The Assigned Mood/Tempo (preferably in the separate field on the Media Player)
7. The Assigned Era which is included in the “Genre” field (e.g. Recent/Country)
8. Original Release Date (not the Re-Issue Date often found in iTunes™)

Each song in the Push button Music Media Player includes an MP3 file with the music and another file with metadata, directions for playlist searches, and certain text information. These MP3 files also contain some text information, such as the star ratings. Therefore, to transfer or back-up the music library, this other information should be transferred or backed-up as well.

### 6. Advantageous Features Achieved by the Preferred Embodiments

Relying upon a database of individually classified songs to generate playlists on-demand is a radical departure from traditional methods for creating playlists. Existing methods will only generate a playlist automatically from the Artist name, or in some cases a single primary genre. Additional playlists are created by hand selecting songs according to some format, subject, or theme. These subjects or themes can range from an individual's personal preferences to a variety of categories, for example, the Billboard Top 100, Songs of the 90's, The Best of Elton John, Favorite Reggae Songs, etc. In all cases, the individual songs within these playlists can only be retrieved by using the title of the playlist compilation, just as you would select a terrestrial satellite or Internet station today.

In contrast, the method of the preferred embodiment does not program or develop playlists of songs to follow a particular format, subject, or theme. Instead, in Filters #4 and #5, each individual song is listened to, classified, and rated based on separate criteria preferably including artist name, multiple genres, era or original release date, mood/tempo, and star rating. This applies a uniform classification and rating system to each song. This allows the consumer to select songs by using any combination of the search criteria described above. For example, one could combine 3-Star/Fast/Recent/Metal with 2-Star/Slow/Archive/Jazz. Furthermore, the system enables the generation of pre-selected song combinations or playlists for consumers who do not want to create their own. These most popular lists appear on their PC and/or MP3 player in easy-to-understand numbered playlists.

The mathematical implications of this approach, and, its impact on the variety of playlists consumers can generate on their PC and then enjoy from a portable device with fixed capacity, is quite astounding. As shown in Table 4 below, the Playlist Generator Database™ of the preferred embodiment can create up to 1.8 billion different song combinations per artist. With a 30,000 song library available, there are thousands of playlist choices that each includes over 100 songs. Finally, the top 480 to 600 playlists which appear numbered on the portable device may range from 55 to 5,071 songs.

TABLE 4

| Possible Combinations | Total | |
|---|---|---|
| From Each Criterion | Combinations | |
| 1 Artist(1) | 1 | |
| 18 Genres(1) | 262,143 | |
| 5 Ratings | 31 | |
| 4 Mood/Tempos | 15 | 1.8 Billion |
| 6 Era(1) | 31 | |

(1)There are approximately 20,000 Artists, 28 Genres, and 6 Eras included in the 30,000 song database.

Of course, with a more limited capacity device capable of holding 500 rather than 19,000 songs, most of these predetermined song combinations would have few, if any songs. However, at any capacity level, the system of the preferred embodiment generates a huge number of playlist options to retrieve, listen, and discover music. As a comparison of the playlist song selection between MTV/Urge and the method of the preferred embodiments, assume that a consumer has a device with 2-gigabyte capacity (i.e., approximately 500-600 songs) that he wishes to load with playlists of music. (MTV/Urge is a subscription service with a 2,500,000 song library.) Table 5 below illustrates a database of 581 songs that was developed by selecting a number of playlists from MTV/Urge. This 581 song file was created by a knowledgeable MTV/Urge user and includes a wide variety of playlist selections.

TABLE 5
MTV/Urge 581 Song Download - Version Date Aug. 01, 2006

| | |
|---|---|
| Must Haves: Blockbuster Hits | 17 songs |
| Must Haves: Country Rock | 15 songs |
| Must Haves: 80's Alternative | 16 songs |
| Superplaylist: Rock Hall of Fame | 128 songs |
| Superplaylist: I Love the 90's | 140 songs |
| Superplaylist: New Orleans | 154 songs |
| Superplaylist: Reggae | 95 songs |
| Moods: Rebel Songs | 16 songs |

To fill his device using playlists from MTV/Urge, the consumer first has to choose from over 1,000 playlist possibilities ranging in size from 9 to 500 songs. Many of these playlists have vague or outright mysterious titles, thus making it difficult to guess their contents. A subscription service, such as MTV/Urge, does not allow consumers to create playlists from their song database based on combinations of Audience Reach, Era, Original Song Release Date, Mood/Tempo, or multiple Genres. As a result, in this example, a consumer wishing to listen to these songs has only eight playlists from which to choose. (Like all other music platforms, the consumer can always use artist name, song name, or a single primary genre to retrieve songs.)

Another major difference between the methodology of the preferred embodiment and a typical subscription service is that the known subscription service playlists are not derived from a narrow universe of songs, and the songs themselves are not rated by audience reach or the other criteria described above. In the other song databases now available, the star ratings are not assigned to the individual songs using a common classification system based on audience reach. As a result, for example, MTV/Urge offers 124,502 “5-Star” songs, a large number that effectively renders this criterion meaningless for search purposes.

Several thousand other playlist choices are also available using the system of the preferred embodiment for a 4-gigabyte device (approximately 1000 songs). For example, a full download selection of a category entitled “ALL FAST SONGS/3-STARS AND ABOVE/ALL GENRES” is available. This category includes a playlist of 801 songs of very fast-paced music from 16 of the 28 genres used by the system of the preferred embodiment. The consumer need not select from a long list of playlist possibilities or artist names to fill the device. Rather, the consumer may choose a single library to be downloaded all at once. Obviously, when facing an 80-gigabyte (19,000 song) MP3 player, this is a huge convenience.

The methods described above create a unique database that can be delivered on a private label basis to the subscriber services, device manufacturers, and broadcast platforms now available to digital music consumers. As described above, these services now offer the ability to download an unlimited number of songs from a 2,500,000 song library to a PC and then side load a portable device using a subscriber-based Digital Rights Management (DRM) system.

The system of the preferred embodiment provides a full-download service to enable a consumer to download up to 19,000 songs if the consumer has a 80-gigabyte MP3 device. An advantage of this aspect of the invention is that it provides the consumer with a high “discovery ratio”. Discovery ratio is defined herein as being the number of times a consumer hears a new song they really like divided by the total number of songs sampled or listened to in full length. A high discovery ratio requires a lot of content variety. To deliver that variety, the preferred embodiments for both the PC and the portable MP3 player have notable advantages over terrestrial and satellite broadcasters. These include the following:

Time-Shift: The ability to skip songs is important to achieving a high discovery ratio. At a potential sampling/listening rate of 60 songs per hour, everyone will hear something they do not care for, no matter how uniformly it is rated for cross-over potential etc. Many listeners just are not ready for a full crossover discovery-oriented playlist. The SKIP button saves them.

Shuffle: This is important because the listener is not stuck on a particular artist or album. This obviously impacts the variety of music listened to in a given hour.

Playlist Depth: Most forms of broadcast music today, including many satellite and Internet-radio stations, have very narrow playlists. The biggest reason is that playing hits helps to ensure that the targeted listener does not change stations. The result is consumers must do a significant amount of channel surfing, even on satellite, to hear a new song. By contrast, fully loaded MP3 players can provide very deep playlists, hundreds of playlist choices, and time-shift. The result is far greater diversity and a painless way to hear new music.

Crossover: “Discovery” does not always refer to a new artist or album from a familiar artist, genre, or timeframe. This is sometimes referred to as horizontal discovery. A lot of great music can be discovered simply by recommending established hit songs from genres and eras with which the average listener is not familiar. This is sometimes referred to as vertical discovery. Unfortunately, the vast majority of playlists that are broadcast on terrestrial, Internet, or satellite radio tend to be highly genre-specific. Even the so-called “Blend” stations tend to be extremely narrow in both the genre and era offered. While this may be great for a listener that only wants a specific type of music, it represents a greatly reduced discovery ratio.

Simply having hundreds of playlists available for small genres such as Blues, Folk, Rap, Latin, World, Alternative/Punk, and Gospel does not help the problem. Passive listeners who are unfamiliar with or who do not prefer these genres will rarely go there. The fact is that only a few songs from these smaller genres have significant crossover potential from both a genre and era standpoint. Combining entire small genre playlists into a “Super Crossover List” therefore does not work. This is the approach now used by the partial download products offered by the major subscription services.

By contrast, the system of the preferred embodiment ranks songs individually for their crossover potential. In that manner, the system offers playlists at a certain rating level that are indifferent to genre or era. This unique multi-genre crossover capability creates unprecedented variety, especially when the shuffle function is on. This, in turn, allows consumers to enjoy a much higher discovery ratio when they choose to do so. While this approach is far too risky for traditional broadcasters, a fully-loaded MP3 player with a skip button removes the risk.

The Source Selection Process Impacts Variety: As described above with respect to Filter #1, all music bought or heard by consumers is first reviewed by one of five expert sources. Which of these experts are selected (from the thousands and thousands available) will greatly impact the variety and quality of the playlist one recommends. Not surprisingly, the A/R Departments of the four major record labels virtually dominate what is now available on terrestrial and satellite radio. The playlists offered by the eight major Internet-based subscription services also focus on a narrow list of mostly major label artists. As a result, they all tend to play exactly the same songs packaged in slightly different ways. To address this problem, the satellite, and Internet-based platforms have begun to offer playlists directed at small non-label sources. These include: “Indie Rock” or “Garage Band” or “College Campus” playlists. However, just like their small genre lists, these are a harrowing experience for the average listener even with a time-shifted device. By contrast, the system of the preferred embodiment includes only highly selected and rated music from a vast array of experts, including non-label music. Any given playlist will therefore include songs from a wide variety of non-label sources without requiring the consumer to search for them.

Artist Career Stage: The vast majority of “new” artists with a major record label have actually been touring and recording for years. By selecting only artists with a major record contract, the traditional radio programmers automatically eliminate the same quality of artists before they have a contract. However, the system of the preferred embodiment (and specifically the Remote Contributor Network) includes an early detection capability that enables consumers to discover acts that are highly likely to get such a contract in the future.

Including Internet-Based Sources: For decades all five expert sources above were only required to listen to a fairly narrow list of artist names. Now, community sharing sites such as MySpace claim to offer websites of varying quality on over 135,000 bands. Meanwhile, the MusicNet database offers 110,000 artists. Clearly, this volume does not include much material that is of interest to the average passive listener, or the five expert sources they rely on to filter it. Fortunately, MySpace, and another 60 or so of the 300 music websites out there, now publish what these enormous populations are downloading and listening to on a daily basis. However, it is believed that few programmers will admit using these new Internet-based sources today. This is because they have no way of systematically introducing this information into their traditional programming process. By contrast, the system of the preferred embodiment has virtually automated the collection of this data into the system. This will provide professional programmers with a very powerful tool they lack today.

### 7. Conclusion

Thus, what has been described is apparatus and method for providing consumers with whole or partial libraries of pre-categorized songs for quick and painless download to their PCs and/or portable music players.

The individual components shown in outline or designated by blocks in the attached Drawings are all well-known in the music arts and Internet, and their specific construction and operation are not critical to the operation or best mode for carrying out the invention.

While the present invention has been described with respect to what is presently considered to be the preferred embodiment, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

All U.S. and foreign patent documents discussed above are hereby incorporated by reference into the Detailed Description of the Preferred Embodiment.

1. A portable music player storing a plurality of song files, each song file including data corresponding to song title, artist, genre, era, tempo, audience reach, and the song's original release date.

2. A portable music player storing a plurality of song files, each song file including data corresponding to song title, artist, and audience reach.

3. A portable music player according to claim 2, wherein said each song file including data corresponding to plural different genres.

4. A portable music player according to claim 2, wherein said each song file including data corresponding to the song's original release date.

5. A portable music player according to claim 2, wherein said each song file including data corresponding to tempo.

6. A portable music player according to claim 2, wherein said each song file including data corresponding to era.

7. A portable music player storing a plurality of song files, each song file including data corresponding to song title, artist, and plural different genres.

8. A portable music player according to claim 7, wherein said each song file including data corresponding to audience reach.

9. A portable music player according to claim 7, wherein said each song file including data corresponding to the song's original release date.

10. A portable music player according to claim 7, wherein said each song file including data corresponding to tempo.

11. A portable music player according to claim 7, wherein said each song file including data corresponding to era.

12. A portable music player storing a plurality of song files, each song file including data corresponding to song title, artist, and the song's original release date.

13. A portable music player according to claim 12, wherein said each song file including data corresponding to audience reach.

14. A portable music player according to claim 12, wherein said each song file including data corresponding to plural different genres.

15. A portable music player according to claim 12, wherein said each song file including data corresponding to tempo.

16. A portable music player according to claim 12, wherein said each song file including data corresponding to era.

17. A portable music player according to any one of claims 1, 2, 7, 12, and 87, wherein said player comprises an MP3 player.

18. A portable music player according any one of claims 1, 2, 7, 12, and 87, wherein said player comprises a player configured to accept songs from an Internet subscription service.

19. A portable music player according any one of claims 1, 2, 7, 12, and 87, wherein said player comprises a cellular telephone.

20. A portable music player according any one of claims 1, 2, 8, and 13, wherein said audience reach comprises a predetermined rating of each song's audience crossover potential.

21. A portable music player according to claim 20, wherein each song's audience reach is predetermined to comprise one of a five rating levels.

22-86. (canceled)

87. A portable music player storing a plurality of song files, each song file including data corresponding to song title, artist, and mood.

88. A portable music player according to any one of claims 1, 2, 7, 12, and 87, wherein said song files are preloaded into the player prior to shipment to the user.

89. A portable music player to any one of claims 1, 2, 7, 12, and 87, wherein said song files are filtered and categorized into a song library and preloaded into the player prior to shipment to the user.

90. A portable music player according to claim 89, wherein said song files are organized into a song library filtered and categorized in accordance with said data corresponding to.

91. A portable music player according to any one of claims 1, 2, 8, and 13, wherein no more than 10% of song files stored on the player have the highest audience reach level.

92. A portable music player according to any one of claims 1, 2, 8, and 13, wherein substantially 5% of song files stored on the player have the highest audience reach level.

93. A portable music player according to claim 90, wherein substantially 10% of the song files stored on the player have the second highest audience reach level; substantially 35% of the song files stored on the player have the third highest audience reach level; and substantially 50% of the song files stored on the player have the fourth highest audience reach level.

94. A portable music player according to any one of claims 1, 2, 8, and 13, wherein the audience reach level of at least one song file is changeable.

95. A portable music player according to claim 94, wherein said portable music player stores a first song file with a highest audience reach level.

96. A portable music player according to claim 95, wherein said portable music player stores the first song file with a second highest audience reach level.

97. A portable music player according to any one of claims 1, 2, 7, 12, and 87, wherein said player stores substantially 30,000 song files.

98. A portable music player according to any one of claims 1, 2, 7, 12, and 87, wherein said player is configured to side load further song files from a memory.

99. A portable music player according to claim 94, wherein the player is configured to eliminate a song file from the player when a further song file is loaded into the player.

100. A portable music player according to any one of claims 1, 2, 7, 12, and 87, wherein said player is configured to allow listening of the stored song files without initial authorization from a song subscription service.

101. A portable music player according to any one of claims 1, 2, 7, 12, and 87, wherein said player is configured to prevent listening of the stored song files until a user receives periodic authorization from a song subscription service.

102. A portable music player according to any one of claims 1, 2, 7, 12, and 87, wherein said player is configured to upload the song files from the player to a memory.

103. A portable music player according to any one of claims 1, 2, 7, 12, and 87, wherein said player includes a display configured to display indicia corresponding to song genre, audience reach rating, era, and mood.

104. A portable music player according to claim 99, wherein the player display is configured to display the indicia as numbered channels which combine more than one of genre, audience reach, era, and mood.

105. A portable music player according to any one of claims 1, 2, 7, 12, and 87, wherein said player includes a display configured to display indicia corresponding to year of song release.

106. A portable music player storing a plurality of digital song files, each digital song file including indicia corresponding to song artist, song title, and at least one of (i) plural different genres, (ii) audience reach, (iii) original song release date, and (iv) mood.

107. A method of storing a plurality of digital song files on a portable music player, comprising the steps of:
preloading in said player with the plurality of digital song files, each digital song file including indicia corresponding to song artist, song title, and at least one of (i) plural different genres, (ii) audience reach, (iii) original song release date, and (iv) mood; and
after said preloading step, providing the player to a user.

108. A method according to claim 107, further comprising the step of providing a plurality of predetermined channels of the stored song files.

109. A method according to claim 107, wherein said preloading step only stores each song file once on said player.

110. A method according to claim 107, wherein said preloading step includes the step of configuring said player to allow listening of the stored song files without initial authorization from a song subscription service.

111. A method according to claim 110, wherein said preloading step includes the step of configuring said player to prevent listening of the stored song files until a user receives periodic authorization from a song subscription service.

112. A method according to claim 107, further comprising the step of periodically storing further song files on said player, after a user receives periodic authorization from a song subscription service.

113. A method according to claim 112, wherein said step of periodically storing further song files on said player includes the step of coupling said player to a memory that is coupled to the song subscription service.

114. A method according to claim 112, wherein the step of periodically storing further song files on said player includes the step of deleting song files from said player.

115. A method according to claim 112, wherein the step of periodically storing further song files on said player includes the step of not exceeding a predetermined number of song files stored on said player.

116. A method according to claim 112, wherein the step of periodically storing further song files on said player includes the step of providing the further song files over the Internet.

117. A method of storing a plurality of song files on a portable music player, comprising the steps of:
receiving an order from a user for a portable media player;
preloading in said player with the plurality of song files, each digital song file including indicia corresponding to song artist, song title, and at least two of (i) plural different genres, (ii) audience reach, (iii) original song release date, and (iv) mood; and
after said preloading step, providing the player to a user.
